(19) United States
(12) Patent Application Publication
(10) Pub. No.: US 2023/0004623 A1
(43) Pub. Date: Jan. 5, 2023

(54) EXPRESSION FOR THE FOUR-DIMENSIONAL FRENET-SERRET FRAME OF A GIVEN TIMELIKE WORLDLINE IN MINKOWSKI SPACE, WHICH EXPRESSION ENCOMPASSES THE CASES THAT THE THIRD 4D-CURVATURE (SECOND TORSION, HYPER-TORSION OR BI-TORSION) AND POSSIBLY ALSO THE SECOND 4D-CURVATURE (FIRST TORSION) AND POSSIBLY ALSO THE FIRST 4D-CURVATURE ARE VANISHING

(71) Applicant: Bernhard Strohmayer, Munchen (DE)

(72) Inventor: Bernhard Strohmayer, Munchen (DE)

(21) Appl. No.: 17/810,603

(22) Filed: Jul. 3, 2022

(51) Int. Cl. G06F 17/16; G06F 17/11

(52) U.S. Cl. CPC G06F 17/16; G06F 17/11

(57) ABSTRACT

The expression for the 4D-Frenet-Serret frame is formed by multiplying a mixed tensor representing a special local frame, which constitutes a 4D-Frenet-Serret frame, if all three 4D-curvatures ρ₁, ρ₂, ρ₃ are zero, with three purely spatial rotations, which form an Euler cradle. In those cases in which the 4D-Frenet-Serret frame is not uniquely determined, said expression provides all possible 4D-Frenet-Serret frames by a certain freedom when choosing the rotation angles. Further each of the three 4D-curvatures ρ₁, ρ₂, ρ₃ are given as a function of the 3D-curvature [symbol] , the 3D-torsion τ and the magnitude \sqrt{u²} of the velocity u of the three-dimensional spatial part of the worldline and the zero sets of these functions are discussed. Also an expression is provided for a timelike worldline describing a circular movement with the second 4D-curvature ρ₂ (first torsion) being zero.

### FIELD OF THE INVENTION

This invention relates to the construction and use of local frames for timelike worldlines [2, p. 30, first paragraph] in four-dimensional Minkowski space.

In this application we use for the Minkowski metric the convention

$$η = ( \begin{matrix}- 1 & 0 & 0 & 0 \\ 0 & 1 & 0 & 0 \\ 0 & 0 & 1 & 0 \\ 0 & 0 & 0 & 1\end{matrix} )$$

Greek indices run from 0 to 3, latin indices run from 1 to 3. We use units c=G=1 with c being the speed of light and with G being the gravitation constant. L, R and D are contravariant tensors of rank 2 with components L^{μv}, R^{μv}, D^{μv}. Lη, Rη, Dη are mixed tensors of rank 2 with components L^{μ}ᵥ, R^{μ}ᵥ, D^{μ}ᵥ. ηLη, ηRη, ηDη are covariant tensors of rank 2 with components L_{μv}, R_{μv}, D_{μv}.

A point · between four-vectors denotes always the Minkowski pseudo scalar product (a·u=a^{T}ηu=aᵥu^{v}), a point · between three-dimensional vectors denotes always a normal Euclidian scalar product (a·u=a^{T}u) and a point · between a matrix and another matrix or a vector denotes always matrix multiplication, however the latter point is also often omitted. Throughout the application documents three-dimensional quantities are always denoted by bold symbols like r, u, a, [symbol] , L in contrast to the associated four-dimensional quantities r, u, a, R, L. An exception is the unfortunate resemblance between proper time τ and 3D-torsion τ, it should however always be possible to distinguish the two symbols and also the context should always prevent any confusion.

### BACKGROUND OF THE INVENTION

An arbitrary timelike worldline is given by

$$r ( τ ) = {( {r}^{0} ( τ ) , {r}^{1} ( τ ) , {r}^{2} ( τ ) , {r}^{3} ( τ ) )}^{T} = ( \begin{matrix}{r}^{0} ( τ ) \\ r ( τ )\end{matrix} ) \qquad ( 1 )$$

and is parametrised by proper time τ. The four-velocity u(τ) and the four-acceleration α(τ) given by

$$u ( τ ) = \frac{d r}{d τ} = {( {u}^{0} ( τ ) , {u}^{1} ( τ ) , {u}^{2} ( τ ) , {u}^{3} ( τ ) )}^{T} = ( \begin{matrix}{u}^{0} ( τ ) \\ u ( τ )\end{matrix} ) \qquad ( 2 )$$

$$u \cdot u = - 1 {{⇔}^{↓}}^{{u}^{0} > 0} {u}^{0} = \sqrt{{u}^{2} + 1} \qquad ( 3 )$$

(u⁰>0 applies, since u must be future-directed, see [2, p. 35 and p. 16])

$$a ( τ ) = \frac{d u}{d τ} = \frac{{d}^{2} r}{d {τ}^{2}} = {( {a}^{0} ( τ ) , {a}^{1} ( τ ) , {a}^{2} ( τ ) , {a}^{3} ( τ ) )}^{T} = ( \begin{matrix}{a}^{0} ( τ ) \\ a ( τ )\end{matrix} ) \qquad ( 4 )$$

Note that equ. (3) applies only, if one uses either, as we do (see above), the units c=G=1 with c being the speed of light and with G being the gravitation constant, or if one defines

$$u = \frac{1}{c} \frac{dr}{d τ}$$

as done by textbook [2, equ. 2.12 on p. 35 and remark 2.9 on p. 36], otherwise the condition u²=−c² would apply with c being the speed of light.

A local frame along the worldline r(τ) is defined (compare textbook [2, p. 77]) by a 4-tupel of proper time dependent four-vectors conveniently written as the column vectors of a mixed 4×4-tensor Lη

$$L ( τ ) η = ( \begin{matrix}{N}_{0} ( τ ) & {N}_{1} ( τ ) & {N}_{2} ( τ ) & {N}_{3} ( τ )\end{matrix} ) = \qquad ( 5 )$$

$$= ( \begin{matrix}{N}_{0}^{0} ( τ ) & {N}_{1}^{0} ( τ ) & {N}_{2}^{0} ( τ ) & {N}_{3}^{0} ( τ ) \\ {N}_{0} ( τ ) & {N}_{1} ( τ ) & {N}_{2} ( τ ) & {N}_{3} ( τ )\end{matrix} ) \qquad ( 6 )$$

with the four four-vectors being defined at any point on the worldline r(τ) and having the following properties:

1. The four four-vectors N₀(τ), N₁(τ), N₂(τ), N₃)(τ) form a right handed Minkowski-orthonormal basis, such that the matrix L(τ)η is a right handed Minkowski-orthonormal matrix, i.e. (in the following the explicit dependence on T is often omitted to increase the readability of the formulas)

N_{μ}·Nᵥ=N_{μ}^{T}ηNᵥ=η_{μv}∀_{μ},v∀τ

⇔(Lη)^{T}η(Lη)=η∀T⇔(Lη)⁻¹=η(Lη)^{T}η∀T (7)

and

det(Lη)=1 (8)

2. N₀(τ) is the four-velocity

$$u ( τ ) = \frac{dr}{d τ} ,$$

i.e.

N₀(τ)=u(τ) (9)

This applies only, if one uses either, as we do (see above), the units c=G=1 with c being the speed of light and with G being the gravitation constant, or if one defines

$$u = \frac{1}{c} \frac{dr}{d τ}$$

as done by textbook [2, equ. 2.12 on p. 35 and remark 2.9 on p. 36]. Otherwise a factor

$$\frac{1}{c}$$

has to be supplemented.

3. All four four-vectors N₀(τ), N₁(τ), N₂(τ), N₃)(τ) and thus also L(τ)η are differentiable.

Due to the above properties a local frame is always of the form

$$L η = ( \begin{matrix}{N}_{0} & {N}_{1} & {N}_{2} & {N}_{3}\end{matrix} ) = ( \begin{matrix}u & \frac{{c}_{1}}{\sqrt{{c}_{1}^{2}}} & \frac{{c}_{2}}{\sqrt{{c}_{2}^{2}}} & \frac{{c}_{3}}{\sqrt{{c}_{3}^{2}}}\end{matrix} ) \qquad ( 10 )$$

In the trivial case

$$\frac{du}{d τ} = 0 ,$$

where r(τ)=u·T r is a straight line in Minkowski space, the above definition of a local frame reduces to the definition of a restricted Lorentz transformation.

A crucial property of a local frame is its transport property Dη defined by

$$D η = {( L η )}^{- 1} \frac{d}{d τ} ( L η ) ⇔ \frac{d}{d τ} {( L η )}^{T} = {( D η )}^{T} {( L η )}^{T} \qquad ( 11 )$$

$$⇔ ( \begin{matrix}\frac{d {N}_{0}^{T}}{d τ} \\ \frac{d {N}_{1}^{T}}{d τ} \\ \frac{d {N}_{2}^{T}}{d τ} \\ \frac{d {N}_{3}^{T}}{d τ}\end{matrix} ) = {( D η )}^{T} ( \begin{matrix}{N}_{0}^{T} \\ {N}_{1}^{T} \\ {N}_{2}^{T} \\ {N}_{3}^{T}\end{matrix} ) \qquad ( 12 )$$

Note that in textbooks this formula is normally provided without the components of the two columns vectors being transposed, but then this equation looses its character of a simple matrix equation and becomes a “vectrix equation”, which is why we prefer the formulation given above.

Derivation of equation (7) yields that ηDη is skew symmetric for all local frames (see annex 1 “Symmetry of transport property Dη”). Thus Dη can be partitioned in the form

$$D η = ( \begin{matrix}0 & {D}_{1}^{T} \\ {D}_{1} & {[ {D}_{2} ]}_{\times }\end{matrix} ) \qquad ( 13 )$$

with D₁ and D₂ being three-dimensional vectors and with matrix [a]ₓ associated with a three-dimensional vector a being defined by

$$a \times b = ( \begin{matrix}{a}_{2} {b}_{3} - {b}_{2} {a}_{3} \\ - ( {a}_{1} {b}_{3} - {b}_{1} {a}_{3} ) \\ {a}_{1} {b}_{2} - {b}_{1} {a}_{2}\end{matrix} ) = {\underbrace{( \begin{matrix}0 & - {a}_{3} & {a}_{2} \\ {a}_{3} & 0 & - {a}_{1} \\ - {a}_{2} & {a}_{1} & 0\end{matrix} )}}_{{\text{=:} [ a ]}_{\times }} ( \begin{matrix}{b}_{1} \\ {b}_{2} \\ {b}_{3}\end{matrix} ) \qquad ( 14 )$$

For skew symmetric (=antisymmetric) 4×4-matrices this type of partitioning has been used to calculate certain matrix properties like the determinant, the inverse matrix or the exponential matrix, see for example [4, fact 4.12.1.xliii)-xlv) on p. 385, fact 6.9.19 on p. 528, fact 8.9.18vi) on p. 665 and fact 15.12.18 on p. 1208]. This sort of partitioning has also been used for antisymmetric four tensors of second order for example to determine the dual tensor, see for example [7, equ. 4.83 on p. 110 and p. 116, 1st para.], [2, equ. 17.19, 17.22 on p. 551 and Remark 3.11 on p. 85] or [5, equ. 11.137, 11.138 and 11.140 on p. 556].

From equ. (12) and (13) one can derive

$${a}^{2} = {( \frac{{dN}_{0}}{d τ} )}^{2} = {D}_{1}^{2} \qquad ( 15 )$$

for all local frames.

If Lη is a local frame of a timelike worldline r(τ), then LηRη with Rη being a purely spatial rotation

$$R ( τ ) η = ( \begin{matrix}1 & 0 \\ 0 & R ( τ )\end{matrix} ) , {[ R ( τ ) η ]}^{T} = {[ R ( τ ) η ]}^{- 1} , det [ R ( τ ) η ] = 1 \qquad ( 16 )$$

is also a local frame of the same worldline (see annex 2 “Lη and LηRη are different local frames of the same worldline”). The converse is also true: if Lη and L′η are local frames for the same worldline, then (Lη)⁻¹ (L′η) is a purely spatial rotation (see likewise annex 2 “Lη and LηRη are different local frames of the same worldline”).

If Lη is a local frame of a timelike worldline, then RηLη with Rη being a purely spatial rotation is also a local frame, but of a different, but likewise timelike worldline as shown in annex 3 “Lη and RηLη are local frames of different worldlines”. If Rη does not depend on proper time, i.e.

$$\frac{d ( R η )}{d τ} = 0 ,$$

then Lη and RηLη have the same transport property as likewise shown in said annex 3. From this one can conclude that the transport property Dη or equivalently D₁, D₂ can be expressed in terms of the 3D-curvature [symbol] , the 3D-torsion T (as defined in annex 4 “Euclidian 3D-Frenet-Serret frame”) and the magnitude \sqrt{u²} of the three-dimensional spatial part u of the four-velocity

$$u = ( \begin{matrix}{u}^{0} \\ u\end{matrix} ) ,$$

since the shape of a curve r(τ) in three-dimensional Euclidian space is fully determined by [symbol] and T up to a constant rotation according to the “fundamental theorem of space curves”, see for example textbook [15, theorem 8.3 on p. 231 and theorem 8.4 on p. 233].

A rotation Rη as defined in equ. (16) constitutes a local frame of a timelike worldline of an observer at rest, since the four-velocity n of an observer at rest is

$$n = ( \begin{matrix}1 \\ 0 \\ 0 \\ 0\end{matrix} ) \qquad ( l7 )$$

A prominent example of a local frame is the 4D-Frenet-Serret frame L̅η

$$\overline{L} η = : ( \begin{matrix}{\overline{N}}_{0}^{0} & {\overline{N}}_{1}^{0} & {\overline{N}}_{2}^{0} & {\overline{N}}_{3}^{0} \\ {\overline{N}}_{0} & {\overline{N}}_{1} & {\overline{N}}_{2} & {\overline{N}}_{3}\end{matrix} ) = ( {\overline{N}}_{0} {\overline{N}}_{1} {\overline{N}}_{2} {\overline{N}}_{3} ) , \qquad ( 18 )$$

which has to be distinguished from the 3D-Frenet-Serret frame of annex 4 “3D Euclidian Frenet-Serret frame”. Note the overline on all quantities related to the 4D-Frenet-Serret frame in Minkowski space.

In textbooks [1], [2], [3] the four-vectors N̅μ of the 4D-Frenet-Serret frame are constructed iteratively according to the Gram-Schmidt orthonormalisation procedure, wherein the sign of the last vector N̅₃ has to be chosen to ensure that det(L̅η)=1 as required by equ. (8):

$${ρ}_{1} : = \sqrt{\frac{d {\overline{N}}_{0}}{d τ} \cdot \frac{d {\overline{N}}_{0}}{d τ}} = \sqrt{a \cdot a} \qquad ( 19 )$$

$${\overline{N}}_{1} : = \frac{1}{{ρ}_{1}} \frac{d {\overline{N}}_{0}}{d τ} = \frac{a}{\sqrt{a \cdot a}} \qquad ( 20 )$$

wherein ρ₁ is called the first curvature,

$${ρ}_{2} : = \sqrt{{( \frac{d {\overline{N}}_{1}}{d τ} - {\overline{N}}_{0} \sqrt{a \cdot a} )}^{2}} \qquad ( 21 )$$

$${\overline{N}}_{2} : = \frac{1}{{ρ}_{2}} ( \frac{d {\overline{N}}_{1}}{d τ} - {\overline{N}}_{0} \sqrt{a \cdot a} ) == \frac{1}{{ρ}_{2}} ( \frac{d \frac{a}{\sqrt{a \cdot a}}}{d τ} - u \sqrt{a \cdot a} ) = \qquad ( 22 )$$

$$= \frac{1}{{ρ}_{2}} [ \frac{1}{\sqrt{a \cdot a}} ( \frac{d a}{d τ} - \frac{a \cdot \frac{d a}{d τ}}{a \cdot a} a ) - u \sqrt{a \cdot a} ] \qquad ( 23 )$$

wherein ρ₂ is called the second curvature or first torsion and

$${ρ}_{3} : = \sqrt{{( \frac{d {\overline{N}}_{2}}{d τ} + {ρ}_{2} {\overline{N}}_{1} )}^{2}} \qquad ( 24 )$$

$${\overline{N}}_{3} : = \pm \frac{1}{{ρ}_{3}} ( \frac{d {\overline{N}}_{2}}{d τ} + {ρ}_{2} {\overline{N}}_{1} ) \qquad ( 25 )$$

wherein ρ₃ is called the third curvature or second torsion or hyper-torsion or bi-torsion.

This procedure ensures that the transport property D̅η assumes the form

$${\underbrace{( \frac{d {\overline{N}}_{0}}{d τ} \frac{d {\overline{N}}_{1}}{d τ} \frac{d {\overline{N}}_{2}}{d τ} \frac{d {\overline{N}}_{3}}{d τ} )}}_{\frac{d}{d τ} \overline{L} η = \frac{d}{d τ} {\overline{L}}_{ν}^{μ}} = {\underbrace{( {\overline{N}}_{0} {\overline{N}}_{1} {\overline{N}}_{2} {\overline{N}}_{3} )}}_{\overline{L} η = {\overline{L}}_{ν}^{μ}} {\underbrace{( \begin{matrix}0 & {ρ}_{1} & 0 & 0 \\ {ρ}_{1} & 0 & - {ρ}_{2} & 0 \\ 0 & {ρ}_{2} & 0 & - {ρ}_{3} \\ 0 & 0 & {ρ}_{3} & 0\end{matrix} )}}_{\overline{D} η = {\overline{D}}_{ν}^{μ}} \qquad ( 26 )$$

$$⇔ ( \begin{matrix}\frac{d {\overline{N}}_{0}^{T}}{d τ} \\ \frac{d {\overline{N}}_{1}^{T}}{d τ} \\ \frac{d {\overline{N}}_{2}^{T}}{d τ} \\ \frac{d {\overline{N}}_{3}^{T}}{d τ}\end{matrix} ) = {\underbrace{( \begin{matrix}0 & {ρ}_{1} & 0 & 0 \\ {ρ}_{1} & 0 & {ρ}_{2} & 0 \\ 0 & - {ρ}_{2} & 0 & {ρ}_{3} \\ 0 & 0 & - {ρ}_{3} & 0\end{matrix} )}}_{{( \overline{D} η )}^{T}} ( \begin{matrix}{\overline{N}}_{0}^{T} \\ {\overline{N}}_{1}^{T} \\ {\overline{N}}_{2}^{T} \\ {\overline{N}}_{3}^{T}\end{matrix} ) \qquad ( 27 )$$

$$\overline{D} η = ( \begin{matrix}- 0 & {\overline{D}}_{1}^{T} \\ {\overline{D}}_{1} & {[ {\overline{D}}_{2} ]}_{\times }\end{matrix} ) with {\overline{D}}_{1} = ( \begin{matrix}{ρ}_{1} \\ 0 \\ 0\end{matrix} ) and {\overline{D}}_{2} = ( \begin{matrix}{ρ}_{3} \\ 0 \\ {ρ}_{2}\end{matrix} ) \qquad ( 28 )$$

For equation (26) see for example [3, equation (18.115) on p. 419], for equation (27) see for example [2, equ. (2.63) on p. 62, equ. (3.29) on p. 81 and Example 3.1. on p. 88] or [6, equations (11.122)-(11.126) on p. 390].

It is apparent from equ. (27) that the three curvatures ϕ₁, ρ₂ and ρ₃ can also be calculated using the following formulas:

$${ρ}_{1} = \frac{d {\overline{N}}_{0}}{d τ} {\overline{N}}_{1} = - \frac{d {\overline{N}}_{1}}{d τ} {\overline{N}}_{0} \qquad ( 29 )$$

$${ρ}_{2} = \frac{d {\overline{N}}_{1}}{d τ} \cdot {\overline{N}}_{2} = - \frac{d {\overline{N}}_{2}}{d τ} \cdot {\overline{N}}_{1} = \sqrt{{( \frac{d {\overline{N}}_{1}}{d τ} )}^{2} + {ρ}_{1}^{2}} \qquad ( 30 )$$

$${ρ}_{3} = \frac{d {\overline{N}}_{2}}{d τ} \cdot {\overline{N}}_{3} = - \frac{d {\overline{N}}_{3}}{d τ} {\overline{N}}_{2} = \sqrt{{( \frac{d {\overline{N}}_{2}}{d τ} )}^{2} - {ρ}_{2}^{2}} = \sqrt{{( \frac{d {\overline{N}}_{3}}{d τ} )}^{2}} \qquad ( 31 )$$

The Gram-Schmidt orthonormalisation procedure works apparently only, if ρⱼ≠0 for all j=1, 2, 3. For all j=1, 2, 3 the equation ρⱼ=0 applies if and only if the wordline is lying in a j-dimensional linear subspace, see for example [1, p. 75, 76], [2, p. 60-62], [8, p. 3, middle paragraph, Theorem 2* on p. 5 and Theorem 2** on p. 6] or [9, Theorem 2 on p. 1330]. In order to construct the 4D-Frenet-Serret frame for this case one has to find time independent Minkowski-orthonormal basis vectors of the complementary subspace. This Minkowski-orthonormal basis is uniquely determined only if said complementary subspace is one-dimensional, i.e. if ρ₃=0 ∧ρ₂≠0. If ρ₂=0 the Minkowski-orthonormal basis is no more uniquely determined. One approach to determine the time independent Minkowski-orthonormal basis vectors of the complementary subspace is outlined for the more general case of an n-dimensional space with an arbitrary metric by Synge [1, p. 75, last paragraph]: if ρⱼ=0 one constructs first j time independent basis vectors of the j-dimensional linear subspace accommodating the timelike worldline using for example

in case of ρ₁=0 the four-velocity u(τ*) at an arbitrary but fixed proper time τ*,

in case of ρ₂=0 the four-velocity u(τ*) and the four-acceleration α(τ*) at an arbitrary, but fixed proper time τ* (one can also use u(T¹) and u(T₂) or α(T₁) and α(T₂) or u(T₁) and a(T₂) as long as the two four-vectors are linearly independent) and

in case of ρ3=0 the four-velocity u(τ*), the four-acceleration α(τ*) and

$$\frac{d a}{d τ} ( {τ}^{*} )$$

at an arbitrary, but fixed proper time τ* (other choices are also possible in this case),

and then one determines 4-j Minkowski-orthonormal, time independent four-vectors, which are Minkowski-orthogonal to said j basis four-vectors.

### SUMMARY OF THE INVENTION

A problem to be solved by the invention is to provide an alternative approach to calculate time independent and Minkowski-orthonormal basis four-vectors of said complementary subspace using time dependent four-vectors u(τ), α(τ) and

$$\frac{d a}{d τ} ,$$

which obviates the need to choose an arbitrary, but fixed proper time τ*.

For all local frames (and thus also for all restricted Lorentz transformations) the problem of calculating the fourth four-vector N₃ of a local frame Lη as defined in equ. (5), (6) above from the first three four-vectors N₀=u, N₁ and N₂ is solved according to the invention as defined in claim 1 by the formula

$${N}_{3} = ( \begin{matrix}{N}_{3}^{0} \\ {N}_{3}\end{matrix} ) = ( \begin{matrix}{u}^{T} \\ \frac{1}{{u}^{0}} ( 1 + u {u}^{T} )\end{matrix} ) ( {N}_{1} \times {N}_{2} ) \qquad ( 32 )$$

with u and u⁰ being defined in equ. (2) and (3) above. Equation (32) applies to all local frames and in particular also to the 4D-Frenet-Serret frame both for ρ₃₌₀ and for ρ3≠0 and is thus to be preferred to equation (25), since it is firstly also applicable for ρ3=0 and since it secondly obviates the need to calculate

$$\frac{d {\overline{N}}_{2}}{d τ} .$$

The problem of providing an expression for the 4D-Frenet-Serret frame for the case ρ3=0 is thus solved by replacing in the textbook version of the 4D-Frenet-Serret frame the expression for the fourth four-vector N̅₃ of equ. (25) with the expression *N̅₃ of equ. (32).

In case of ρ3=0∧ρ₂≠0 the four-vector *N̅₃ constitutes the single time independent and Minkowski-normal basis four-vector of the one-dimensional linear subspace, which is complementary to the three-dimensional linear subspace accommodating the worldline, although *N̅₃ is constructed from time dependent four-vectors u(τ), α(τ) and

$$\frac{d a}{d τ} .$$

There is in this case thus no need to choose an arbitrary, but fixed proper time τ* as in the method disclosed in [1].

In order to solve the problem to provide an expression for the 4D-Frenet Serret frame not only for the case ρ3=0, but also for the case ρ₂=0 and/or ρ₁=0, according to the invention the 4D-Frenet-Serret frame is factorised. The problem is in particular solved by a method of calculating the 4D-Frenet-Serret frame of a timelike worldline in Minkowski space by forming the product of another local frame and one or more spatial rotations as defined in claim 2. Advantageous embodiments are defined in dependent claims 3-6.

A worldline is most often defined by its four components as defined in equ. (1). The worldline is even fully defined by its spatial part r only, since the first component can always be constructed from r by

$${r}^{0} ( τ ) {{=}^{↓}}^{equ . ( 1 ) - ( 3 )} {\int }_{{τ}_{0}}^{τ} \sqrt{{[ u ( {τ}^{′} ) ]}^{2} + 1} d {τ}^{′}$$

A three-dimensional curve r is most often likewise defined by its components, it can however up to a constant rotation also be defined by its natural equation, i.e. by its 3D-curvature [symbol] , by its 3D-torsion τ and by the magnitude of the velocity \sqrt{u}² according to the “fundamental theorem of space curves”, see for example textbook [15, theorem 8.3 on p. 231 and theorem 8.4 on p. 233]. Although it is in many cases, for example for planar curves, possible to solve the natural equation to get mathematical expressions of the three components of the curve, this is not possible in general. Another object of the invention is to enable the analytical calculation of the three 4D-curvatures of the 4D-Frenet-Serret frame also in those cases in which the worldline is defined by the 3D-curvature [symbol] , by the 3D-torsion τ and by the magnitude \sqrt{u²} of the three-dimensional spatial part u of the four-velocity

$$u = ( \begin{matrix}{u}^{0} \\ u\end{matrix} )$$

without there being an analytical solution of the natural equation. The problem is solved according to the invention as defined in claim 7 by providing an analytical expression for each of the three 4D-curvatures ρ₁, ρ₂, ρ₃ in terms of the 3D-curvature [symbol] , the 3D-torsion τ and the magnitude \sqrt{u²} of the three-dimensional spatial part u of the four-velocity

$$u = ( \begin{matrix}{u}^{0} \\ u\end{matrix} ) .$$

Advantageous embodiments are defined in dependent claim 8.

According to the invention as defined in claim 9 the problem of calculating the transport property D′η of a local frame L′η=LηRη with

$$R η = ( \begin{matrix}1 & 0 \\ 0 & R\end{matrix} )$$

being a spatial rotation is solved by using the matrix partitioning defined in equ. (13) and by calculating D′₁, D′₂ from D₁, D₂ and [symbol] . An advantageous embodiment is defined in claim 10.

Another object of the invention is to provide a simple solution for the equations ρ₂=0 and ρ3=0 (the solution for ρ₁=0 is trivial). As explained in the paragraph below equ. (31) above it is textbook knowledge that the solution to ρ₂=0 is any worldline lying in a linear two-dimensional subspace. However there are certain restrictions regarding the two four-vectors spanning a subspace accomodating a timelike worldline and within the subspace the two basis four-vectors can be freely chosen. According to the invention as defined in claim 11 a particularly simple and thus advantageous choice results in the four-velocity of a general timelike worldline with ρ₂=0 assuming the form

$$u ( τ ) = \pm \sqrt{1 + {γ ( τ )}^{2}} ( \begin{matrix}\sqrt{1 + {B}^{2}} \\ B\end{matrix} ) + γ ( τ ) ( \begin{matrix}0 \\ G\end{matrix} ) with {G}^{2} = 1 and G \cdot B = 0$$

with γ(τ) being an arbitrary differentiable function and with B, G being arbitrary constant three-dimensional vectors with the above defined properties.

Similarly according to the invention as defined in claim 12 a particularly simple and thus advantageous form of the four-velocity of a general timelike wordline with ρ3=0 is given by the expression

$$u ( τ ) = ( \begin{matrix}\frac{1}{\sqrt{1 + \frac{1 - {H}^{2}}{{[ \hat{u} ( τ ) \cdot H ]}^{2}}}} \\ \pm \sqrt{\frac{1 - {H}^{2}}{{[ \hat{u} ( τ ) \times H ]}^{2} - 1}} \hat{u} ( τ )\end{matrix} ) , H = ( \begin{matrix}[ \pm ] \sqrt{{H}^{2} - 1} \\ H\end{matrix} )$$

with û(τ) being a unit vector arbitrarily varying with proper time and with H being a constant four-vector, which is Minkowski-orthogonal to the three-dimensional linear subspace accomodating the timelike worldline. ± and [±] can be chosen independently.

The problem of calculating a timelike worldline describing a circular movement with the second 4D-curvature (first torsion) ρ₂ of the 4D-Frenet-Serret frame being zero is solved by the method defined in claim 13.

The invention is further directed according to claim 14 to a computer program executing one of the methods defined in claims 1-13.

The invention is further directed according to claim 15 to a storage medium, for example solid state disc, hard disc, USB-stick or CD-Rom etc., storing a program as defined in claim 14.

### BRIEF DESCRIPTION OF THE DRAWINGS

Not Applicable

### DETAILED DESCRIPTION OF THE PREFERRED EMBODIMENTS

Before the 4D-Frenet-Serret frame is treated in detail, the problem of calculating the transport property D′η of a local frame L′η=LηRη with

$$R η = ( \begin{matrix}1 & 0 \\ 0 & R\end{matrix} )$$

being a spatial rotation is solved by using the matrix partitioning defined in equ. (13). As proven in annex 5 “Calculation of the transport property D′η of local frame L′η=LηRη from the transport property Dη and the rotation Rη” D₁, D′₂ can be determined from D₁, D₂ and R by the following formulas:

$${L}^{′} η := L η R η ∧ R η = ( \begin{matrix}1 & 0 \\ 0 & R\end{matrix} ) ⇒ {D}_{1}^{′} = {R}^{T} {D}_{1} ∧ {D}_{2}^{′} = {R}^{T} {D}_{2} + Ω \\ ⇔ {D}^{′} η = ( \begin{matrix}0 & {D}_{1}^{′ T} \\ {D}_{1}^{′} & {[ {D}_{2}^{′} ]}_{\times }\end{matrix} ) = ( \begin{matrix}0 & {( {R}^{T} {D}_{1} )}^{T} \\ {R}^{T} {D}_{1} & {[ {R}^{T} {D}_{2} + Ω ]}_{\times }\end{matrix} ) \qquad ( 33 )$$

with the three-dimensional vector Ω being defined by

$${[ Ω ]}_{\times } := {R}^{T} \frac{d R}{d τ} \qquad ( 34 )$$

Note that the three-dimensional matrix

$${R}^{T} \frac{d R}{d τ}$$

is skew symmetric and can thus be written in the form [Ω]ₓ (see equ. (14) above) for reasons given in said annex 5.

Using equ. (33) and (28) it is shown in Annex 6 “The 4D-Frenet-Serret frame is uniquely determined by equ. (27) for a given timelike worldline in case of ρ₂≠0, but not in case of ρ₂=0” that the following statements hold with [symbol] being the 3D-rotation inside a 4D-rotation of the form

$$R η = ( \begin{matrix}1 & 0 \\ 0 & R\end{matrix} ) :$$

$$\begin{matrix}{ρ}_{2} \neq 0 & ⇒ & 4 D - Frenet - Serret frame uniquely \\ determined by equ . ( 27 )\end{matrix} \qquad ( 35 )$$

$$\begin{matrix}{ρ}_{2} = 0 ∧ {ρ}_{1} \neq 0 & ⇒ & 4 D - Frenet - Serret frame determined \\ by equ . ( 27 ) up to a rotation R with \\ axis {( 100 )}^{T} and an arbitrary , but \\ constant angle\end{matrix} \qquad ( 36 )$$

$${ρ}_{2} = 0 ∧ {ρ}_{1} = 0 \qquad ⇒ \qquad 4 D - Fernet - Serret \\ frame determined by equ . ( 27 ) \\ up to a rotation R w ith an \\ arbitrary , but constant axis \\ and an \\ arbitrary , but constant angle \qquad ( 37 )$$

Note that the 4D-Frenet-Serret frame is uniquely determined by equation (27) in case of ρ₂≠0 only for a given timelike worldline. Two local frames of different worldlines can have the same transport property as shown in the second paragraph below equ. (16) above.

Now we turn to the problem of constructing an expression for the 4D-Frenet-Serret frame, which is also valid in case of ρ3=0. In annex 7 “Expression for the fourth column vector N₃ of a local frame” it is proven that the fourth column vector N₃ of an arbitrary local frame

$$L η = ( \begin{matrix}{N}_{0} & {N}_{1} & {N}_{2} & {N}_{3}\end{matrix} ) = ( \begin{matrix}{N}_{0}^{0} & {N}_{1}^{0} & {N}_{2}^{0} & {N}_{3}^{0} \\ {N}_{0} & {N}_{1} & {N}_{2} & {N}_{3}\end{matrix} )$$

can be determined from the first three column vectors N₀=u, N₁ and N₂ by equ. (32):

$${N}_{3} = ( \begin{matrix}{N}_{3}^{0} \\ {N}_{3}\end{matrix} ) = ( \begin{matrix}{u}^{T} \\ \frac{1}{{u}^{0}} ( 1 + {uu}^{T} )\end{matrix} ) ( {N}_{1} \times {N}_{2} )$$

In annex 8 “N₃ of equ. (32) in Einsteinian notation” it is proven that equ. (32) can be formulated in Einsteinian notation in the following way

$${N}_{3}^{μ} = \{ - 2 {u}^{μ} {n}_{ν} - \frac{1}{{u}^{γ} {n}_{γ}} [ {δ}_{ν}^{μ} + {u}^{μ} {u}_{ν} + {n}^{μ} {n}_{ν} ] \} {N}_{2 α} {N}_{1 β} {E}_{σ}^{αβν} {n}^{σ} \qquad ( 38 )$$

with δ^{μ}ᵥ being the Kronecker symbol, E being the Levi-Civita tensor (equ. (96) and (97)) and with n being the four-velocity of an observer at rest given in equ. (17). In this form the result can be generalised to metrics other than the Minkowski metric.

Formula (32) can also be used to calculate N₂, if N₀=u, N₁ and N₃ are given, since one can first calculate the fourth four-vector of the local frame (u, N₁, N₃, ?) and then multiply the result by −1 and exchange the last two columns in order to keep the determinant equal to 1. Thus

$${N}_{2} = ( \begin{matrix}{u}^{T} \\ \frac{1}{{u}^{0}} ( 1 + {uu}^{T} )\end{matrix} ) ( {N}_{3} \times {N}_{1} ) \qquad ( 39 )$$

and in an analogous manner (without multiplication with −1 and with two subsequent exchanges of columns)

$${N}_{1} = ( \begin{matrix}{u}^{T} \\ \frac{1}{{u}^{0}} ( 1 + {uu}^{T} )\end{matrix} ) ( {N}_{2} \times {N}_{3} ) \qquad ( 40 )$$

In annex 10 “Using equ. (32) to calculate the fourth column vector *N̅₃ of the 4D-Frenet-Serret frame *L̅η” it is shown that application of equation (32) to the 4D-Frenet-Serret frame yields

$${*}^{} {\overline{N}}_{3} = \frac{1}{{ρ}_{1}^{2} {ρ}_{2}} \frac{1}{{u}^{0}} ( \begin{matrix}{u}^{0} u \cdot ( a \times \frac{da}{d τ} ) \\ ( a \times \frac{da}{d τ} ) + [ u \cdot ( a \times \frac{da}{d τ} ) ] u - ( a \cdot a ) ( a \times u )\end{matrix} ) \qquad ( 41 )$$

An advantage of this form with respect to equ. (25) is not only that it is also valid in case of ρ3=0, but that it also does not require calculation of

$$\frac{{d}^{2} a}{d τ} .$$

By replacing in the textbook version of the 4D-Frenet-Serret L̅η the expression for the fourth four-vector N̅₃ of equ. (25) with one of the equivalent expressions equ. (32)/(38)/(41) of four-vector *N̅₃ one can thus construct the following analytical expression for the 4D-Frenet-Serret frame

L̅η:=(N̅₀N̅₁N̅₂*N̅₃) (42)

which is in contrast to L̅η also valid in case of ρ3=0, Necessarily the following applies:

ρ₃≠0⇒*N̅₃=N̅₃⇒*L̅η=L̅η

But the expression *L̅η is still not well defined in case of ρ2=0 or ρ₁=0.

In order to solve the problem of providing an expression for the 4D-Frenet-Serret frame, which is also valid in case of ρ₂=0 or ρ₁=0, the 4D-Frenet-Serret frame is factorised as follows:

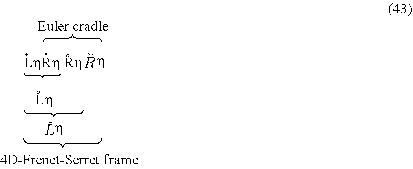

wherein

\dot{L}η is a 4D-Frenet-Serret frame if ρ₁=0

L̊η is a local frame related to the 3D-Frenet-Serret frame of r

[symbol] η is a 4D-Frenet-Serret frame if ρ₂=0∧u [symbol] a(⇒ρ₁≠0)

Quantities r, u, a are defined in equ. (1), (2) and (4) and ρ₁, ρ₂ are the first and second curvatures of the 4D-Frenet-Serret frame defined in equ. (19), (21), (26), (27), (29) and (30). The 4D-Frenet-Serret frame constructed according to equ. (43) is in case of ρ₂≠0 identical to the 4D-Frenet-Serret frame *L̅η constructed according to equ. (42) and is also well defined in case of ρ₂=0 and in case of ρ₁=0 and thus solves the problem of providing an expression for the 4D-Frenet-Serret frame which is well defined, if one or more of the 4D-curvatures ρ₁, ρ₂, β are vanishing. The three spatial rotations \dot{R}η, R̊η, [symbol] η form an Euler cradle.

In the following one has to carefully distinguish between quantities with a dot \dot{ }, with a ring ̊, with a breve [symbol] , with an overline and (only in the annexes) with a tilde \tilde{ }Three-dimensional vectors with a hat \hat{ }denote always unit vectors.

In order to prove that the 4D-Frenet-Serret frame can be factorised in the manner indicated in equ. (43) we start with the definition of the frame [symbol] η:

$${L}^{∪} η := ( \begin{matrix}{u}^{0} & \frac{{a}^{0}}{\sqrt{a \cdot a}} & - \frac{{( u ⨯ a )}^{2}}{\sqrt{( a \cdot a ) {( u ⨯ a )}^{2}}} & 0 \\ u & \frac{a}{\sqrt{a \cdot a}} & - \frac{( {u}^{0} a - {a}^{0} u ) ⨯ ( u \times a )}{\sqrt{( a \cdot a ) {( u ⨯ a )}^{2}}} & \frac{u ⨯ a}{\sqrt{{( u \times a )}^{2}}}\end{matrix} ) \qquad ( 44 )$$

$$= ( \begin{matrix}{{N}_{0}^{0}}^{∪} & {{N}_{1}^{0}}^{∪} & {{N}_{2}^{0}}^{∪} & {{N}_{3}^{0}}^{∪} \\ {{N}^{∪}}_{0} & {{N}^{∪}}_{1} & {{N}^{∪}}_{2} & {{N}^{∪}}_{3}\end{matrix} ) = ( {{N}^{∪}}_{0} {{N}^{∪}}_{1} {{N}^{∪}}_{2} {{N}^{∪}}_{3} ) \qquad ( 45 )$$

That this frame is a local frame, i.e. that it fulfils conditions (7), (8) and (9) above, is proven in annex 11 “Frame [symbol] η is a local frame”.

Expressions for column vectors [symbol] ₂ and [symbol] ₃ in Einsteinan notation are derived in annex 12 “ [symbol] ₂ and [symbol] ₃ in Einsteinian notation” with the following results:

$${{N}_{2}^{μ}}^{∪} = \frac{{{c}_{2}^{μ}}^{∪}}{\sqrt{{{c}^{∪}}_{2 γ}^{} {{{c}^{∪}}_{2}^{γ}}^{}}} with {{c}_{2}^{μ}}^{∪} = {a}^{α} {u}^{β} {E}_{αβ v}^{μ} {{c}^{∪}}_{3}^{v} = {a}_{α} {u}_{β} {E}_{v}^{αβμ} {{c}^{∪}}_{3}^{v} \qquad ( 46 )$$

$${{N}_{3}^{μ}}^{∪} = \frac{{{c}^{∪}}_{3}^{μ}}{\sqrt{{{c}^{∪}}_{3 γ}^{} {{c}^{∪}}_{3}^{γ}}} with {{c}^{∪}}_{3}^{μ} = {a}^{α} {u}^{β} {E}_{αβ v}^{μ} {n}^{v} = {a}_{α} {u}_{β} {E}_{v}^{αβμ} {n}^{v} \qquad ( 47 )$$

Since both *L̅η and [symbol] η are local frames, they are linked by a spatial rotation R̆η. The rotation matrix R̆η= [symbol] η⁻¹*L̅η is calculated in annex 13 “Calculation of R̆η=( [symbol] η)⁻¹*L̅η” with the following result:

$${R}^{∪} η = ( \begin{matrix}1 & 0 \\ 0 & {R}^{∪} ( τ )\end{matrix} ) = ( \begin{matrix}1 & 0 & 0 & 0 \\ 0 & 1 & 0 & 0 \\ 0 & 0 & cos ( {α}^{∪} ) & sin ( {α}^{∪} ) \\ 0 & 0 & - s in ( {α}^{∪} ) & cos ( {α}^{∪} )\end{matrix} ) \qquad ( 48 )$$

$${α}^{∪} = \{ \begin{matrix}atan 2 {\overbrace{( - \frac{1}{{ρ}_{1} {ρ}_{2}} \frac{\vert u a \frac{da}{d τ} \vert}{\sqrt{{( u ⨯ a )}^{2}}}}}^{sin ( {α}^{∪} )} , {\overbrace{\frac{1}{{u}^{0}} \vert {\overline{N}}_{1} {\overline{N}}_{2} {{N}^{∪}}_{3} \vert )}}^{cos ( {α}^{∪} )} & if {ρ}_{2} \neq 0 \\ 0 or any other constant ∈ & if {ρ}_{2} = 0\end{matrix} \qquad ( 49 )$$

wherein the first alternative is always well defined for ρ₂≠0 because of

ρ₂≠0⇒[ρ₁≠0∧u [symbol] a]

and wherein |a b c| denotes as usual the determinant of the 3×3 matrix (a b c). “atan2” is the four quadrant version of the conventional arctangent, i.e.

a tan 2[sin(α), cos(α)]=α

applies in all four quadrants. The relation of atan2 to the conventional arctangent can be found in textbooks like [14, equ. (18.19) on p. 443] (the order of the two arguments is different in [14], different authors/programming languages use different conventions regarding the order of the two arguments) and is also given in annex 14 “atan2”. Note that in general [symbol] ₂≠N̅₂, [symbol] ₃≠N̅₃, but [symbol] ₀=N̅₀, [symbol] ₁=N̅₁. This distinction is particularly important in the determinant |N̅₁ N̅₂ N̆₃|.

Strictly speaking annex 13 “Calculation of [symbol] η=( [symbol] η)⁻¹*L̅η” proves only the first alternative of equ. (49), the second alternative can be derived from the transport property [symbol] η of [symbol] η, which is calculated in annex 15 “Calculation of the transport property [symbol] η of [symbol] η” with the following result:

$${D}^{∪} η = ( \begin{matrix}0 & {ρ}_{1} & 0 & 0 \\ {ρ}_{1} & 0 & - 〈 \pm 〉 \sqrt{{ρ}_{2}^{2} - {x}^{2}} & - x \\ 0 & 〈 \pm 〉 \sqrt{{ρ}_{2}^{2} - {x}^{2}} & 0 & - x \frac{{a}^{0}}{\sqrt{{( u ⨯ a )}^{2}}} \\ 0 & x & x \frac{{a}^{0}}{\sqrt{{( u ⨯ a )}^{2}}} & 0\end{matrix} ) \qquad ( 50 )$$

$$with$$

$$x = \frac{1}{{ρ}_{1}} \frac{\vert u a \frac{da}{d τ} \vert}{\sqrt{{( u ⨯ a )}^{2}}}$$

$$and with \\ 〈 \pm 〉 := \{ \begin{matrix}0 & if \vert {\overline{N}}_{1} {\overline{N}}_{2} {{N}^{∪}}_{3} \vert = 0 \\ \frac{\vert {\overline{N}}_{1} {\overline{N}}_{2} {{N}^{∪}}_{3} \vert}{\vert \vert {\overline{N}}_{1} {\overline{N}}_{2} {{N}^{∪}}_{3} \vert \vert} & if \vert {\overline{N}}_{1} {\overline{N}}_{2} {{N}^{∪}}_{3} \vert \neq 0\end{matrix} \qquad ( 51 )$$

From this one can see that [symbol] η is a 4D-Frenet-Serret frame in case of ρ₂=0 and a [symbol] u: as stated in the paragraph below equ. (31) above ρ₂=0 applies if and only if u, a,

$$\frac{d a}{d τ}$$

are linearly dependent, which implies that u, a,

$$\frac{d a}{d τ}$$

are linearly dependent, i.e.

$$if a u \\ {ρ}_{2} = 0 ⇒ \vert u a \frac{da}{d τ} \vert = 0 {⇒}^{↓} x = 0$$

Note that

a [symbol] u⇒ρ₁≠0

The transport property [symbol] η with ρ₂=0∧a [symbol] u, which implies ρ₃=0, assumes thus the form

$${ρ}_{2} = 0 ∧ a u ⇒ {D}^{∪} η = ( \begin{matrix}0 & {ρ}_{1} & 0 & 0 \\ {ρ}_{1} & 0 & 0 & 0 \\ 0 & 0 & 0 & 0 \\ 0 & 0 & 0 & 0\end{matrix} ) \qquad ( 52 )$$

and comparing this with the transport property D̅η of the 4D-Frenet-Serret frame in equ. (26) one can see that the transport property [symbol] η with ρ₂=0 ∧a [symbol] u happens to be identical to the transport property D̅η of the 4D-Frenet-Serret frame. Thus [symbol] η is a 4D-Frenet-Serret frame for this case. Because of a [symbol] u⇒ρ₁≠0 this is a subcase of the statement (36) above, i.e. the 4D-Frenet-Serret frame is in this case determined by equ. (27) only up to a rotation [symbol] with axis (1 0 0)^{T} and an arbitrary, but constant angle. As can be seen from equ. (48) the axis of [symbol] is (1 0 0)^{T} and for this reason the angle [symbol] , which is not well defined in the first alternative of equ. (49) in the case ρ₂=0, can assume in this case according to the second alternative of equ. (49) any constant value ∈ [symbol] . We have thus proven the correctness of the second alternative of equ. (49).

In case of ρ₂=0 ∧a [symbol] u the two four-vectors [symbol] ₂ and [symbol] ₃ constitute two time independent and Minkowski-orthonormal basis four-vectors of the two-dimensional linear subspace, which is complementary to the two-dimensional linear subspace accomodating the worldline, although [symbol] ₂ and [symbol] ₃ are constructed from time dependent four-vectors u(τ) and α(τ). There is in this case thus no need to choose an arbitrary, but fixed proper time τ* as in the method disclosed in [1].

In those many applications in which a∥ u can be excluded the 4D-Frenet-Serret frame covering the cases ρ₃=0 and ρ₂=0 thus assumes the simple form

**L̅η:= [symbol] η [symbol] η

### Necessarily the Following Applies:

ρ₃≠0⇒**L̅η=*L̅η=L̅η

ρ₃=0∧ρ₂≠0⇒**L̅η=*L̅η

If one wants to cover also the case a∥ u, then also the other local frames in equ. (43) have to be considered. The next frame L̊η appearing in equ. (43) is defined as follows:

$${L}^{˚} η := ( \begin{matrix}{u}^{0} & \sqrt{{u}^{2}} & 0 & 0 \\ u & \frac{{u}^{0}}{\sqrt{{u}^{2}}} u & - \frac{u ⨯ ( u ⨯ a )}{\sqrt{{[ u ⨯ ( u ⨯ a ) ]}^{2}}} & \frac{u ⨯ a}{\sqrt{{( u ⨯ a )}^{2}}}\end{matrix} ) = \qquad ( 53 )$$

$$= ( \begin{matrix}{u}^{0} & \frac{{u}^{0}}{\sqrt{{u}^{2}}} \frac{{u}^{2}}{{u}^{0}} & 0 & 0 \\ u & \frac{{u}^{0}}{\sqrt{{u}^{2}}} u & - \frac{u ⨯ ( u ⨯ a )}{\sqrt{{[ u ⨯ ( u ⨯ a ) ]}^{2}}} & \frac{u ⨯ a}{\sqrt{{( u ⨯ a )}^{2}}}\end{matrix} ) = \qquad ( 54 )$$

$$= ( \begin{matrix}{u}^{0} & \sqrt{{u}^{2}} & 0 & 0 \\ \sqrt{{u}^{2}} \hat{u} & {u}^{0} \hat{u} & - \hat{u ⨯} & \end{matrix} ) {=}^{{↓}^{annex 4}} \qquad ( 55 )$$

$$= ( \begin{matrix}{u}^{0} & \sqrt{{u}^{2}} & 0 & 0 \\ u & {u}^{0} \hat{u} & & \hat{u} ⨯\end{matrix} ) = \qquad ( 56 )$$

$$= ( \begin{matrix}{\mathring{N}}_{0}^{0} & {\mathring{N}}_{1}^{0} & {\mathring{N}}_{2}^{0} & {\mathring{N}}_{3}^{0} \\ {\mathring{N}}_{0} & {\mathring{N}}_{1} & {\mathring{N}}_{2} & {\mathring{N}}_{3}\end{matrix} ) = ( {\mathring{N}}_{0} {\mathring{N}}_{1} {\mathring{N}}_{2} {\mathring{N}}_{3} ) \qquad ( 57 )$$

An Einsteinian notation of four-vectors N̊₁, N̊₂, N̊₃ is derived in annex 18 “Einsteinian notation of four-vectors N̊₁, N̊₂, N̊₃ and \dot{N}₁, \dot{N}₂, \dot{N}₃” with the following result:

$${{N}^{˚}}_{3}^{μ} = \frac{{{c}^{˚}}_{3}^{μ}}{\sqrt{{\mathring{c}}_{3 γ}^{} {\mathring{c}}_{3}^{γ}}} with {{c}^{˚}}_{3}^{μ} = {a}^{α} {u}^{β} {E}_{αβν}^{μ} {n}^{ν} = {a}_{α} {u}_{β} {E}_{ν}^{αβμ} {n}^{ν} \qquad ( 58 )$$

$${{N}^{˚}}_{2}^{μ} = \frac{{{c}^{˚}}_{2}^{μ}}{\sqrt{{{c}^{˚}}_{2 γ} {{c}^{˚}}_{2}^{γ}}} with {{c}^{˚}}_{2}^{μ} = {a}^{α} {{c}^{˚}}_{3}^{β} {E}_{αβν}^{μ} {n}^{ν} = {a}_{α} {{c}^{˚}}_{3 β} {E}_{ν}^{αβμ} {n}^{ν} \qquad ( 59 )$$

$${{N}^{˚}}_{1}^{μ} = \frac{1}{( {{c}^{˚}}_{3 γ} {{c}^{˚}}_{3}^{γ} ) \sqrt{{( {u}_{ϵ} {n}^{ϵ} )}^{2} - 1}} {u}_{α} {{c}^{˚}}_{3 β} {E}_{v}^{αβμ} {{c}^{˚}}_{2}^{v} \qquad ( 60 )$$

That L̊η is a local frame (provided u [symbol] a) is proven in annex 17 “Calculation of the transport property \tilde{D}η of local frame \tilde{L}η generalising frames \dot{L}η and L̊η”.

The transport property D̊η of local frame L̊η is calculated in annex 19 “Calculation of the transport property D̊η of local frame L̊η” with the following result:

$${D}^{˚} η = ( \begin{matrix}0 & \frac{{a}^{0}}{\sqrt{{u}^{2}}} & {u}^{2} κ & 0 \\ \frac{{a}^{0}}{\sqrt{{u}^{2}}} & 0 & - {u}^{0} \sqrt{{u}^{2}} κ & 0 \\ {u}^{2} κ & {u}^{0} \sqrt{{u}^{2}} κ & 0 & - τ \sqrt{{u}^{2}} \\ 0 & 0 & τ \sqrt{{u}^{2}} & 0\end{matrix} )$$

wherein [symbol] is the 3D-curvature and T is the 3D-torsion of the three-dimensional Euclidian 3D-Frenet-Serret frame (see equ. (87) in annex 4 “Euclidian 3D-Frenet-Serret frame”) of the spatial part r(τ) of the timelike worldline r(τ) defined in equ. (1) above. There is an unfortunate resemblance between proper time τ and 3D-torsion τ, it should however always be possible to distinguish the two symbols and also the context should always prevent any confusion.

The rotation R̊η defined by [symbol] η=L̊ηR̊η is determined in annex 20 “Calculation of the rotation R̊η=(L̊η)⁻¹ [symbol] η” with the following result:

$${R}^{˚} η = ( \begin{matrix}1 & 0 \\ 0 & {R}^{˚} ( τ )\end{matrix} ) = ( \begin{matrix}1 & 0 & 0 & 0 \\ 0 & cos ( {α}^{˚} ) & sin ( {α}^{˚} ) & 0 \\ 0 & - s in ( {α}^{˚} ) & cos ( {α}^{˚} ) & 0 \\ 0 & 0 & 0 & 1\end{matrix} ) \qquad ( 61 )$$

$$\mathring{α} = \{ \begin{matrix}atan 2 {\overbrace{( - \frac{\sqrt{{( u ⨯ a )}^{2}}}{{ρ}_{1} \sqrt{{u}^{2}}}}}^{sin ( \mathring{α} )} , {\overbrace{\frac{{a}^{0}}{{ρ}_{1} \sqrt{{u}^{2}}} )}}^{cos ( \mathring{α} )} & if {ρ}_{1} \neq 0 \\ 0 or any other constant ∈ & if {ρ}_{1} = 0\end{matrix} \qquad ( 62 )$$

or equivalently

$$\mathring{α} = \{ \begin{matrix}atan 2 {\overbrace{( - \frac{{u}^{2}}{{ρ}_{1}} κ}}^{sin ( \mathring{α} )} , {\overbrace{\frac{{a}^{0}}{\vert {a}^{0} \vert} \sqrt{1 - \frac{{u}^{4}}{{ρ}_{1}^{2}}} {κ}^{2} )}}^{cos ( \mathring{α} )} & if {ρ}_{1} \neq 0 \\ 0 or any other constant ∈ & if {ρ}_{1} = 0\end{matrix} \qquad ( 63 )$$

with ρ₁=\sqrt{a·a} being the first curvature of the 4D-Frenet-Serret frame defined in equations (19) and (27) above. While L̊η is a local frame only if u [symbol] a, R̊η is also uniquely defined in case of u∥ a as long as ρ₁≠0, i.e. as long as \sqrt{u²} ≠constant.

Strictly speaking annex 20 “Calculation of the rotation R̊η=(L̊η)⁻¹ [symbol] η” proves only the first alternative of equ. (62)/(63), the proof of the second alternative is postponed to the discussion of the last local frame \dot{L}η, which is defined as follows:

$$\dot{L} η := ( \begin{matrix}{u}^{0} & \sqrt{{u}^{2}} & 0 & 0 \\ u & \frac{{u}^{0}}{\sqrt{{u}^{2}}} u & - \frac{u ⨯ ( u ⨯ b )}{\sqrt{{[ u ⨯ ( u ⨯ b ) ]}^{2}}} & \frac{u ⨯ b}{\sqrt{{( u ⨯ b )}^{2}}}\end{matrix} ) = \qquad ( 64 )$$

$$= ( \begin{matrix}{u}^{0} & \sqrt{{u}^{2}} & 0 & 0 \\ \sqrt{{u}^{2}} \hat{u} & {u}^{0} \hat{u} & - \hat{u} ⨯ ( ) & \end{matrix} ) = \qquad ( 65 )$$

$$= ( \begin{matrix}{\dot{N}}_{0}^{0} & {\dot{N}}_{1}^{0} & {\dot{N}}_{2}^{0} & {\dot{N}}_{3}^{0} \\ {\dot{N}}_{0} & {\dot{N}}_{1} & {\dot{N}}_{2} & {\dot{N}}_{3}\end{matrix} ) = ( {\dot{N}}_{0} {\dot{N}}_{1} {\dot{N}}_{2} {\dot{N}}_{3} ) \qquad ( 66 )$$

The vector b is an arbitrary constant vector

$$( \frac{d b}{d τ} = 0 )$$

with b [symbol] u.

An Einsteinian notation of four-vectors \dot{N}₁, \dot{N}₂, \dot{N}₃ is derived in annex 18 “Einsteinian notation of four-vectors N̊₁, N̊₂, N̊₃ and \dot{N}₁, \dot{N}₂, \dot{N}₃” with the following result:

$${\dot{N}}_{3}^{μ} = \frac{{\dot{c}}_{3}^{μ}}{\sqrt{{\dot{c}}_{3 γ} {\dot{c}}_{3}^{γ}}} with {\dot{c}}_{3}^{μ} = {b}^{α} {u}^{β} {E}_{αβ v}^{μ} {n}^{v} = {b}_{α} {u}_{β} {E}_{v}^{α β μ} {n}^{v} \qquad ( 67 )$$

$${\dot{N}}_{2}^{μ} = \frac{{\dot{c}}_{2}^{μ}}{\sqrt{{\dot{c}}_{2 γ} {\dot{c}}_{2}^{γ}}} with {\dot{c}}_{2}^{μ} = {b}^{α} {\dot{c}}_{3}^{β} {E}_{αβ v}^{μ} {n}^{v} = {b}_{α} {\dot{c}}_{3 β} {E}_{v}^{α β μ} {n}^{v} \qquad ( 68 )$$

$${\dot{N}}_{1}^{μ} = \frac{1}{( {\dot{c}}_{3 γ} {\dot{c}}_{3}^{γ} ) \sqrt{{( {u}_{ϵ} {n}^{ϵ} )}^{2} - 1}} {u}_{α} {\dot{c}}_{3 β} {E}_{v}^{αβμ} {\dot{c}}_{2}^{v} \qquad ( 69 )$$

That \dot{L}η is a local frame (provided u [symbol] b) is proven in annex 17 “Calculation of the transport property \tilde{D}η of local frame \tilde{L}η generalising frames \dot{L}η and L̊η”.

In the form of equ. (65) local frame \dot{L}η is also well defined in case of \sqrt{u²}=0:

$$\sqrt{{u}^{2}} = 0 ⇒ {\dot{L}}_{η} = \{ \begin{matrix}1 & 0 & 0 & 0 \\ 0 & \hat{u} & - \hat{u} \times ( ) & \end{matrix} ) = ( \begin{matrix}1 & 0 \\ 0 & {R}_{0}\end{matrix} )$$

with [symbol] ₀ being a three-dimensional rotation matrix.

In annex 21 “Calculation of the rotation \dot{R}η=(\dot{L}η)⁻¹ L̊η” the rotation \dot{R}η defined by the equation L̊η=\dot{L}η\dot{R}η is calculated with the following result:

$${\dot{R}}_{η} = ( \begin{matrix}1 & 0 \\ 0 & \dot{R} ( τ )\end{matrix} ) = ( \begin{matrix}1 & 0 & 0 & 0 \\ 0 & 1 & 0 & 0 \\ 0 & 0 & cos ( \dot{α} ) & sin ( \dot{α} ) \\ 0 & 0 & - sin ( \dot{α} ) & cos ( \dot{α} )\end{matrix} ) \qquad ( 70 )$$

$$\dot{α} = \{ \begin{matrix}a tan 2 ( {\overbrace{\frac{\sqrt{{u}^{2}} a \cdot ( u \times b )}{\sqrt{{u \times b )}^{2} {( u \times a )}^{2}}}}}^{sin ( \dot{α} )} {, \overbrace{\frac{( u \times a ) \cdot ( u \times b )}{\sqrt{{( u \times b )}^{2} {( u \times a )}^{2}}}}}^{cos ( \dot{α} )} ) & if u a ∧ {ρ}_{1} \neq 0 \\ 0 & if u ∥ a ∧ {ρ}_{1} \neq 0 \\ 0 or any other constant ∈ & if u ∥ a ∧ {ρ}_{1} = 0\end{matrix} \qquad ( 71 )$$

Strictly speaking annex 21 “Calculation of the rotation \dot{R}η=(\dot{L}η)⁻¹ L̊η” proves only the first alternative of equ. (71), the proof of the second and third alternatives is given after the presentation of the transport property of the local frame \dot{L}η, which is calculated in annex 22 “Determination of the transport property \dot{D}η of local frame \dot{L}η” with the following result:

$${\dot{D}}_{η} == η ( \begin{matrix}0 & * & * & * \\ \frac{{a}^{0}}{\sqrt{{u}^{2}}} & 0 & * & * \\ - \frac{1}{\sqrt{{u}^{2}}} \frac{[ u \times ( u \times b ) ] \cdot a}{\sqrt{{( u \times b )}^{2}}} & - \frac{{u}^{0}}{{u}^{2}} \frac{[ u \times ( u \times b ) ] \cdot a}{\sqrt{{( u \times b )}^{2}}} & 0 & * \\ \frac{a \cdot ( u \times b )}{\sqrt{{( u \times b )}^{2}}} & \frac{{u}^{0}}{\sqrt{{u}^{2}}} \frac{a \cdot ( u \times b )}{\sqrt{{( u \times b )}^{2}}} & \frac{( u \cdot b ) [ a \cdot ( b \times u ) ]}{{( u \times b )}^{2} \sqrt{{u}^{2}}} & 0\end{matrix} ) = \qquad ( 72 )$$

$$= η ( \begin{matrix}0 & * & * & * \\ \frac{1}{{u}^{0}} \frac{d \sqrt{{u}^{2}}}{d τ} & 0 & * & * \\ - \sqrt{{u}^{2}} \frac{\hat{u} \times ( \hat{u} \times b ) ] \cdot \frac{d \hat{u}}{d τ}}{\sqrt{{( \hat{u} \times b )}^{2}}} & - {u}^{0} \frac{[ \hat{u} \times ( \hat{u} \times b ) ] \cdot \frac{d \hat{u}}{d τ}}{\sqrt{{( \hat{u} \times b )}^{2}}} & 0 & * \\ \sqrt{{u}^{2}} \frac{\frac{d \hat{u}}{d τ} \cdot ( \hat{u} \times b )}{\sqrt{{( \hat{u} \times b )}^{2}}} & {u}^{0} \frac{\frac{d \hat{u}}{d τ} \cdot ( \hat{u} \times b )}{\sqrt{{( \hat{u} \times b )}^{2}}} & \frac{( \hat{u} \cdot b ) [ \frac{d \hat{u}}{d τ} \cdot ( b \times \hat{u} ) ]}{{( \hat{u} \times b )}^{2}} & 0\end{matrix} ) \qquad ( 73 )$$

wherein the stars * complement the skew symmetric matrix (η\dot{D}η is skew symmetric according to equ. (85), but \dot{D}η is not).

Now all ingredients required to prove the second alternative of equ. (62)/(63) and the second and third alternatives of equ. (71) are derived. The proof is given in annex 23 “Proof of the second alternative of equ. (62)/(63) and the second and third alternatives of equ. (71)”. Thus the 4D-Frenet-Serret frame ***L̅η defined in equ. (43) as

***L̅η:=\dot{L}η\dot{R}ηR̊ηR̆η

provides in case of ρ₃=0 or ρ₂=0 or ρ₁=0 not only one possible 4D-Frenet-Serret frame, but all possible 4D-Frenet-Serret frames due to the possible choice of angles [symbol] , α̊, \dot{α}, while the textbook version \dot{L}η of the 4D-Frenet-Serret frame defined in equ. (20), (22), (25) is not defined at all in these cases. Of course the following identities apply:

$$\begin{matrix}{ρ}_{3} \neq 0 & {⇒}^{** *} {\overline{L}}_{η} {=}^{**} {\overline{L}}_{η} {=}^{*} {\overline{L}}_{η} = {\overline{L}}_{ ET } \\ {ρ}_{3} = 0 ∧ {ρ}_{2} \neq 0 & {⇒}^{** *} {\overline{L}}_{η} {=}^{**} {\overline{L}}_{η} {=}^{*} {\overline{L}}_{η} \\ {ρ}_{3} = 0 ∧ {ρ}_{2} = 0 ∧ A U & {⇒}^{** *} {\overline{L}}_{η} {=}^{**} {\overline{L}}_{η}\end{matrix}$$

In other words any two of the four different expressions ***L̅η, **L̅η, *L̅η and L̅η for the 4D-Frenet-Serret frame are identical for all those timelike wordlines for which both expressions are well defined and the transport property of any of the four different expressions ***N̅η, **L̅η, *L̅η and L̅η for the 4D-Frenet-Serret frame is of the form D̅η given in equ. (26) for any timelike worldline, for which the expression is well defined. If one of the four expressions is well defined for a certain timelike worldline, then all expressions with more preceding stars * are also well defined for this timelike worldline. ***L̅η is well defined for all timelike worldlines, since b can be chosen arbitrarily and can thus always be chosen such that b [symbol] u.

As shown in said annex 23 in case of ρ₂=0 ∧a∥u ∧ρ₁≠0 the two four-vectors

$$\frac{{a}^{0}}{\vert {a}^{0} \vert} {\dot{N}}_{2}$$

and \dot{N}₃ constitute two time independent and Minkowski-orthonormal basis four-vectors of the two-dimensional linear subspace, which is complementary to the two-dimensional linear subspace accomodating the worldline, although

$$\frac{{a}^{0}}{\vert {a}^{0} \vert} {\dot{N}}_{2}$$

and \dot{N}₃ are constructed from time dependent four-vectors u(τ) and α(τ). There is in this case thus no need to choose an arbitrary, but fixed proper time τ* as in the method disclosed in [1]. As shown in annex 32 “Calculation of

$${\overline{N}}_{1} = \frac{a}{\sqrt{a \cdot a}}$$

in case of a∥u ∧ρ₁≠0” the following identity holds in this case:

$$a ∥ u ∧ {ρ}_{1} \neq 0 ⇒ {\overline{N}}_{1} = \frac{a}{\sqrt{a \cdot a}} = \frac{{a}^{0}}{\vert {a}^{0} \vert} ( \begin{matrix}\sqrt{{u}^{2}} \\ \frac{{u}^{0}}{\sqrt{{u}^{2}}} u\end{matrix} ) = \frac{{a}^{0}}{\vert {a}^{0} \vert} {\dot{N}}_{1}$$

As likewise shown in said annex 23 in case of ρ₁=0 the three four-vectors \dot{N}₁, \dot{N}₂, \dot{N}₃ constitute three time independent and Minkowski-orthonormal basis four-vectors of the three-dimensional linear subspace, which is complementary to the one-dimensional linear subspace accomodating the worldline.

It is a further problem of the invention to provide an analytical expression for each of the three 4D-curvatures ρ₁, ρ₂ and ρ₃ in terms of the 3D-curvature [symbol] , the 3D-torsion τ and the magnitude \sqrt{u²} of the spatial part u of the four-velocity

$$u = ( \begin{matrix}{u}^{0} \\ u\end{matrix} )$$

of a timelike worldline

$$r = ( \begin{matrix}{r}^{0} \\ r\end{matrix} )$$

in order to be able to analytically calculate the 4D-curvatures, if the worldline is defined by [symbol] , τ and \sqrt{u²}, but the natural equation of the spatial part r cannot be solved analytically. That this is possible follows from the fact derived above in the second paragraph below equ. (16). Explicit analytical expressions for all three 4D-curvatures ρᵢ( [symbol] , τ, \sqrt{u²}) with i=1, 2, 3 are calculated in annex 24 “Calculation of the first 4D-curvature ρ₁=ρ₂( [symbol] , \sqrt{u²}) in terms of the 3D-curvature [symbol] and the magnitude \sqrt{u²} of the three-dimensional spatial part u of the four-velocity

$$u = {( \begin{matrix}{u}^{0} \\ u\end{matrix} )}^{∥} ,$$

annex 25 “Calculation of the second 4D-curvature ρ₂=ρ₂( [symbol] , τ, \sqrt{u²}) (first torsion) in terms of the 3D-curvature [symbol] , the 3D-torsion τ and the magnitude \sqrt{u²} of the three-dimensional spatial part u of the four-velocity

$$u = {( \begin{matrix}{u}^{0} \\ u\end{matrix} )}^{∥}$$

and annex 26 “Calculation of the third 4D-curvature ρ₃=ρ₃( [symbol] , τ, \sqrt{u²}) (second torsion, hyper-torsion, bi-torsion) in terms of the 3D-curvature [symbol] , the 3D-torsion τ and the magnitude \sqrt{u²} of the three-dimensional spatial part u of the four-velocity

$$u = {( \begin{matrix}{u}^{0} \\ u\end{matrix} )}^{∥} .$$

For the first curvature ρ₁ we get the following result:

$${ρ}_{1} = \sqrt{\frac{1}{{u}^{2} + 1} {( \frac{d \sqrt{{u}^{2}}}{d τ} )}^{2} + {u}^{4} {K}^{2}} = \qquad ( 74 )$$

$${{=}^{↓}}^{if K \neq 0} {u}^{2} K \sqrt{{( {\underbrace{\frac{1}{{Ku}^{2} \sqrt{{u}^{2} + 1}} \frac{d \sqrt{{u}^{2}}}{d τ}}}_{:= y} )}^{2} + 1} = {\sqrt{{u}^{2}}}^{3} K \sqrt{\frac{{y}^{2} + 1}{{u}^{2}}} \qquad ( 75 )$$

For the second curvature ρ₂, also called the first torsion, we get the following result:

$$\begin{matrix}if κ \neq 0 \\ {ρ}_{2} {=}^{↓}\end{matrix} \{ \begin{matrix}\sqrt{{u}^{2}} \sqrt{{κ}^{2} ( {u}^{2} + 1 ) + {τ}^{2}} & if y = 0 \\ \sqrt{{[ \frac{1}{2 y} \frac{d}{d τ} ( ln \frac{{u}^{2}}{{y}^{2} + 1} ) ]}^{2} + {τ}^{2} \frac{{u}^{2}}{{y}^{2} + 1}} & if y \neq 0\end{matrix} \qquad ( 76 )$$

If [symbol] =0, then ρ₂=0.

For the third curvature β₃, also called second torsion, hyper-torsion or bi-torsion, we get the following result:

$$\begin{matrix}if τ \neq 0 \\ {ρ}_{3} {=}^{↓}\end{matrix} \{ \begin{matrix}- \frac{d}{d τ} arctan ( \frac{κ}{\vert τ \vert} \sqrt{{u}^{2} + 1} ) & if y = 0 \\ y \frac{τ \sqrt{{u}^{2}}}{\sqrt{{y}^{2} + 1}} & if y \neq 0 ∧ \frac{d}{d τ} ( \frac{{y}^{2} + 1}{{u}^{2}} ) = 0 \\ \frac{1}{\frac{1}{τ y} \frac{d}{d τ} ( \frac{\sqrt{{y}^{2} + 1}}{\sqrt{{u}^{2}}} )} . & \\ \cdot \frac{d}{d τ} ln \{ \sqrt{1 + {[ \frac{1}{τ y} \frac{d}{d τ} ( \frac{\sqrt{{y}^{2} + 1}}{\sqrt{{u}^{2}}} ) ]}^{2}} \cdot ( \frac{\sqrt{{y}^{2} + 1}}{\sqrt{{u}^{2}}} ) \} & if y \neq 0 ∧ \frac{d}{d τ} ( \frac{{y}^{2} + 1}{{u}^{2}} ) \neq 0\end{matrix} \qquad ( 77 )$$

If τ=0, then β₃=0.

The quantity y is defined in equ. (75) as

$$y = \frac{1}{κ {u}^{2} \sqrt{{u}^{2} + 1}} \frac{d \sqrt{{u}^{2}}}{d τ}$$

but also the following equivalent definitions

$$\begin{matrix} & equ . ( 132 ) & \\ y & {=}^{↓} & \frac{{a}^{0}}{\sqrt{{( u \times a )}^{2}}}\end{matrix}$$

$$\begin{matrix} & equ . ( 138 ) & \\ \frac{{y}^{2} + 1}{{u}^{2}} & {=}^{↓} & \frac{{a}^{2}}{{( u \times a )}^{2}}\end{matrix}$$

can be helpful and provide in particular further possibilities to calculate ρ₁, β₂ or β₃.

Regarding equations (76), (77), (49) and (51) also the following nontrivial equivalence might be of interest:

$$\begin{matrix} & equ . ( 144 ) & \\ [ y \neq 0 ∧ \frac{d}{d τ} ( \frac{{y}^{2} + 1}{{u}^{2}} ) = 0 ] & {⇔}^{↓} & \vert \begin{matrix}{\overline{N}}_{1} & {\overline{N}}_{2} & {{N}^{⌣}}_{3}\end{matrix} \vert = 0\end{matrix} \qquad ( 78 )$$

In the following the conditions ρ₂=0, i=1, 2, 3 and their solutions are discussed. From equ. (74) one can immediately read:

$${ρ}_{1} = 0 ⇔ [ \frac{d \sqrt{{u}^{2}}}{d τ} = 0 ∧ κ = 0 ]$$

This is consistent with the condition described in the paragraph below equ. (31) that ρ₁=0 applies if and only if the timelike worldline r and thus also u and a are lying in a one dimensional subspace of four-dimensional Minkowski space. By derivation of condition (3) one can see that u is always Minkowski-orthogonal to α. As noted in textbook [2, p. 38] “any vector orthogonal to a timelike vector is necessarily spacelike or zero”. Since worldline r is timelike, the vector spanning said one dimensional subspace is also timelike. Thus the acceleration α must be zero, which is equivalent to

$$\frac{d \sqrt{{u}^{2}}}{d τ} = 0 ∧ κ = 0.$$

In annex 27 “3D-condition for ρ₂=0” it is shown that the condition ρ₂=0 is equivalent to the condition

$${ρ}_{2} = 0 ⇔ τ = 0 ∧ κ = \{ \begin{matrix}0 \\ or \\ \vert \frac{\frac{d \sqrt{{u}^{2}}}{d τ}}{{u}^{2} \sqrt{{u}^{2} + 1} \sqrt{{cu}^{2} - 1}} \vert\end{matrix} \qquad ( 79 )$$

or to the equivalent condition

$${ρ}_{2} = 0 ⇔ τ = 0 ∧ \{ \begin{matrix}\frac{d \hat{u}}{d τ} = 0 \\ or \\ {u}^{2} = {[ ( c + 1 ) {cos}^{2} ( \int \sqrt{{( \frac{d \hat{u}}{d τ} )}^{2}} d τ - {c}^{′} ) - 1 ]}^{- 1}\end{matrix} \qquad ( 80 )$$

with c, c′ ∈ [symbol] being constants.

Condition (79) (and consequently also condition (80)) is consistent with the statement in the paragraph below equ. (31) that ρ₂=0 applies if and only if the timelike worldline is lying in a two-dimensional linear subspace. In annex 28 “Construction of a general curve with ρ₂=0” it is shown that the four-velocity of the most general timelike worldline lying in a two-dimensional subspace can be expressed in the form

$$u = \pm \sqrt{1 + {γ ( τ )}^{2}} ( \begin{matrix}\sqrt{1 + {B}^{2}} \\ B\end{matrix} ) + γ ( τ ) ( \begin{matrix}0 \\ G\end{matrix} ) with {G}^{2} = 1 and G \cdot B = 0 \qquad ( 81 )$$

with γ(τ) being an arbitrary differentiable function and with B, G being arbitrary constant vectors with the above defined properties. In said annex 28 from this ansatz u²(γ) and [symbol] (γ) are calculated and from these two results then [symbol] (u²) is calculated. The result is identical to equ. (79) with

$$c = \frac{1}{{B}^{2}} = \frac{1}{{( G \times B )}^{2}}$$

As an interesting example in annex 29 “Circular movement with ρ₂=0” we show that the timelike worldline of an observer moving along a circle with radius R in a plane spanned by vectors B, G with ρ₂=0 can be written in the two forms

$$\begin{matrix}r ( τ ) = ( \begin{matrix}{r}^{0} ( τ ) \\ r ( τ )\end{matrix} ) = ( \begin{matrix}\int \sqrt{{( R \frac{d β}{d τ} )}^{2} + 1} d τ \\ R sin ( β ( τ ) ) B + R cos ( β ( τ ) ) G\end{matrix} ) == \\ \int \sqrt{1 + {γ ( τ )}^{2}} ( \begin{matrix}\sqrt{2} \\ B\end{matrix} ) + γ ( τ ) ( \begin{matrix}0 \\ G\end{matrix} ) d τ \\ with \\ {B}^{2} = {G}^{2} = 1 and G \cdot B = 0 \\ β ( τ ) = {E}^{〈 - 1 〉} ( \pm \frac{1}{R} τ + {c}^{″} , 2 ) and {γ}^{2} = \frac{{sin}^{2} β ( τ )}{1 - 2 {sin}^{2} β ( τ )}\end{matrix} \qquad ( 82 )$$

E⁽⁻¹⁾ (x, m) is the inversion of the elliptic integral of the second kind in Legendre form

$$E ( ϕ , m ) = {\int }_{0}^{ϕ} \sqrt{1 - m {sin}^{2} θ} d θ$$

and c″ ∈ [symbol] is an arbitrary constant. Note that m=2 is an unusually large parameter for an elliptic integral of the second kind and limits the interval of θ, ϕ and β(τ) and finally τ, for which the integral is real, i.e. for which a parametrisation is possible.

In annex 30 “3D-condition for ρ₃=0” it is shown that the condition ρ₃=0 is equivalent to the following conditions:

$${ρ}_{3} = 0 ⇔ τ = \{ \begin{matrix}0 & or \\ \pm \frac{κ}{c} \sqrt{{u}^{2} + 1} & if y = 0 \\ \pm \frac{1}{y} \frac{d}{d τ} \sqrt{c - \frac{{y}^{2} + 1}{{u}^{2}}} & if y \neq 0\end{matrix} \qquad ( 83 )$$

with c ∈ [symbol] being constant and with y being defined in equ. (74).

Conditions (83) are consistent with the statement in the paragraph below equ. (31) that ρ₃=0 if and only if the timelike worldline is lying in a three-dimensional linear subspace. In annex 31 “Construction of a general curve with ρ₃=0” it is shown that the four-velocity of the most general timelike worldline lying in a three-dimensional subspace can be expressed in the form

$$u ( τ ) = ( \begin{matrix}\frac{1}{\sqrt{1 + \frac{1 - {H}^{2}}{{[ \hat{u} ( τ ) \cdot H ]}^{2}}}} \\ \pm \sqrt{\frac{1 - {H}^{2}}{{[ \hat{u} ( τ ) \times H ]}^{2} - 1} \hat{u} ( τ )}\end{matrix} ) , H = ( \begin{matrix}[ \pm ] \sqrt{{H}^{2} - 1} \\ H\end{matrix} ) \qquad ( 84 )$$

with Û(τ) being a unit vector arbitrarily varying with time and with H being a constant four-vector Minkowski-orthogonal to the three-dimensional linear subspace accomodating the timelike worldline. ± and [±] can be chosen independently. In said annex 31 it is also shown that this worldline fulfills in case of

$$y = 0 ⇔ \frac{d \sqrt{{u}^{2}}}{d τ} = 0$$

the second condition of equ. (83) with

$$c = \sqrt{\frac{{u}^{2}}{{H}^{2} - 1} - 1}$$

and in case of

$$y \neq 0 ⇔ \frac{d \sqrt{{u}^{2}}}{d τ} \neq 0$$

the third condition of equ. (83) with

$$c = \frac{1}{{H}^{2} - 1} .$$

That the first condition of equ. (83) is correct follows from the fact that τ=0 implies that r(τ) is lying in a two-dimensional plane of three-dimensional Euclidian space, which implies that

$$r = ( \begin{matrix}{r}^{0} ( τ ) \\ r ( τ )\end{matrix} )$$

is lying in a three-dimensional subspace of four-dimensional Minkowski space.

Industrial applicability is discussed in annex 33—“Industrial applicability”.

Annex 1—Symmetry of transport property Dη

Derivation of equation (7) yields that ηDη is skew symmetric:

$$\begin{matrix}{( L η )}^{T} η ( L η ) = η \\ ⇔ {η ( L η )}^{T} η ( L η ) = 1 \\ ⟹ η \frac{{d ( L η )}^{T}}{d τ} η ( L η ) + {η ( L η )}^{T} η \frac{d ( L η )}{d τ} = 0 \\ ⇔ {( L η )}^{T} η \frac{d ( L η )}{d τ} = - ( \frac{{d ( L η )}^{T}}{d τ} η ( L η ) ) \\ ⇔ {( L η )}^{T} η \frac{d ( L η )}{d τ} = - {( {( L η )}^{T} η \frac{d ( L η )}{d τ} )}^{T} \\ ⇔ {ηη ( L η )}^{T} η \frac{d ( L η )}{d τ} = - {( {ηη ( L η )}^{T} η \frac{d ( L η )}{d τ} )}^{T} \\ ⇔ {η ( L η )}^{- 1} \frac{d ( L η )}{d τ} = - {( {η ( L η )}^{- 1} \frac{d ( L η )}{d τ} )}^{T} \\ \begin{matrix}equ . ( 11 ) & \\ {⇔}^{↓} & η ( D η ) = - {( η ( D η ) )}^{T} ( skew symmetric )\end{matrix}\end{matrix} \qquad ( 85 )$$

Annex 2—Lη and LηRη are different local frames of the same worldline

If Lη is a local frame of a timelike worldline r(τ), then LηRη with Rη being a spatial rotation as defined in equ. (16) is also a local frame of the same worldline as can be shown from conditions (7), (8) and (9) above:

$$\begin{matrix}{( L η R η )}^{T} η ( L η R η ) = {( R η )}^{T} {( L η )}^{T} η ( L η ) ( R η ) = \\ \begin{matrix}equ . ( 7 ) & & equ . ( 16 ) & & equ . ( 16 ) & \\ {=}^{↓} & {( R η )}^{T} η ( R η ) & {=}^{↓} & {( R η )}^{T} ( R η ) η & {=}^{↓} & η\end{matrix}\end{matrix}$$

$$\begin{matrix} & equ . ( 8 ) , ( 16 ) & \\ det ( L η R η ) = det ( L η ) \cdot det ( R η ) & {=}^{↓} & 1\end{matrix}$$

The converse is also true: if Lη and L′η are local frames for the same worldline, then (Lη)₋₁ (L′η) is a purely spatial rotation, i.e. the transposed matrix is the inverse matrix

$$\begin{matrix}{( L η )}^{- 1} {( {L}^{′} η ) [ {( L η )}^{- 1} ( {L}^{′} η ) ]}^{T} == \\ {( L η )}^{- 1} ( {L}^{′} η ) {{( {L}^{′} η )}^{T} [ {( L η )}^{- 1} ]}^{T} == \\ {( L η )}^{- 1} ( {L}^{′} η ) {ηη ( {L}^{′} η )}^{T} {ηη [ {( L η )}^{- 1} ]}^{T} = … \\ \begin{matrix} & equ . ( 7 ) , ( 9 ) \\ {( L η )}^{- 1} ( {L}^{′} η ) & {=}^{↓}\end{matrix} ( \begin{matrix}1 & {0}^{T} \\ 0 & *\end{matrix} ) \\ … = {η ( L η )}^{- 1} ( {L}^{′} η ) {η ( {L}^{′} η )}^{T} {ηη [ {( L η )}^{- 1} ]}^{T} = \\ \begin{matrix}equ . ( 7 ) & \\ {=}^{↓} & {η ( L η )}^{- 1} ( {L}^{′} η ) {( {L}^{′} η )}^{- 1} {η [ {( L η )}^{- 1} ]}^{T} =\end{matrix}\end{matrix}$$

$$\begin{matrix} & equ . ( 7 ) & \\ = {η ( L η )}^{- 1} {η [ {( L η )}^{- 1} ]}^{T} & {=}^{↓} & {η ( L η )}^{- 1} {η [ {η ( L η )}^{T} η ]}^{T} =\end{matrix}$$

$$\begin{matrix}= {η ( L η )}^{- 1} ηη ( L η ) η = {η ( L η )}^{- 1} ( L η ) η = ηη = 1 \\ and\end{matrix}$$

$$\begin{matrix} & equ . ( 8 ) & \\ det [ {( L η )}^{- 1} ( {L}^{′} η ) ] = {det ( L η )}^{- 1} det ( {L}^{′} η ) = \frac{det ( {L}^{′} η )}{det ( L η )} & {=}^{↓} & 1\end{matrix}$$

Annex 3—Lη and RηLη are local frames of different worldlines

In the following we show that RηLη is a local frame, ie. fulfills equations (7) and (8):

$${( R η L η )}^{T} η ( R η L η ) = {( L η )}^{T} {( R η )}^{T} η ( R η ) ( L η ) =$$

$$\begin{matrix}equ . ( 16 ) & equ . ( 16 ) & equ . ( 7 ) \\ {=}^{↓} {( L η )}^{T} {( R η )}^{T} ( R η ) η ( L η ) & {=}^{↓} {( L η )}^{T} η ( L η ) & {=}^{↓} η\end{matrix}$$

$$\begin{matrix} & equ . ( 8 ) , ( 16 ) \\ det ( R η L η ) = det ( R η ) \cdot det ( L η ) & {=}^{↓} 1\end{matrix}$$

### If

$$u ( τ ) = ( \begin{matrix}{u}^{0} ( τ ) \\ u ( τ )\end{matrix} )$$

is the first column of Lη, then

$$( \begin{matrix}{u}^{0} ( τ ) \\ R ( τ ) u ( τ )\end{matrix} )$$

is the first column of RηLη. Because of

$$\begin{matrix} & equ . ( 3 ) \\ ( \begin{matrix}{u}^{0} \\ Ru\end{matrix} ) \cdot ( \begin{matrix}{u}^{0} \\ Ru\end{matrix} ) = - {( {u}^{0} )}^{2} + {[ Ru ]}^{T} Ru = - {( {u}^{0} )}^{2} + {u}^{T} {R}^{T} Ru = {u}^{2} & {=}^{↓} - 1\end{matrix}$$

RηLη is a local frame of the following, likewise timelike [2, p. 30, first paragraph] worldline:

$$( \begin{matrix}{r}^{0} ( τ ) \\ \int R ( τ ) u ( τ ) d τ\end{matrix} )$$

If Rη does not depend on proper time, i.e. if

$$\frac{d ( R η )}{d τ} = 0 ,$$

then Lη and RηLη have the same transport property as defined in equ. (11):

$${( R η L η )}^{- 1} \frac{d}{d τ} ( R η L η ) = {( L η )}^{- 1} {( R η )}^{- 1} R η \frac{d}{d τ} ( L η ) = {( L η )}^{- 1} \frac{d}{d τ} ( L η )$$

Annex 4—Euclidian 3D-Frenet-Serret frame

The Frenet formulas for a curve r(τ) with

$$\frac{d r}{d τ} = u ( τ ) , \frac{{d}^{2} r}{d {τ}^{2}} = a ( τ )$$

in three-dimensional Euclidian space, which curve is not parametrised in arc length, can be found for example in textbook [15, theorem 7.13 on p. 203 and theorem 7.15 on p. 204]:

$$\frac{d}{d τ} ( \begin{matrix}\frac{{u}^{T}}{\sqrt{{u}^{2}}} \\ - \frac{{[ u \times ( u \times a ) ]}^{T}}{\sqrt{{[ u \times ( u \times a ) ]}^{2}}} \\ \frac{{( u \times a )}^{T}}{\sqrt{{( u \times a )}^{2}}}\end{matrix} ) = \sqrt{{u}^{2}} ( \begin{matrix}0 & κ & 0 \\ - κ & 0 & τ \\ 0 & - τ & 0\end{matrix} ) ( \begin{matrix}\frac{{u}^{T}}{\sqrt{{u}^{2}}} \\ - \frac{{[ u \times ( u \times a ) ]}^{T}}{\sqrt{{[ u \times ( u \times a ) ]}^{2}}} \\ \frac{{( u \times a )}^{T}}{\sqrt{{( u \times a )}^{2}}}\end{matrix} ) ⇔ \frac{d}{d τ} ( \frac{u}{\sqrt{{u}^{2}}} - \frac{u \times ( u \times a )}{\sqrt{{[ u \times ( u \times a ) ]}^{2}}} \frac{u \times a}{\sqrt{{( u \times a )}^{2}}} ) = ( \frac{u}{\sqrt{{u}^{2}}} - \frac{u \times ( u \times a )}{\sqrt{{[ u \times ( u \times a ) ]}^{2}}} \frac{u \times a}{\sqrt{{( u \times a )}^{2}}} ) \sqrt{{u}^{2}} {\underbrace{( \begin{matrix}0 & κ & 0 \\ - κ & 0 & τ \\ 0 & - τ & 0\end{matrix} )}}_{{\begin{matrix}{=}^{{↓}^{equ . ( 14 )}} & [\end{matrix} ( \begin{matrix}τ \\ 0 \\ κ\end{matrix} ) ]}_{x}} \qquad ( 86 )$$

$$with$$

$$κ = \frac{\sqrt{{( u \times a )}^{2}}}{{\sqrt{{u}^{2}}}^{3}} ∧ τ = \frac{( u \times a ) \cdot \frac{d a}{d τ}}{{( u \times a )}^{2}} = \frac{\vert ua \frac{d a}{d τ} \vert}{{( u \times a )}^{2}} \qquad ( 87 )$$

As in equ. (12) we again added a transposed sign in equ. (86) in order to formulate it as a conventional matrix equation.

As proven in the following there is an alternative formulation of the Frenet-Serret frame in 3D:

$$( \begin{matrix}\frac{{u}^{T}}{\sqrt{{u}^{2}}} \\ - \frac{{[ u \times ( u \times a ) ]}^{T}}{\sqrt{{[ u \times ( u \times a ) ]}^{2}}} \\ \frac{{( u \times a )}^{T}}{\sqrt{{( u \times a )}^{2}}}\end{matrix} ) = ( \begin{matrix}{\hat{u}}^{T} \\ \\ {( \hat{u} \times )}^{T}\end{matrix} ) \qquad ( 88 )$$

$$κ = \frac{\sqrt{{( u \times a )}^{2}}}{{\sqrt{{u}^{2}}}^{3}} = \frac{\sqrt{{( \frac{d \hat{u}}{d τ} )}^{2}}}{\sqrt{{u}^{2}}}$$

$$τ = \frac{( u \times a ) \cdot \frac{d a}{d τ}}{{( u \times a )}^{2}} = \frac{\vert \begin{matrix}u & a & \frac{d a}{d τ}\end{matrix} \vert}{{( u \times a )}^{2}} = \frac{\frac{{d}^{2} \hat{u}}{d {τ}^{2}} \cdot ( \hat{u} \times )}{\sqrt{{u}^{2}} \sqrt{{( \frac{d \hat{u}}{d τ} )}^{2}}}$$

An alternative formulation of the 3D-Frenet-Serret formulas is thus

$$\frac{d}{d τ} ( \begin{matrix}{\hat{u}}^{T} \\ {T}^{} \\ {( \hat{u} \times )}^{T}\end{matrix} ) = \sqrt{{u}^{2}} ( \begin{matrix}0 & κ & 0 \\ - κ & 0 & τ \\ 0 & - τ & 0\end{matrix} ) ( \begin{matrix}{\hat{u}}^{T} \\ {T}^{} \\ {( \hat{u} \times )}^{T}\end{matrix} ) ⇔ \frac{d}{d τ} ( \begin{matrix}{\hat{u}}^{T} \\ {T}^{} \\ {( \hat{u} \times )}^{T}\end{matrix} ) = ( \begin{matrix}0 & \sqrt{{( \frac{d \hat{u}}{d τ} )}^{2}} & 0 \\ - \sqrt{{( \frac{d \hat{u}}{d τ} )}^{2}} & 0 & \frac{\frac{{d}^{2} \hat{u}}{d {τ}^{2}} \cdot ( \hat{u} \times )}{\sqrt{{( \frac{d \hat{u}}{d τ} )}^{2}}} \\ 0 & - \frac{\frac{{d}^{2} \hat{u}}{d {τ}^{2}} \cdot ( \hat{u} \times )}{\sqrt{{( \frac{d \hat{u}}{d τ} )}^{2}}} & 0\end{matrix} ) ( \begin{matrix}{\hat{u}}^{T} \\ {T}^{} \\ {( \hat{u} \times )}^{T}\end{matrix} ) ⇔ {( \begin{matrix}\hat{u} & & \hat{u} \times \end{matrix} )}^{T} \frac{d}{d τ} ( \begin{matrix}\hat{u} & & \hat{u} \times \end{matrix} ) = ( \begin{matrix}0 & - \sqrt{{( \frac{d \hat{u}}{d τ} )}^{2}} & 0 \\ \sqrt{{( \frac{d \hat{u}}{d τ} )}^{2}} & 0 & - \frac{\frac{{d}^{2} \hat{u}}{d {τ}^{2}} \cdot ( \hat{u} \times )}{\sqrt{{( \frac{d \hat{u}}{d τ} )}^{2}}} \\ 0 & \frac{\frac{{d}^{2} \hat{u}}{d {τ}^{2}} \cdot ( \hat{u} \times )}{\sqrt{{( \frac{d \hat{u}}{d τ} )}^{2}}} & 0\end{matrix} ) \qquad ( 89 )$$

Proof of the above identities:

$$1. \begin{matrix}\frac{u}{\sqrt{{u}^{2}}} = \hat{u}\end{matrix} \\ ⇒ a = \frac{d \sqrt{{u}^{2}}}{d τ} \hat{u} + \sqrt{{u}^{2}} \frac{d \hat{u}}{d τ} = \frac{d \sqrt{{u}^{2}}}{d τ} \hat{u} + \sqrt{{u}^{2}} \sqrt{{( \frac{d \hat{u}}{d τ} )}^{2}} \\ ⇒ \frac{d a}{d τ} = \frac{{d}^{2} \sqrt{{u}^{2}}}{d {τ}^{2}} \hat{u} + \frac{d \sqrt{{u}^{2}}}{d τ} \frac{d \hat{u}}{d τ} + \frac{d \sqrt{{u}^{2}}}{d τ} \frac{d \hat{u}}{d τ} + \sqrt{{u}^{2}} \frac{{d}^{2} \hat{u}}{d {τ}^{2}} \\ ⇒ u \times a = {u}^{2} \sqrt{{( \frac{d \hat{u}}{d τ} )}^{2}} \hat{u} \times \qquad ( 90 )$$

$$⇒ 2. \begin{matrix}\frac{u \times a}{\sqrt{{( u \times a )}^{2}}} = \hat{u} \times \end{matrix}$$

$$3. \begin{matrix}\sqrt{{( \frac{d \hat{u}}{d τ} )}^{2}} = \frac{\sqrt{{( u \times a )}^{2}}}{{u}^{2}} = \sqrt{{u}^{2}} κ\end{matrix}$$

$$4. \begin{matrix}\frac{\sqrt{{u}^{2}} \frac{d a}{d τ} \cdot ( u \times a )}{{( u \times a )}^{2}} = \frac{\frac{{d}^{2} \hat{u}}{d {τ}^{2}} \cdot ( \hat{u} \times \hat{\frac{d \hat{u}}{d τ}} )}{\sqrt{{( \frac{d \hat{u}}{d τ} )}^{2}}} = τ \sqrt{{u}^{2}}\end{matrix} \\ ⇒ u \times ( u \times a ) = {\sqrt{{u}^{2}}}^{3} \sqrt{{( \frac{d \hat{u}}{d τ} )}^{2}} \hat{u} \times ( \hat{u} \times \hat{\frac{d \hat{u}}{d τ}} ) = - {\sqrt{{u}^{2}}}^{3} \sqrt{{( \frac{d \hat{u}}{d τ} )}^{2}} \hat{\frac{d \hat{u}}{d τ}} \qquad ( 91 )$$

$$⇒ 5. \begin{matrix}- \frac{u \times ( u \times a )}{\sqrt{{[ u \times ( u \times a ) ]}^{2}}} =\end{matrix}$$

Annex 5—Calculation of the transport property D′η of local frame L′η=LηRη from the transport property Dη and the rotation Rη

Starting from equ. (11) we get

$$⇒ {D}^{′} η = {( {L}^{′} η )}^{- 1} \frac{d ( {L}^{′} η )}{d τ} {=}^{{↓}^{equ . ( 7 )}} {η ( {L}^{′} η )}^{T} η \frac{d ( {L}^{′} η )}{d τ} {=}^{{↓}^{{L}^{′} η = L η R η}}$$

$$= {η ( L η R η )}^{T} η \frac{d ( L η R η )}{d τ} = {η ( R η )}^{T} {( L η )}^{T} η ( \frac{d ( L η )}{d τ} R η + ( L η ) \frac{d ( R η )}{d τ} ) =$$

$$= {η ( R η )}^{T} {( L η )}^{T} η \frac{d ( L η )}{d τ} ( R η ) + {η ( R η )}^{T} {( L η )}^{T} η ( L η ) \frac{d ( R η )}{d τ} =$$

$$= {( R η )}^{T} {η ( L η )}^{T} η \frac{d ( L η )}{d τ} ( R η ) + {( R η )}^{T} {η ( L η )}^{T} η ( L η ) \frac{d ( R η )}{d τ} =$$

$$= {( R η )}^{T} {( L η )}^{- 1} \frac{d ( L η )}{d τ} ( R η ) + {( R η )}^{T} {( L η )}^{- 1} ( L η ) \frac{d ( R η )}{d τ} =$$

$$= {( R η )}^{T} ( D η ) ( R η ) + {( R η )}^{T} \frac{d ( R η )}{d τ} =$$

$${=}^{{↓}^{equ . ( 16 ) , ( 13 )}} {( \begin{matrix}1 & 0 \\ 0 & R\end{matrix} )}^{T} ( \begin{matrix}0 & {D}_{1}^{T} \\ {D}_{1} & {[ {D}_{2} ]}_{x}\end{matrix} ) ( \begin{matrix}1 & 0 \\ 0 & R\end{matrix} ) + {( \begin{matrix}1 & 0 \\ 0 & R\end{matrix} )}^{T} \frac{d}{d τ} ( \begin{matrix}1 & 0 \\ 0 & R\end{matrix} ) =$$

$$= ( \begin{matrix}1 & 0 \\ 0 & {R}^{T}\end{matrix} ) ( \begin{matrix}0 & {D}_{1}^{T} R \\ {D}_{1} & {[ {D}_{2} ]}_{x} R\end{matrix} ) + ( \begin{matrix}1 & 0 \\ 0 & {R}^{T}\end{matrix} ) ( \begin{matrix}0 & 0 \\ 0 & \frac{dR}{d τ}\end{matrix} ) =$$

$$= ( \begin{matrix}0 & {D}_{1}^{T} R \\ {R}^{T} {D}_{1} & {{R}^{T} [ {D}_{2} ]}_{x} R\end{matrix} ) + ( \begin{matrix}0 & 0 \\ 0 & {R}^{T} \frac{d R}{d τ}\end{matrix} ) =$$

$${=}^{{↓}^{[ 4 , fact 4.12 \text{.1} . xxxix on p \text{.385} ]}} ( \begin{matrix}0 & {D}_{1}^{T} R \\ {R}^{T} {D}_{1} & {[ {R}^{A} {D}_{2} ]}_{x}\end{matrix} ) + ( \begin{matrix}0 & 0 \\ 0 & {R}^{T} \frac{d R}{d τ}\end{matrix} ) =$$

$${=}^{{↓}^{[ 4 , equ . 3.8 \text{.22} on p \text{.301} ]}} ( \begin{matrix}0 & {D}_{1}^{T} R \\ {R}^{T} {D}_{1} & det {( R ) [ {R}^{- 1} {D}_{2} ]}_{x}\end{matrix} ) + ( \begin{matrix}0 & 0 \\ 0 & {R}^{T} \frac{d R}{d τ}\end{matrix} ) =$$

$${=}^{{↓}^{equ . ( 16 )}} ( \begin{matrix}0 & {( {R}^{T} {D}_{1} )}^{T} \\ {R}^{T} {D}_{1} & {[ {R}^{T} {D}_{2} ]}_{x}\end{matrix} ) + ( \begin{matrix}0 & 0 \\ 0 & {R}^{T} \frac{dR}{d τ}\end{matrix} ) =$$

$$= ( \begin{matrix}0 & {( {R}^{T} {D}_{1} )}^{T} \\ {R}^{T} {D}_{1} & {[ {R}^{T} {D}_{2} ]}_{x} + {R}^{T} \frac{d R}{d τ}\end{matrix} )$$

Because of

$${R}^{T} R = 1 ⇒ \frac{d {R}^{T}}{d τ} R + {R}^{T} \frac{d R}{d τ} = 0 ⇔ {( {R}^{T} \frac{d R}{d τ} )}^{T} = - ( {R}^{T} \frac{d R}{d τ} ) {R}^{T} \frac{d R}{d τ}$$

is skew symmetric and can be written in the form

$${[ Ω ]}_{x} := {R}^{T} \frac{d R}{d τ}$$

This equation is replicated as equ. (34) in the description.

Thus we get finally

$${D}^{′} η = ( \begin{matrix}0 & {D}_{1}^{′ T} \\ {D}_{1}^{′} & {[ {D}_{2}^{′} ]}_{2}\end{matrix} ) = ( \begin{matrix}0 & {( {R}^{T} {D}_{1} )}^{T} \\ {R}^{T} {D}_{1} & {[ {R}^{T} {D}_{2} + Ω ]}_{x}\end{matrix} )$$

$$or$$

$${D}_{1}^{′} = {R}^{T} {D}_{1} ∧ {D}_{2}^{′} = {R}^{T} {D}_{2} + Ω$$

This equation is replicated as equ. (33) in the description.

Annex 6—The 4D-Frenet-Serret frame is uniquely determined by equ. (27) for a given timelike worldline in case of ρ₂ 0, but not in case of ρ₂=0

Using equ. (33) and (28) one can see that the 4D-Frenet-Serret frame is for ρ₂≠0 uniquely determined by equation (27): for a rotation

$$R η = ( \begin{matrix}1 & 0 \\ 0 & R\end{matrix} )$$

to leave D̅₁=(ρ₁ 0 0)^{T} of equ. (28) unchanged, D̅₁ must be a proper vector of [symbol] with proper value 1, i.e. (1 0 0)^{T} must constitute the rotation axis of [symbol] because of ρ₂≠0⇒β₁≠0. If ϕ(τ) is the rotation angle, calculation of Ω yields:

$$R := ( \begin{matrix}1 & 0 & 0 \\ 0 & cos ϕ & sin ϕ \\ 0 & - s in ϕ & cos ϕ\end{matrix} )$$

$$⇒ {[ Ω ]}_{x} = {R}^{T} \frac{d R}{d τ} = ( \begin{matrix}1 & 0 & 0 \\ 0 & cos ϕ & - s in ϕ \\ 0 & sin ϕ & cos ϕ\end{matrix} ) ( \begin{matrix}0 & 0 & 0 \\ 0 & - \frac{d ϕ}{d τ} sin ϕ & \frac{d ϕ}{d τ} cos ϕ \\ 0 & - \frac{d ϕ}{d τ} cos ϕ & - \frac{d ϕ}{d τ} sin ϕ\end{matrix} ) = ( \begin{matrix}0 & 0 & 0 \\ 0 & 0 & \frac{d ϕ}{d τ} \\ 0 & - \frac{d ϕ}{d τ} & 0\end{matrix} ) = - {\frac{d ϕ}{d τ} [ ( \begin{matrix}1 \\ 0 \\ 0\end{matrix} ) ]}_{x}$$

$$⇒ Ω = ( \begin{matrix}- \frac{d ϕ}{d τ} \\ 0 \\ 0\end{matrix} ) = ( \begin{matrix}1 & 0 & 0 \\ 0 & cos ϕ & sin ϕ \\ 0 & - s in ϕ & cos ϕ\end{matrix} ) ( \begin{matrix}{ρ}_{3} \\ 0 \\ {ρ}_{2}\end{matrix} ) + ( \begin{matrix}- \frac{d ϕ}{d τ} \\ 0 \\ 0\end{matrix} ) = ( \begin{matrix}{ρ}_{3} - \frac{d ϕ}{d τ} \\ {ρ}_{2} sin ϕ \\ {ρ}_{2} cos ϕ\end{matrix} )$$

Inserting this result in equ. (33) yields

D̅₂′= [symbol] ^{T}D₂+Ω=

Now if the rotation

$$R η = ( \begin{matrix}1 & 0 \\ 0 & R\end{matrix} )$$

should not only leave D̅₁=(ρ₁ 0 0)^{T} of equ. (28) unchanged, but also leave D̅₂=(ρ3 0 ρ2)^{T} of equ. (28) unchanged, then

$${\overline{D}}_{2}^{′} = {\overline{D}}_{2} ⇔ ( \begin{matrix}{ρ}_{3} - \frac{d ϕ}{d τ} \\ {ρ}_{2} sin ϕ \\ {ρ}_{2} cos ϕ\end{matrix} ) = ( \begin{matrix}{ρ}_{3} \\ 0 \\ {ρ}_{2}\end{matrix} )$$

which implies ϕ=n2π with n ∈ [symbol] , Thus the only rotation, which leaves both vectors D̅₁ and D̅₂ and thus D̅η unchanged, is the unity matrix. Thus the 4D-Frenet-Serret frame is uniquely determined by equ. (27) in case of ρ₂≠0.

However the situation is different, if ρ₂=0, which implies because of ρ₂=0 ⇒ρ₃=0 that D̅₂=(0 0 0)^{T}. From equ. (33) one can see that a rotation

$$R η = ( \begin{matrix}1 & 0 \\ 0 & R\end{matrix} ) ,$$

which leaves D̅₂=(0 0 0)^{T} unchanged, must obey the condition Ω=(0 0 0)^{T}, which implies

$$\frac{d R}{d τ} = 0 ,$$

as can be seen from

$${R}^{T} R = 1$$

$$⇒ \frac{d {R}^{T}}{d τ} R + {R}^{T} \frac{d R}{d τ} = 0$$

$$⇔ \frac{d {R}^{T}}{d τ} + \underbrace{{R}^{T} \frac{d R}{d τ}}_{{[ Ω ]}_{x}} {R}^{T} = 0 \frac{d R}{d τ} = 0 {⇔}^{{↓}^{Ω = {( 000 )}^{T}}} \frac{dR}{d τ} = 0$$

Now two cases have to be distinguished: if ρ₁≠0, then for reasons given above any rotation with the rotation axis (1 0 0)^{T} and a constant rotation angle leaves both vectors D̅₁ and D̅₂ and thus D̅η unchanged. If ρ₁=0, then any rotation with an arbitrary, but constant rotation axis and with a constant rotation angle leaves both vectors D̅₁ and D̅₂ and thus D̅η unchanged.

Annex 7—Expression for the fourth column vector N₃ of a local frame

In order to solve the problem of calculating the fourth four-vector N₃ from the first three four-vectors N₀=u, N₁ and N₂ of a local frame or of a restricted Lorentz transformation we start with the following theorem:

Theorem 1:det(N₁N₂N₃)=N₁·(N₂×N₃)=u⁰ (92)

Proof: with L:=(N₁ N₂ N₃) and v:=(N₁⁰ N₂⁰ N₃⁰)^{T} any local frame can be written in the following form

$$L η = ( \begin{matrix}{u}^{0} & {v}^{T} \\ u & L\end{matrix} )$$

From condition (7) above follows

$$\begin{matrix}{( L η )}^{- 1} = {η ( L η )}^{T} η = ( \begin{matrix}{u}^{0} & - {u}^{T} \\ - v & {L}^{T}\end{matrix} ) \\ ⟹ 1 = L {η ( L η )}^{- 1} = ( \begin{matrix}{( {u}^{0} )}^{2} - {v}^{2} & - {( {u}^{0} u - Lv )}^{T} \\ {u}^{0} u - Lv & - {uu}^{T} + {LL}^{T}\end{matrix} ) \\ ⇓\end{matrix} \qquad ( 93 )$$

$$\begin{matrix}1. {( {u}^{0} )}^{2} - {v}^{2} = 1 & ⇔ {v}^{2} = {u}^{2} \\ 2. {u}^{0} u - Lv = ( {u}^{0} \hat{u} - L \hat{v} ) \sqrt{{u}^{2}} = 0 & ⇔ v = {u}^{0} {L}^{- 1} u\end{matrix} \qquad ( 94 )$$

According to textbook [4, equ. (3.9.11) on p. 303 and fact 3.17.2 on p. 334]

$$\begin{matrix}det ( L η ) = det ( \begin{matrix}{u}^{0} & {v}^{T} \\ u & L\end{matrix} ) = det ( L ) ( {u}^{0} - {v}^{T} {L}^{- 1} u ) = \\ \begin{matrix} & equ . ( 94 ) \\ = det ( L ) ( {u}^{0} - \frac{{v}^{T} {u}^{0} {L}^{- 1} u}{{u}^{0}} ) & {=}^{↓}\end{matrix} \\ \begin{matrix} & equ . ( 93 ) & equ . ( 8 ) \\ = det ( L ) ( {u}^{0} - \frac{{v}^{T} v}{{u}^{0}} ) & {=}^{↓} \frac{det ( L )}{{u}^{0}} & {=}^{↓} 1\end{matrix} \\ ⟹ det ( L ) = {u}^{0} \\ qed .\end{matrix}$$

Theorem 2: For all local frames the following equation holds:

N₁×N₂=N₀⁰N₃−N₃⁰N₀ (95)

Proof: from theorem 1 one can derive that N₁, N₂ and N₃ are linearly independent, it is thus sufficient to prove that the Euclidian scalar product of equ. (95) with Nᵢ holds for all i=1, 2, 3:

$$\begin{matrix} & equation ( 95 ) above & \\ 0 = {N}_{1} \cdot ( {N}_{1} \times {N}_{2} ) & {=}^{↓} & {N}_{0}^{0} ( {N}_{1} \cdot {N}_{3} ) - {N}_{3}^{0} ( {N}_{1} \cdot {N}_{0} ) =\end{matrix}$$

$$\begin{matrix}condition ( 7 ) above & \\ {=}^{↓} & {N}_{0}^{0} ( {N}_{1}^{0} \cdot {N}_{3}^{0} ) - {N}_{3}^{0} ( {N}_{1}^{0} \cdot {N}_{0}^{0} ) = 0\end{matrix}$$

$$\begin{matrix} & equation ( 95 ) above & \\ 0 = {N}_{2} \cdot ( {N}_{1} \times {N}_{2} ) & {=}^{↓} & {N}_{0}^{0} ( {N}_{2} \cdot {N}_{3} ) - {N}_{3}^{0} ( {N}_{2} \cdot {N}_{0} ) =\end{matrix}$$

$$\begin{matrix}condition ( 7 ) above & \\ {=}^{↓} & {N}_{0}^{0} ( {N}_{2}^{0} \cdot {N}_{3}^{0} ) - {N}_{3}^{0} ( {N}_{2}^{0} \cdot {N}_{0}^{0} ) = 0\end{matrix}$$

$$\begin{matrix} & theorem 1 above & & equation ( 95 ) above \\ {u}^{0} & {=}^{↓} & {N}_{1} \cdot ( {N}_{2} \times {N}_{3} ) = {N}_{3} \cdot ( {N}_{1} \times {N}_{2} ) & {=}^{↓}\end{matrix}$$

$$\begin{matrix}= ( {N}_{0}^{0} {N}_{3} - {N}_{3}^{0} {N}_{0} ) \cdot {N}_{3} = \\ = {N}_{0}^{0} {N}_{3}^{2} - {N}_{3}^{0} ( {N}_{0} \cdot {N}_{3} ) =\end{matrix}$$

$$\begin{matrix}condition ( 7 ) above & & condition ( 9 ) above & \\ {=}^{↓} & {{N}_{0}^{0} ( 1 + {N}_{3}^{0} )}^{2} - {N}_{3}^{0} ( {N}_{0}^{0} \cdot {N}_{3}^{0} ) = {N}_{0}^{0} & {=}^{↓} & {u}^{0}\end{matrix}$$

$$qed .$$

Rearranging equation (95) yields

$${N}_{3} = \frac{1}{{u}^{0}} [ {N}_{1} \times {N}_{2} + {N}_{3}^{0} u ]$$

### Thus

$$\begin{matrix} & condition ( 7 ) above & \\ 0 & {=}^{↓} & {N}_{3} \cdot u = - {u}^{0} {N}_{3}^{0} + \frac{1}{{u}^{0}} [ {N}_{1} \times {N}_{2} + {N}_{3}^{0} u ] \cdot u ==\end{matrix}$$

$$\begin{matrix}( \frac{{u}^{2}}{{u}^{0}} - {u}^{0} ) {N}_{3}^{0} + \frac{1}{{u}^{0}} ( {N}_{1} \times {N}_{2} ) \cdot u == \\ \frac{1}{{u}^{0}} [ {u}^{2} - {( {u}^{0} )}^{2} ] {N}_{3}^{0} + \frac{1}{{u}^{0}} ( {N}_{1} \times {N}_{2} ) \cdot u == \\ - \frac{1}{{u}^{0}} {N}_{3}^{0} + \frac{1}{{u}^{0}} ( {N}_{1} \times {N}_{2} ) \cdot u \\ ⇔ {N}_{3}^{0} = ( {N}_{1} \times {N}_{2} ) \cdot u \\ ⟹ {N}_{3} = ( \begin{matrix}( {N}_{1} \times {N}_{2} ) \cdot u \\ \frac{1}{{u}^{0}} \{ {N}_{1} \times {N}_{2} + [ ( {N}_{1} \times {N}_{2} ) \cdot u ] u \}\end{matrix} ) == \\ ( \begin{matrix}u \cdot ( {N}_{1} \times {N}_{2} ) \\ \frac{1}{{u}^{0}} ( 1 + {uu}^{T} ) ( {N}_{1} \times {N}_{2} )\end{matrix} ) \\ ⇔ {N}_{3} = ( \begin{matrix}{u}^{T} \\ \frac{1}{{u}^{0}} ( 1 + {uu}^{T} )\end{matrix} ) ( {N}_{1} \times {N}_{2} )\end{matrix}$$

This equation is replicated as equ. (32) in the description.

Annex 8—N₃ of equ. (32) in Einsteinian notation

Equ. (32) can be reformulated in the following manner:

$${N}_{3} = ( \begin{matrix}{u}^{0} & {u}^{T} \\ u & \frac{1}{{u}^{0}} ( 1 + {uu}^{T} )\end{matrix} ) ( \begin{matrix}0 \\ {N}_{1} \times {N}_{2}\end{matrix} )$$

The first matrix can be decomposed as follows:

$$\begin{matrix}( \begin{matrix}{u}^{0} & {u}^{T} \\ u & \frac{1}{{u}^{0}} ( {uu}^{T} + 1 )\end{matrix} ) == \\ - 2 ( \begin{matrix}- {u}^{0} & {0}^{T} \\ - u & 0\end{matrix} ) + ( \begin{matrix}- {u}^{0} & {u}^{T} \\ - u & \frac{1}{{u}^{0}} ( {uu}^{T} + 1 )\end{matrix} ) == \\ - 2 ( \begin{matrix}- {u}^{0} & {0}^{T} \\ - u & 0\end{matrix} ) + \frac{1}{{u}^{0}} ( \begin{matrix}- {( {u}^{0} )}^{2} & {u}^{0} {u}^{T} \\ - {u}^{0} u & {uu}^{T} + 1\end{matrix} ) == \\ - 2 ( \begin{matrix}- {u}^{0} & {0}^{T} \\ - u & 0\end{matrix} ) + \frac{1}{{u}^{0}} [ ( \begin{matrix}0 & {0}^{T} \\ 0 & 1\end{matrix} ) + ( \begin{matrix}- {( {u}^{0} )}^{2} & {u}^{0} {u}^{T} \\ - {u}^{0} u & {uu}^{T}\end{matrix} ) ] == \\ - 2 ( \begin{matrix}- {u}^{0} & {0}^{T} \\ - u & 0\end{matrix} ) + \frac{1}{{u}^{0}} [ ( \begin{matrix}1 & {0}^{T} \\ 0 & 1\end{matrix} ) + ( \begin{matrix}- {( {u}^{0} )}^{2} & {u}^{0} {u}^{T} \\ - {u}^{0} u & {uu}^{T}\end{matrix} ) + ( \begin{matrix}- 1 & {0}^{T} \\ 0 & 0\end{matrix} ) ] == \\ - 2 {u ( η n )}^{T} - \frac{1}{{u}^{T} ( η n )} [ 1 + {u ( η u )}^{T} + {n ( η n )}^{T} ] == \\ - 2 {u}^{μ} {n}_{v} - \frac{1}{{u}^{γ} {n}_{γ}} [ {δ}_{v}^{μ} + {u}^{μ} {u}_{v} + {n}^{μ} {n}_{ν} ]\end{matrix}$$

with n being the four-velocity of an observer at rest given in equ. (17).

The second matrix can be factorised as follows:

$$( \begin{matrix}0 \\ {N}_{1} \times {N}_{2}\end{matrix} ) = ( \begin{matrix}0 & {( {N}_{1} \times {N}_{2} )}^{T} \\ {N}_{1} \times {N}_{2} & {[ {N}_{1}^{0} {N}_{2} - {N}_{2}^{0} {N}_{1} ]}_{x}\end{matrix} ) n$$

The following identity is proven in annex 9 “Proof of a tensor relation”

$$( \begin{matrix}0 & {( {N}_{1} \times {N}_{2} )}^{T} \\ {N}_{1} \times {N}_{2} & {[ {N}_{1}^{0} {N}_{2} - {N}_{2}^{0} {N}_{1} ]}_{x}\end{matrix} ) \begin{matrix}equ . ( 98 ) \\ {=}^{↓}\end{matrix} {N}_{2}^{α} {N}_{1}^{β} {E}_{{αβ}_{v}^{μ}} = {N}_{2 α} {N}_{1 β} {E}_{v}^{αβμ}$$

with E being the Levi-Civita tensor.

Regarding the Levi-Civita tensor we adopt the convention used inter alia by [2, equ. (14.51) on p. 486 and equ. (14.63) on p. 489]

E^{αβγδ}=−ϵ_{αβμv}∧E_{αβμv}=ϵ_{αβμv} (96)

with ϵ being the permutation symbol:

$${ϵ}_{αβγδ} = \{ \begin{matrix}0 & if any two of the indices ( α , β , γ , δ ) are equal \\ 1 & if ( α , β , γ , δ ) is an even permutation of ( 0 , 1 , 2 , 3 ) \\ - 1 & if ( α , β , γ , δ ) is an odd permutation of ( 0 , 1 , 2 , 3 )\end{matrix} \qquad ( 97 )$$

Thus we finally get

$${N}_{3}^{μ} = \{ - 2 {u}^{μ} {n}_{v} - \frac{1}{{u}^{γ} {n}_{γ}} [ {δ}_{v}^{μ} + {u}^{μ} {u}_{v} + {n}^{μ} {n}_{v} ] \} {N}_{2 α} {N}_{1 β} {E}_{σ}^{αβ v} {n}^{σ}$$

Annex 9—Proof of a tensor relation

In the following we prove the following identity:

$${a}_{α} {b}_{β} {E}_{v}^{αβμ} = ( \begin{matrix}0 & {( b \times a )}^{T} \\ b \times a & {[ {b}^{0} a - {a}^{0} b ]}_{x}\end{matrix} )$$

We start with an explicit calculation of the following expression:

$$\begin{matrix} & {ϵ}^{αβμ v} = - {ϵ}^{βαμ v} \\ {a}^{α} {b}^{β} {ϵ}_{αβμ v} & {=}^{↓}\end{matrix} = \\ ( \begin{matrix}0 & {ϵ}_{2301} ( {a}^{2} {b}^{3} - {a}^{3} {b}^{2} ) & {ϵ}_{3102} ( {a}^{3} {b}^{1} - {a}^{1} - {b}^{3} ) & {ϵ}_{1203} ( {a}^{1} {b}^{2} - {a}^{2} {b}^{1} ) \\ … & 0 & {ϵ}_{0312} ( {a}^{0} {b}^{3} - {a}^{3} {b}^{0} ) & {ϵ}_{2013} ( {a}^{2} {b}^{0} - {a}^{0} {b}^{2} ) \\ … & … & 0 & {ϵ}_{0123} ( {a}^{0} {b}^{1} - {a}^{1} {b}^{0} ) \\ … & … & … & 0\end{matrix} ) = …$$

In order to continue the transformation we need the following relations, which are based on equ. (97)
ϵ₀₁₂₃=1 [symbol] ϵ₀₃₂₁=−1 [symbol] ϵ₂₃₀₁=1
ϵ₀₁₂₃=1 [symbol] ϵ₀₃₂₁=−1 [symbol] ϵ₂₃₀₁=1
ϵ₀₁₂₃=1 [symbol] ϵ₀₃₂₁=−1 [symbol] ϵ₂₃₀₁=1
ϵ₀₁₂₃=1 [symbol] ϵ₀₃₂₁=−1 [symbol] ϵ₂₃₀₁=1
ϵ₀₁₂₃=1 [symbol] ϵ₀₃₂₁=−1 [symbol] ϵ₂₃₀₁=1
   now we can continue the transformation:

$$\begin{matrix}… = ( \begin{matrix}0 & {a}^{2} {b}^{3} - {a}^{3} {b}^{2} & {a}^{3} {b}^{1} - {a}^{1} {b}^{3} & {a}^{1} {b}^{2} - {a}^{2} {b}^{1} \\ … & 0 & {a}^{0} {b}^{3} - {a}^{3} {b}^{0} & {a}^{2} {b}^{0} - {a}^{0} {b}^{2} \\ … & … & 0 & {a}^{0} {b}^{1} - {a}^{1} {b}^{0} \\ … & … & … & 0\end{matrix} ) == \\ ( \begin{matrix}0 & {( a \times b )}^{T} \\ - a \times b & {[ {b}^{0} a - {a}^{0} b ]}_{x}\end{matrix} )\end{matrix}$$

From this follows

$$⇒ {M}_{μ ν} = {a}^{α} {b}^{β} {E}_{α β μ ν} {=}^{{equ . ( 96 )}_{↓}} {α}^{α} {b}^{β} {ϵ}_{αβμν} = \\ = ( \begin{matrix}0 & {( a \times b )}^{T} \\ - a \times b & {[ {b}^{0} a - {a}^{0} b ]}_{\times }\end{matrix} )$$

From this follows

$$⇒ {M}_{ν}^{μ} = {a}^{α} {b}^{β} {{E}_{α β}}_{ν}^{μ} = {a}_{α} {b}_{β} {E}_{ν}^{α β μ} = \\ = η ( \begin{matrix}0 & {( a \times b )}^{T} \\ - a \times b & {[ {b}^{0} a - {a}^{0} b ]}_{\times }\end{matrix} ) = ( \begin{matrix}0 & {( a \times b )}^{T} \\ - a \times b & {[ {b}^{0} a - {a}^{0} b ]}_{\times }\end{matrix} ) = \\ = ( \begin{matrix}0 & {( a \times b )}^{T} \\ - b \times a & {[ {b}^{0} a - {a}^{0} b ]}_{\times }\end{matrix} ) \\ qed \qquad ( 98 )$$

Annex 10—Using equ. (32) to calculate the fourth column vector *N̅₃ of the 4D-Frenet-Serret frame *L̅η

Inserting equ. (23) in equ. (32) yields:

$${}^{*} {\overline{N}}_{3} = \frac{1}{{ρ}_{2}} ( \begin{matrix}{u}^{T} \\ \frac{1}{{u}^{0}} ( 1 + {uu}^{T} )\end{matrix} ) ( \frac{a}{\sqrt{a \cdot a}} \times [ \frac{1}{\sqrt{a \cdot a}} \frac{da}{d τ} - u \sqrt{a \cdot a} ] ) =$$

$$= \frac{1}{{ρ}_{2}} ( \begin{matrix}{u}^{T} \\ \frac{1}{{u}^{0}} ( 1 + {uu}^{T} )\end{matrix} ) ( \frac{1}{a \cdot a} a \times \frac{da}{d τ} - a \times u ) =$$

$$= \frac{1}{{ρ}_{2}} \frac{1}{a \cdot a} ( \begin{matrix}{u}^{T} \\ \frac{1}{{u}^{0}} ( 1 + {uu}^{T} )\end{matrix} ) ( a \times \frac{da}{d τ} ) - \frac{1}{{ρ}_{2}} ( \begin{matrix}{u}^{T} \\ \frac{1}{{u}^{0}} ( 1 + {uu}^{T} )\end{matrix} ) ( a \times u ) =$$

$$= \frac{1}{{ρ}_{2}} \frac{1}{a \cdot a} ( \begin{matrix}u \cdot ( a \times \frac{da}{d τ} ) \\ \frac{1}{{u}^{0}} ( a \times \frac{da}{d τ} ) + \frac{1}{{u}^{0}} [ u \cdot ( a \times \frac{da}{d τ} ) ] u\end{matrix} ) - \frac{1}{{ρ}_{2}} ( \begin{matrix}0 \\ \frac{1}{{u}^{0}} ( a \times u )\end{matrix} ) =$$

$$= \frac{1}{{ρ}_{2}} \frac{1}{a \cdot a} ( \begin{matrix}u \cdot ( a \times \frac{da}{d τ} ) \\ \frac{1}{{u}^{0}} ( a \times \frac{da}{d τ} ) + \frac{1}{{u}^{0}} [ u \cdot ( a \times \frac{da}{d τ} ) ] u\end{matrix} ) - \frac{1}{{ρ}_{2}} \frac{1}{a \cdot a} ( \begin{matrix}0 \\ \frac{a \cdot a}{{u}^{0}} ( a \times u )\end{matrix} ) =$$

$$= \frac{1}{{ρ}_{2}} \frac{1}{{u}^{0}} \frac{1}{a \cdot a} ( \begin{matrix}{u}^{0} u \cdot ( a \times \frac{da}{d τ} ) \\ ( a \times \frac{da}{d τ} ) + [ u \cdot ( a \times \frac{da}{d τ} ) ] u - ( a \cdot a ) ( a \times u )\end{matrix} )$$

Annex 11—Frame L̆η is a local frame

[symbol] η defined in equ. (44) is a local frame, i.e. it fulfills conditions (7), (8) and (9) above: one can immediately see that [symbol] ₃ is Minkowski-orthogonal to [symbol] ₀ and [symbol] ₁. An easy way to show in one run that [symbol] ₂ completes the local frame, i.e that L̆η, fulfils conditions (8) and (9) above, is to show that N₂ can be calculated via equation (39):

$${\breve{N}}_{2} = ( \begin{matrix}{u}^{T} \\ \frac{1}{{u}^{0}} ( 1 + {uu}^{T} )\end{matrix} ) ( {\breve{N}}_{3} \times {\breve{N}}_{1} ) = \qquad ( 99 )$$

$$= ( \begin{matrix}{u}^{T} \\ \frac{1}{{u}^{0}} ( 1 + {uu}^{T} )\end{matrix} ) ( \frac{u \times a}{\sqrt{{( u \times a )}^{2}}} \times \frac{a}{\sqrt{a \cdot a}} ) =$$

$$= ( \begin{matrix}{u}^{T} \\ \frac{1}{{u}^{0}} ( 1 + {uu}^{T} )\end{matrix} ) \frac{( u \times a ) \times a}{\sqrt{( a \cdot a ) {( u \times a )}^{2}}} =$$

$$= ( \begin{matrix}{u}^{T} \\ \frac{1}{{u}^{0}} ( 1 + {uu}^{T} )\end{matrix} ) \frac{( u \cdot a ) a - ( a \cdot a ) u}{\sqrt{( a \cdot a ) {( u \times a )}^{2}}} =$$

$$= ( \begin{matrix}{( u \cdot a )}^{2} - {a}^{2} {u}^{2} \\ \frac{1}{{u}^{0}} [ - {a}^{2} u + ( u \cdot a ) a - ( {a}^{2} {u}^{2} ) u + {( u \cdot a )}^{2} u ]\end{matrix} ) \frac{1}{\sqrt{( a \cdot a ) {( u \times a )}^{2}}} =$$

$$= ( \begin{matrix}{( u \cdot a )}^{2} - {a}^{2} {u}^{2} \\ \frac{1}{{u}^{0}} \{ ( u \cdot a ) a - [ {a}^{2} + ( {a}^{2} {u}^{2} ) - {( u \cdot a )}^{2} ] u \}\end{matrix} ) \frac{1}{\sqrt{( a \cdot a ) {( u \times a )}^{2}}} =$$

$$= ( \begin{matrix}{( u \cdot a )}^{2} - {a}^{2} {u}^{2} \\ \frac{1}{{u}^{0}} \{ ( u \cdot a ) a - [ {a}^{2} ( 1 + {u}^{2} ) - {( u \cdot a )}^{2} ] u \}\end{matrix} ) \frac{1}{\sqrt{( a \cdot a ) {( u \times a )}^{2}}} =$$

$$= ( \begin{matrix}{( u \cdot a )}^{2} - {a}^{2} {u}^{2} \\ \frac{1}{{u}^{0}} \{ - ( a \cdot u ) [ {u}^{2} a - ( a \cdot u ) u ] + ( {u}^{2} + 1 ) [ ( a \cdot u ) a - {a}^{2} u ] \}\end{matrix} ) \frac{1}{\sqrt{( a \cdot a ) {( u \times a )}^{2}}} =$$

$$= - ( \begin{matrix}{a}^{2} {u}^{2} - {( u \cdot a )}^{2} \\ {a}^{0} [ {u}^{2} a - ( a \cdot u ) u ] - {u}^{0} [ ( a \cdot u ) a - {a}^{2} u ]\end{matrix} ) \frac{1}{\sqrt{( a \cdot a ) {( u \times a )}^{2}}} =$$

$$= - ( \begin{matrix}{( u \times a )}^{2} \\ ( {u}^{0} a - {a}^{0} u ) \times ( u \times a )\end{matrix} ) \frac{1}{\sqrt{( a \cdot a ) {( u \times a )}^{2}}} =$$

This is the expression for [symbol] ₂ in equ. (44).

Annex 12— [symbol] ₂ and [symbol] ₃ in Einsteinian notation

In order to derive the Einsteinian form of [symbol] ₃ it is helpful to start with c [symbol] ₃ defined in equ. (10):

$${\breve{c}}_{3} {=}^{{equ ( 10 )}_{↓}} {\underbrace{\sqrt{{( u \times a )}^{2}}}}_{\sqrt{{\breve{c}}_{3} \cdot {\breve{c}}_{3}}} {\breve{N}}_{3} = ( \begin{matrix}0 \\ u \times a\end{matrix} ) =$$

$$= ( \begin{matrix}0 & {( u \times a )}^{T} \\ u \times a & {[ {u}^{0} a - {a}^{0} u ]}_{\times }\end{matrix} ) n$$

$$\begin{matrix}{equ . ( 98 )}_{↓} \\ ⇒\end{matrix} \begin{matrix}{\breve{c}}_{3}^{μ} = & {a}^{α} {u}^{β} {E}_{α {β}_{ν}^{μ} {n}^{ν}} = {a}^{α} {u}^{β} {E}_{α {β}_{ν}^{μ} {n}^{ν}}\end{matrix}$$

$${\breve{N}}_{3}^{μ} = \qquad \frac{{\breve{c}}_{3}^{μ}}{\sqrt{{\breve{c}}_{3 γ} {\breve{c}}_{3}^{γ}}}$$

This equation is replicated as equ. (47) in the description.

The Einsteinian form of [symbol] ₂ is similarly derived starting with [symbol] ₂:

$${\breve{c}}_{2} {=}^{{equ ( 10 )}_{↓}} {\underbrace{- \sqrt{( a \cdot a ) {( u \times a )}^{2}}}}_{\sqrt{{\breve{c}}_{2} \cdot {\breve{c}}_{2}}} {\breve{N}}_{2} = ( \begin{matrix}{( u \times a )}^{2} \\ ( {u}^{0} a - {a}^{0} u ) \times ( u \times a )\end{matrix} ) = \\ = ( \begin{matrix}u \times a ) \\ {[ {u}^{0} a - {a}^{0} u ]}_{\times }\end{matrix} ) ( u \times a ) = \\ = ( \begin{matrix}0 & {( u \times a )}^{T} \\ ( u \times a & {[ {u}^{0} a - {a}^{0} u ]}_{\times }\end{matrix} ) ( \begin{matrix}0 \\ u \times a\end{matrix} ) = \\ = ( \begin{matrix}0 & {( u \times a )}^{T} \\ ( u \times a & {[ {u}^{0} a - {a}^{0} u ]}_{\times }\end{matrix} ) {\breve{c}}_{3} \\ \begin{matrix}{equ . ( 98 )}_{↓} \\ ⇒\end{matrix} \begin{matrix}{\breve{c}}_{2}^{μ} = & {a}^{α} {u}^{β} {E}_{α {β}_{ν}^{μ}} {\breve{c}}_{3}^{ν} = {a}^{α} {u}^{β} {E}_{α {β}_{ν}^{μ}} {\breve{c}}_{3}^{ν}\end{matrix} \\ \begin{matrix}{\breve{N}}_{2}^{μ} = & \frac{{\breve{c}}_{2}^{μ}}{\sqrt{{\breve{c}}_{2 γ} {\breve{c}}_{2}^{γ}}}\end{matrix}$$

This equation is replicated as equ. (46) in the description.

Annex 13—Calculation of [symbol] η=( [symbol] η)⁻¹*L̅η

In the following we calculate the components of the following matrix:

$$\breve{R} η = {{( \breve{L} η )}^{- 1}}^{*} \overline{L} η = {η ( \breve{L} η )}^{T} η {(}^{*} \overline{L} η ) = = ( \begin{matrix}1 & 0 & 0 & 0 \\ 0 & 1 & 0 & 0 \\ 0 & 0 & {\breve{N}}_{2} \cdot {\overline{N}}_{2} & {\breve{N}}_{2} \cdot {*}^{} {\overline{N}}_{3} \\ 0 & 0 & {\breve{N}}_{3} \cdot {\overline{N}}_{2} & {\breve{N}}_{3} \cdot {*}^{} {\overline{N}}_{3}\end{matrix} ) \qquad ( 100 )$$

Calculation of the last two components is simple:

$$\begin{matrix}{\breve{N}}_{3} \cdot & {\overline{N}}_{2}\end{matrix} = {\overline{N}}_{2} \cdot \frac{1}{\sqrt{{( u \times a )}^{2}}} ( \begin{matrix}0 \\ u \times a\end{matrix} ) = \frac{1}{\sqrt{{( u \times a )}^{2}}} {\overline{N}}_{2} \cdot ( u \times a ) = \\ {=}^{{equ . ( 23 )}_{↓}} \frac{1}{{ρ}_{2}} \frac{1}{\sqrt{( a \cdot a ) {( u \times a )}^{2}}} ( \frac{da}{d τ} \cdot ( u \times a ) ) = \\ = \frac{1}{{ρ}_{2}} \frac{\vert \begin{matrix}u & a & \frac{da}{d τ}\end{matrix} \vert}{\sqrt{( a \cdot a ) {( u \times a )}^{2}}} {=}^{{equ . ( 19 )}_{↓}} \begin{matrix}\frac{1}{{ρ}_{1} {ρ}_{2}} & \frac{\vert \begin{matrix}u & a & \frac{da}{d τ}\end{matrix} \vert}{\sqrt{{( u \times a )}^{2}}}\end{matrix} \\ \begin{matrix}{\breve{N}}_{3} \cdot & {*}^{} {\overline{N}}_{3}\end{matrix} {=}^{*} {\overline{N}}_{3}^{T} η \frac{1}{{( \sqrt{( u \times a )} )}^{2}} ( \begin{matrix}0 \\ u \times a\end{matrix} ) = \\ {=}^{{equ . ( 32 )}_{↓}} {[ ( \begin{matrix}{u}^{T} \\ \frac{1}{{u}^{0}} ( 1 + {uu}^{T} )\end{matrix} ) ( {\overline{N}}_{1} \times {\overline{N}}_{2} ) ]}^{T} η \frac{1}{\sqrt{{( u \times a )}^{2}}} ( \begin{matrix}0 \\ u \times a\end{matrix} ) = \\ = {( {\overline{N}}_{1} \times {\overline{N}}_{2} )}^{T} ( \begin{matrix}u & \frac{1}{{u}^{0}} ( 1 + {uu}^{T} ) ) η \frac{1}{\sqrt{{( u \times a )}^{2}}} ( \begin{matrix}0 \\ u \times a\end{matrix} ) = \\\end{matrix} \\ = {( {\overline{N}}_{1} \times {\overline{N}}_{2} )}^{T} ( \begin{matrix}u & \frac{1}{{u}^{0}} ( 1 + {uu}^{T} ) ) \frac{1}{\sqrt{{( u \times a )}^{2}}} ( \begin{matrix}0 \\ u \times a\end{matrix} ) = \\\end{matrix} \\ = \frac{1}{{u}^{0}} {( {\overline{N}}_{1} \times {\overline{N}}_{2} )}^{T} \frac{1}{\sqrt{{( u \times a )}^{2}}} ( u \times a ) = \\ = \frac{1}{{u}^{0}} {\breve{N}}_{3} \cdot ( {\overline{N}}_{1} \times {\overline{N}}_{2} ) = \begin{matrix}\frac{1}{{u}^{0}} {\overline{N}}_{1} \cdot & ( {\overline{N}}_{2} \times {\breve{N}}_{3} )\end{matrix}$$

Calculation of the first two non-trivial components is unnecessary, since the relations [symbol] ₂·N̅₂= [symbol] ₃·*N̅₃ and [symbol] ₂·*N̅₃=− [symbol] ₃·N̅₂ must hold, but as a check we calculate the first two non-trivial components too, which is however somewhat lengthy:

$$\begin{matrix}{\breve{N}}_{2} \cdot & {\overline{N}}_{2}\end{matrix} = - {\breve{N}}_{2}^{0} {\overline{N}}_{2}^{0} + {\overline{N}}_{2} \cdot {\breve{N}}_{2} = = - \frac{1}{{u}^{0}} ( {\breve{N}}_{2}^{0} {\overline{N}}_{2}^{0} {u}^{0} - {u}^{0} {\overline{N}}_{2} \cdot {\breve{N}}_{2} ) = = - \frac{1}{{u}^{0}} ( {\breve{N}}_{2}^{0} {\overline{N}}_{2} \cdot u - {u}^{0} {\overline{N}}_{2} \cdot {\breve{N}}_{2} ) = = - \frac{1}{{u}^{0}} {\overline{N}}_{2} \cdot ( {\breve{N}}_{2}^{0} u - {u}^{0} {\breve{N}}_{2} ) = …$$

### To Continue we Need the Relationship

[symbol] ₁× [symbol] ₃= [symbol] ₂⁰u−u⁰ [symbol] ₂

The proof of this relationship is analog to “Theorem 2” (equ. (95)) in Annex 7 “Expression for the fourth column vector N₃ of a local frame”, we repeat here only the part relevant for the correct sign:

[symbol]

₂·( [symbol] ₁× [symbol] ₃)= [symbol] ₁·( [symbol] ₃× [symbol] ₂)=− [symbol] ₁·( [symbol] ₂× [symbol] ₃)=−u⁰

( [symbol] ₂⁰u−u⁰ [symbol] ₂)· [symbol] ₂= [symbol] ₂⁰( [symbol] ₂⁰u⁰)−u⁰[1+( [symbol] ₂⁰)²]=−u⁰

Now we can continue

$$… = - \frac{1}{{u}^{0}} {\overline{N}}_{2} \cdot ( {\breve{N}}_{1} \times {\breve{N}}_{3} ) = - \frac{1}{{u}^{0}} {\breve{N}}_{3} \cdot ( {\overline{N}}_{2} \times {\breve{N}}_{1} ) =$$

$$\begin{matrix}{\breve{N}}_{1} & = & {\overline{N}}_{1} \\ & {=}^{↓} & - \frac{1}{{u}^{0}} {\breve{N}}_{3} \cdot ( {\overline{N}}_{2} \times {\overline{N}}_{1} ) = \frac{1}{{u}^{0}} {\breve{N}}_{3} \cdot ( {\overline{N}}_{1} \times {\overline{N}}_{2} ) =\end{matrix}$$

$$= \frac{1}{{u}^{0}} {\overline{N}}_{2} \cdot ( {\breve{N}}_{3} \times {\overline{N}}_{1} ) = \begin{matrix}\frac{1}{{u}^{0}} {\overline{N}}_{1} \cdot & ( {\overline{N}}_{2} \times {\breve{N}}_{3} )\end{matrix}$$

In order to calculate [symbol] ₂·*N̅₃ it is helpful to bring [symbol] ₂ in a different form:

$$( {u}^{0} a - {a}^{0} u ) \times ( u \times a ) = = {a}^{0} [ {u}^{2} a - ( a \cdot u ) u ] - {u}^{0} [ ( a \cdot u ) a - {a}^{2} u ] = = \frac{1}{{u}^{0}} \{ ( a \cdot u ) [ {u}^{2} a - ( a \cdot u ) u ] - ( {u}^{2} + 1 ) [ ( a \cdot u ) a - {a}^{2} u ] \} = = - \frac{1}{{u}^{0}} \{ ( a \cdot u ) a + [ {( a \cdot u )}^{2} - {a}^{2} ( {u}^{2} + 1 ) ] u \} = = - \frac{1}{{u}^{0}} \{ ( a \cdot u ) a + [ {( a \cdot u )}^{2} - {a}^{2} {u}^{2} - {a}^{2} ] u \} = = - \frac{1}{{u}^{0}} \{ ( a \cdot u ) a + [ - {( a \times u )}^{2} - {a}^{2} ] u \} = = \frac{1}{{u}^{0}} \{ [ {( a \times u )}^{2} + {a}^{2} ] u - ( a \cdot u ) a \}$$

Thus [symbol] ₂ can be written

$${\breve{N}}_{2} = - ( \begin{matrix}{( u \times a )}^{2} \\ ( {u}^{0} a - {a}^{0} u ) \times ( u \times a )\end{matrix} ) \frac{1}{\sqrt{( a \cdot a ) {( u \times a )}^{2}}} = \\ - ( \begin{matrix}{( u \times a )}^{2} \\ \frac{1}{{u}^{0}} \{ [ {( a \times u )}^{2} + {a}^{2} ] u - ( a \cdot u ) a \}\end{matrix} ) \frac{1}{\sqrt{( a \cdot a ) {( u \times a )}^{2}}}$$

From equ. (41) we have

$${*}^{} {\overline{N}}_{3} = \frac{1}{{ρ}_{2}} \frac{1}{{u}^{0}} \frac{1}{a \cdot a} ( \begin{matrix}{u}^{0} u \cdot ( a \times \frac{d a}{d τ} ) \\ ( a \times \frac{d a}{d τ} ) + [ u \cdot ( a \times \frac{d a}{d τ} ) ] u - ( a \cdot a ) ( a \times u )\end{matrix} )$$

Now one can calculate [symbol] ₂·*N̅₃:

$$- {ρ}_{2} {u}^{0} ( a \cdot a ) \sqrt{( a \cdot a ) {( u \times a )}^{2}} {\breve{N}}_{2} \cdot {*}^{} {\overline{N}}_{3} = \\ = ( \begin{matrix}{( u \times a )}^{2} \\ \frac{1}{{u}^{0}} \{ [ {( a \times u )}^{2} + {a}^{2} ] u - ( a \cdot u ) a \}\end{matrix} ) \cdot \\ \cdot ( \begin{matrix}{u}^{0} u \cdot ( a \times \frac{da}{d τ} ) \\ ( a \times \frac{da}{d τ} ) + [ u \cdot ( a \times \frac{da}{d τ} ) ] u - ( a \cdot a ) ( a \times u )\end{matrix} ) = \\ = - {u}^{0} u \cdot ( a \times \frac{da}{d τ} ) {( u \times a )}^{2} ++ ( a \times \frac{da}{d τ} ) \cdot u \frac{1}{{u}^{0}} [ {( a \times u )}^{2} + {a}^{2} ] + \\ + [ u \cdot ( a \times \frac{da}{d τ} ) ] \frac{1}{{u}^{0}} u \cdot \{ [ {( a \times u )}^{2} + {a}^{2} ] u - ( a \cdot u ) a \} = \\ = \frac{1}{{u}^{0}} u \cdot ( a \times \frac{da}{d τ} ) 〈 - {( {u}^{0} )}^{2} {( u \times a )}^{2} + \\ + [ {( a \times u )}^{2} + {a}^{2} ] + u \{ [ {( a \times u )}^{2} + {a}^{2} ] u - ( a \cdot u ) a \} 〉 = \\ = \frac{1}{{u}^{0}} u \cdot ( a \times \frac{da}{d τ} ) 〈 - {( {u}^{0} )}^{2} {( u \times a )}^{2} + \\ + [ {( a \times u )}^{2} + {a}^{2} ] + [ {( a \times u )}^{2} + {a}^{2} ] {u}^{2} - {( a \cdot u )}^{2} 〉 = \\ = \frac{1}{{u}^{0}} u \cdot ( a \times \frac{da}{d τ} ) 〈 - {( {u}^{0} )}^{2} {( u \times a )}^{2} + \\ + [ {( a \times u )}^{2} + {a}^{2} ] ( 1 + {u}^{2} ) - {( a \cdot u )}^{2} 〉 = \\ = \frac{1}{{u}^{0}} u \cdot ( a \times \frac{da}{d τ} ) 〈 - {( {u}^{0} )}^{2} {( u \times a )}^{2} + \\ + [ {( a \times u )}^{2} + {a}^{2} ] {( {u}^{0} )}^{2} - {( {a}^{0} {u}^{0} )}^{2} 〉 = \\ = {u}^{0} u \cdot ( a \times \frac{da}{d τ} ) 〈 {a}^{2} - {( {a}^{0} )}^{2} 〉 = \\ = {a}^{2} {u}^{0} u \cdot ( a \times \frac{da}{d τ} )$$

### Thus

$$\begin{matrix}{\breve{N}}_{2} \cdot & {*}^{} {\overline{N}}_{3}\end{matrix} = - \frac{u \cdot ( a \times \frac{da}{d τ} )}{{ρ}_{2} \sqrt{( a \cdot a ) {( u \times a )}^{2}}} = - \frac{1}{{ρ}_{2}} \frac{\vert \begin{matrix}u & a & \frac{da}{d τ}\end{matrix} \vert}{{ρ}_{2} \sqrt{( a \cdot a ) {( u \times a )}^{2}}} {=}^{{equ . ( 19 )}_{↓}} \begin{matrix}- \frac{1}{{ρ}_{1} {ρ}_{2}} & \frac{\vert \begin{matrix}u & a & \frac{da}{d τ}\end{matrix} \vert}{\sqrt{{( u \times a )}^{2}}}\end{matrix} = - {\breve{N}}_{3} \cdot {\overline{N}}_{2}$$

The final result can be brought into various forms:

$${R}^{⌣} η = ( \begin{matrix}1 & 0 & 0 & 0 \\ 0 & 1 & 0 & 0 \\ 0 & 0 & \frac{1}{{u}^{0}} \vert \begin{matrix}{\overline{N}}_{1} & {\overline{N}}_{2} & {{N}^{⌣}}_{3}\end{matrix} \vert & - \frac{1}{{ρ}_{1} {ρ}_{2}} \frac{\vert \begin{matrix}u & a & \frac{da}{d τ} \vert\end{matrix}}{\sqrt{{( u \times a )}^{2}}} \\ 0 & 0 & \frac{1}{{ρ}_{1} {ρ}_{2}} \frac{\vert \begin{matrix}u & a & \frac{da}{d τ} \vert\end{matrix}}{\sqrt{{( u \times a )}^{2}}} & \frac{1}{{u}^{0}} \vert \begin{matrix}{\overline{N}}_{1} & {\overline{N}}_{2} & {{N}^{⌣}}_{3} \vert\end{matrix}\end{matrix} ) = … \qquad ( 101 )$$

The preceding form corresponds to equ. (48) and the first alternative of equ. (49) in the description.

$$\begin{matrix}… = ( \begin{matrix}1 & 0 & 0 & 0 \\ 0 & 1 & 0 & 0 \\ 0 & 0 & {{N}^{⌣}}_{2} \cdot {\overline{N}}_{2} & {{N}^{⌣}}_{2} \cdot {}^{*} {\overline{N}}_{3} \\ 0 & 0 & {{N}^{⌣}}_{3} \cdot {\overline{N}}_{2} & {{N}^{⌣}}_{3} \cdot {}^{*} {\overline{N}}_{3}\end{matrix} ) == \\ ( \begin{matrix}1 & 0 & 0 & 0 \\ 0 & 1 & 0 & 0 \\ 0 & 0 & 〈 \pm 〉 \sqrt{1 - {( {{N}^{⌣}}_{3} \cdot {\overline{N}}_{2} )}^{2}} & - {{N}^{⌣}}_{3} \cdot {\overline{N}}_{2} \\ 0 & 0 & {{N}^{⌣}}_{3} \cdot {\overline{N}}_{2} & 〈 \pm 〉 \sqrt{1 - {( {{N}^{⌣}}_{3} \cdot {\overline{N}}_{2} )}^{2}}\end{matrix} ) == \\ ( \begin{matrix}1 & {0}^{T} \\ 0 & {R}^{⌣}\end{matrix} ) with {R}^{⌣} = ( \begin{matrix}1 & 0 & 0 \\ 0 & 〈 \pm 〉 \sqrt{1 - {{f}^{2}}^{⌣}} & - {f}^{⌣} \\ 0 & {f}^{⌣} & 〈 \pm 〉 \sqrt{1 - {{f}^{2}}^{⌣}}\end{matrix} ) which defines {f}^{⌣}\end{matrix} \qquad ( 102 )$$

The [symbol] ± [symbol] sign can be specified as follows: due to the basic properties of a rotation we get from equation (100)

$$\begin{matrix}\vert {{N}^{⌣}}_{3} \cdot {}^{*} {\overline{N}}_{3} \vert = \sqrt{1 - {( {{N}^{⌣}}_{3} \cdot {\overline{N}}_{2} )}^{2}} \\ ⇔ \vert \frac{1}{{u}^{0}} \vert \begin{matrix}{\overline{N}}_{1} & {\overline{N}}_{2} & {{N}^{⌣}}_{3} ‖ - \sqrt{1 - {( \frac{1}{{ρ}_{1} {ρ}_{2}} \frac{\vert \begin{matrix}u & a & \frac{da}{d τ} \vert\end{matrix}}{\sqrt{{( u \times a )}^{2}}} )}^{2}}\end{matrix} \\ ⇔ \frac{1}{{u}^{0}} \vert \begin{matrix}{\overline{N}}_{1} & {\overline{N}}_{2} & {{N}^{⌣}}_{3}\end{matrix} \vert == \\ \{ \begin{matrix}0 & if \vert \begin{matrix}{\overline{N}}_{1} & {\overline{N}}_{2} & {{N}^{⌣}}_{3}\end{matrix} \vert = 0 \\ \frac{\vert \begin{matrix}{\overline{N}}_{1} & {\overline{N}}_{2} & {{N}^{⌣}}_{3}\end{matrix} \vert}{‖ \begin{matrix}{\overline{N}}_{1} & {\overline{N}}_{2} & {{N}^{⌣}}_{3}\end{matrix} ‖} \sqrt{1 - {( \frac{1}{{ρ}_{1} {ρ}_{2}} \frac{\vert \begin{matrix}u & a & \frac{da}{d τ}\end{matrix} \vert}{\sqrt{{( u \times a )}^{2}}} )}^{2}} & if \vert \begin{matrix}{\overline{N}}_{1} & {\overline{N}}_{2} & {{N}^{⌣}}_{3}\end{matrix} \vert \neq 0\end{matrix} \} == \\ 〈 \pm 〉 \sqrt{1 - {( \frac{1}{{ρ}_{1} {ρ}_{2}} \frac{\vert \begin{matrix}u & a & \frac{da}{d τ}\end{matrix} \vert}{\sqrt{{( u \times a )}^{2}}} )}^{2}} \\ with \\ 〈 \pm 〉 := \{ \begin{matrix}0 & if \vert \begin{matrix}{\overline{N}}_{1} & {\overline{N}}_{2} & {{N}^{⌣}}_{3}\end{matrix} \vert = 0 \\ \frac{\vert \begin{matrix}{\overline{N}}_{1} & {\overline{N}}_{2} & {{N}^{⌣}}_{3}\end{matrix} \vert}{‖ \begin{matrix}{\overline{N}}_{1} & {\overline{N}}_{2} & {{N}^{⌣}}_{3}\end{matrix} ‖} & if \vert \begin{matrix}{\overline{N}}_{1} & {\overline{N}}_{2} & {{N}^{⌣}}_{3}\end{matrix} \vert \neq 0\end{matrix}\end{matrix} \qquad ( 103 )$$

This equation is replicated as equ. (51) in the description.

From equ. (100), (102) one can see that the following identity holds:

$${f}^{⌣} = {{N}^{⌣}}_{3} \cdot {\overline{N}}_{2} = - {{N}^{⌣}}_{2} \cdot {}^{*} {\overline{N}}_{3} = \frac{1}{{ρ}_{1} {ρ}_{2}} \frac{\vert \begin{matrix}u & a & \frac{da}{d τ}\end{matrix} \vert}{\sqrt{{( u \times a )}^{2}}} == \{ \begin{matrix}0 & if \vert \begin{matrix}u & a & \frac{da}{d τ}\end{matrix} \vert = 0 \\ \frac{\vert \begin{matrix}u & a & \frac{da}{d τ}\end{matrix} \vert}{‖ \begin{matrix}u & a & \frac{da}{d τ}\end{matrix} ‖} \sqrt{1 - {( \frac{1}{{u}^{0}} \vert \begin{matrix}{\overline{N}}_{1} & {\overline{N}}_{2} & {{N}^{⌣}}_{3}\end{matrix} \vert )}^{2}} & if \vert \begin{matrix}u & a & \frac{da}{d τ}\end{matrix} \vert \neq 0\end{matrix} \qquad ( 104 )$$

For later reference we calculate also

$${[ {Ω}^{⌣} ]}_{x} := {{R}^{T}}^{⌣} \frac{d {R}^{⌣}}{d τ}$$

(see equ. (34)):

$$\begin{matrix}\vert {f}^{⌣} \vert = 1 \frac{{{dR}^{T}}^{⌣}}{d τ} {R}^{⌣} = {[ ( \begin{matrix}0 \\ 0 \\ 0\end{matrix} ) ]}_{x} \\ \vert {f}^{⌣} \vert \neq 1 \frac{{{dR}^{T}}^{⌣}}{d τ} {R}^{⌣} == \\ {( \begin{matrix}0 & 0 & 0 \\ 0 & 〈 \pm 〉 \frac{- {f}^{⌣} {{f}^{′}}^{⌣}}{\sqrt{1 - {{f}^{2}}^{⌣}}} & - {{f}^{′}}^{⌣} \\ 0 & {{f}^{′}}^{⌣} & 〈 \pm 〉 \frac{- {f}^{⌣} {{f}^{′}}^{⌣}}{\sqrt{1 - {{f}^{2}}^{⌣}}}\end{matrix} )}^{T} ( \begin{matrix}1 & 0 & 0 \\ 0 & 〈 \pm 〉 \sqrt{1 - {{f}^{2}}^{⌣}} & - {f}^{⌣} \\ 0 & {f}^{⌣} & 〈 \pm 〉 \sqrt{1 - {{f}^{2}}^{⌣}}\end{matrix} ) == \\ {{f}^{′}}^{⌣} ( \begin{matrix}0 & 0 & 0 \\ 0 & 〈 \pm 〉 \frac{- {f}^{⌣}}{\sqrt{1 - {{f}^{2}}^{⌣}}} & 1 \\ 0 & - 1 & 〈 \pm 〉 \frac{- {f}^{⌣}}{\sqrt{1 - {{f}^{2}}^{⌣}}}\end{matrix} ) ( \begin{matrix}1 & 0 & 0 \\ 0 & 〈 \pm 〉 \sqrt{1 - {{f}^{2}}^{⌣}} & - {f}^{⌣} \\ 0 & {f}^{⌣} & 〈 \pm 〉 \sqrt{1 - {{f}^{2}}^{⌣}}\end{matrix} ) == \\ {{f}^{′}}^{⌣} ( \begin{matrix}0 & 0 & 0 \\ 0 & 0 & 〈 \pm 〉 \frac{{{f}^{2}}^{⌣}}{\sqrt{1 - {{f}^{2}}^{⌣}}} 〈 \pm 〉 \sqrt{1 - {{f}^{2}}^{⌣}} \\ 0 & - 〈 \pm 〉 \sqrt{1 - {{f}^{2}}^{⌣}} - 〈 \pm 〉 \frac{{{f}^{2}}^{⌣}}{\sqrt{1 - {{f}^{2}}^{⌣}}} & 0\end{matrix} ) == \\ 〈 \pm 〉 {{f}^{′}}^{⌣} ( \begin{matrix}0 & 0 & 0 \\ 0 & 0 & \frac{1}{\sqrt{1 - {{f}^{2}}^{⌣}}} \\ 0 & - \frac{1}{\sqrt{1 - {{f}^{2}}^{⌣}}} & 0\end{matrix} ) = 〈 \pm 〉 \frac{{{f}^{′}}^{⌣}}{\sqrt{1 - {{f}^{2}}^{⌣}}} ( \begin{matrix}0 & 0 & 0 \\ 0 & 0 & 1 \\ 0 & - 1 & 0\end{matrix} ) =\end{matrix} \qquad ( 105 )$$

$$\begin{matrix}= {\frac{{{f}^{′}}^{⌣}}{〈 \pm 〉 \sqrt{1 - {{f}^{2}}^{⌣}}} [ ( \begin{matrix}- 1 \\ 0 \\ 0\end{matrix} ) ]}_{x} = {- [ {Ω}^{⌣} ]}_{x} \\ {R}^{T} \frac{dR}{d τ} = {[ Ω ]}_{x} ⇔ \frac{{dR}^{T}}{d τ} R = {- [ Ω ]}_{x}\end{matrix} \qquad ( 106 )$$

Annex 14—atan2

The definition of the four quadrant version atan2 of the arctangent in terms of the conventional two quadrant arctangent arctan can for example be found in textbook [14, equ. (18.19) on p. 443] (the order of the two arguments is different in [14], different authors/programming languages use different conventions regarding the order of the two arguments):

$$atan 2 ( x , y ) = \{ \begin{matrix}arctan ( \frac{x}{y} ) & if y > 0 \\ arctan ( \frac{x}{y} ) + π & if x \geq 0 ∧ y < 0 \\ arctan ( \frac{x}{y} ) - π & if x < 0 ∧ y < 0 \\ π / 2 & if x > 0 ∧ y = 0 \\ - π / 2 & if x < 0 ∧ y = 0 \\ undefined & if x = 0 ∧ y = 0\end{matrix}$$

Annex 15—Calculation of the transport property [symbol] η of [symbol] η

We will calculate the transport property using the simplification proven in annex 16 “Simplification of the calculation of the transport property of an arbitrary local frame”.

In order to calculate the transport property it is helpful to bring [symbol] ₂ in a different form starting from equ. (99):

$$\begin{matrix}{{N}^{⌣}}_{2} = ( \begin{matrix}{u}^{T} \\ \frac{1}{{u}^{0}} ( 1 + {uu}^{T} )\end{matrix} ) ( {{N}^{⌣}}_{3} \times {{N}^{⌣}}_{1} ) == \\ ( \begin{matrix}{u}^{T} \\ \frac{1}{{u}^{0}} ( 1 + {uu}^{T} )\end{matrix} ) ( \frac{u \times a}{\sqrt{{( u \times a )}^{2}}} \times \frac{a}{\sqrt{a \cdot a}} ) == \\ ( \begin{matrix}{u}^{T} \\ \frac{1}{{u}^{0}} ( 1 + {uu}^{T} )\end{matrix} ) \frac{( u \times a ) \times a}{\sqrt{( a \cdot a ) {( u \times a )}^{2}}} == \\ - \frac{1}{{u}^{0}} \sqrt{\frac{{( u \times a )}^{2}}{a \cdot a}} ( \begin{matrix}{u}^{0} \\ \frac{a \times ( u \times a )}{{( u \times a )}^{2}} + u\end{matrix} ) == \\ {\underbrace{- \frac{1}{{u}^{0} \sqrt{\frac{a \cdot a}{{( u \times a )}^{2}}}}}}_{\frac{1}{\sqrt{{{c}^{⌣}}_{2} \cdot {{c}^{⌣}}_{2}}} = \frac{1}{\sqrt{{{c}^{⌣}}_{2}^{2}}}} {\underbrace{( \begin{matrix}{u}^{0} \\ \frac{a \times ( u \times a )}{{( u \times a )}^{2}} + u\end{matrix} )}}_{{{c}^{⌣}}_{2}}\end{matrix}$$

Having thus defined [symbol] ₂ we can now calculate

$$\begin{matrix}\frac{d {{c}^{⌣}}_{2}}{d τ} : \\ \frac{d {{c}^{⌣}}_{2}}{d τ} = \frac{d}{d τ} [ \frac{a \times ( u \times a )}{{( u \times a )}^{2}} + u ] == \\ - \frac{2 ( u \times a ) \cdot ( u \times \frac{da}{d τ} )}{{( u \times a )}^{4}} a \times ( u \times a ) + \frac{\frac{da}{d τ} \times ( u \times a ) + a \times ( u \times \frac{da}{d τ} )}{{( u \times a )}^{2}} + a == \\ - \frac{2 ( u \times a ) \cdot ( u \times \frac{da}{d τ} )}{{( u \times a )}^{4}} a \times ( u \times a ) + \frac{( \frac{da}{d τ} \cdot a ) u - ( \frac{da}{d τ} \cdot u ) a + ( \frac{da}{d τ} \cdot a ) u - ( u \cdot a ) \frac{da}{d τ}}{{( u \times a )}^{2}} + a\end{matrix}$$

Local frame [symbol] η of equation (44) can thus be brought into the following form:

$$\begin{matrix}{L}^{⌣} η = ( \begin{matrix}{u}^{0} & \frac{{a}^{0}}{\sqrt{a \cdot a}} & - \frac{{( u \times a )}^{2}}{\sqrt{( a \cdot a ) {( u \times a )}^{2}}} & 0 \\ u & \frac{a}{\sqrt{a \cdot a}} & - \frac{( {u}^{0} a - {a}^{0} u ) \times ( u \times a )}{\sqrt{( a \cdot a ) {( u \times a )}^{2}}} & \frac{u \times a}{\sqrt{{( u \times a )}^{2}}}\end{matrix} ) == \\ ( \begin{matrix}{u}^{0} & \frac{{a}^{0}}{\sqrt{a \cdot a}} & - \frac{1}{{u}^{0}} \sqrt{\frac{{( u \times a )}^{2}}{a \cdot a}} {u}^{0} & 0 \\ u & \frac{a}{\sqrt{a \cdot a}} & - \frac{1}{{u}^{0}} \sqrt{\frac{{( u \times a )}^{2}}{a \cdot a}} ( \frac{a \times ( u \times a )}{{( u \times a )}^{2}} + u ) & \frac{u \times a}{\sqrt{{( u \times a )}^{2}}}\end{matrix} )\end{matrix}$$

$$\begin{matrix}equ . ( 10 ) \\ {=}^{↓}\end{matrix} ( \begin{matrix}u & \frac{{{c}^{⌣}}_{1}}{\sqrt{{{c}^{⌣}}_{1}^{2}}} & \frac{{{c}^{⌣}}_{2}}{\sqrt{{{c}^{⌣}}_{2}^{2}}} & \frac{{{c}^{⌣}}_{3}}{\sqrt{{{c}^{⌣}}_{3}^{2}}}\end{matrix} )$$

After these preliminaries we can now calculate the components of [symbol] η. Due to the symmetry of [symbol] η (see Annex 1—Symmetry of transport property Dη) it is sufficient to calculate only half of the off-diagonal components. However as a cross check we calculated all components:

$$\begin{matrix}\frac{{{c}^{⌣}}_{3}}{\sqrt{{{c}^{⌣}}_{3}^{2}}} \cdot \frac{\frac{d {{c}^{⌣}}_{2}}{d τ}}{\sqrt{{{c}^{⌣}}_{2}^{2}}} = - \frac{1}{{u}^{0} \sqrt{\frac{a \cdot a}{{( u \times a )}^{2}}}} \frac{1}{\sqrt{{( u \times a )}^{2}}} \cdot \\ \cdot ( \frac{a \times ( u \times \frac{da}{d τ} )}{{( u \times a )}^{2}} ) \cdot ( u \times a ) == \\ - \frac{1}{{u}^{0} \sqrt{\frac{a \cdot a}{{( u \times a )}^{2}}}} \frac{1}{\sqrt{{( u \times a )}^{2}}} \cdot \\ \cdot ( \frac{( \frac{da}{d τ} \cdot a ) u - ( u \cdot a ) \frac{da}{d τ}}{{( u \times a )}^{2}} ) \cdot ( u \times a ) == \\ - \frac{1}{{u}^{0} \sqrt{\frac{a \cdot a}{{( u \times a )}^{2}}}} \frac{1}{\sqrt{{( u \times a )}^{2}}} \cdot ( \frac{- ( u \cdot a ) \frac{da}{d τ}}{{( u \times a )}^{2}} ) \cdot ( u \times a ) == \\ \frac{1}{{u}^{0} \sqrt{a \cdot a}} ( \frac{{u}^{0} {a}^{0} \frac{da}{d τ}}{{( u \times a )}^{2}} ) \cdot ( u \times a ) == \\ \frac{{a}^{0}}{\sqrt{a \cdot a}} \frac{\frac{da}{d τ} \cdot ( u \times a )}{{( u \times a )}^{2}} \\ \frac{{{c}_{1}}^{⌣}}{\sqrt{{{c}^{⌣}}_{1}^{2}}} \cdot \frac{\frac{d {{c}^{⌣}}_{3}}{d τ}}{\sqrt{{{c}^{⌣}}_{3}^{2}}} = \frac{1}{\sqrt{a \cdot a}} \frac{1}{\sqrt{{( u \times a )}^{2}}} a \cdot ( \begin{matrix}0 \\ u \times \frac{da}{d τ}\end{matrix} ) = \frac{a \cdot ( u \times \frac{da}{d τ} )}{\sqrt{( a \cdot a ) {( u \times a )}^{2}}} \\ \frac{{{c}^{⌣}}_{3}}{\sqrt{{{c}^{⌣}}_{3}^{2}}} \cdot \frac{\frac{d {{c}^{⌣}}_{1}}{d τ}}{\sqrt{{{c}^{⌣}}_{1}^{2}}} = \frac{1}{\sqrt{{( u \times a )}^{2}}} ( \begin{matrix}0 \\ u \times a\end{matrix} ) \cdot \frac{\frac{da}{d τ}}{\sqrt{a \cdot a}} = \frac{\frac{da}{d τ} \cdot ( u \times a )}{\sqrt{( a \cdot a ) {( u \times a )}^{2}}} \\ \frac{{{c}^{⌣}}_{2}}{\sqrt{{{c}^{⌣}}_{2}^{2}}} \cdot \frac{\frac{d {{c}^{⌣}}_{1}}{d τ}}{\sqrt{{{c}^{⌣}}_{1}^{2}}} = - \frac{1}{{u}^{0} \sqrt{\frac{a \cdot a}{{( u \times a )}^{2}}}} ( \begin{matrix}{u}^{0} \\ \frac{a \times ( u \times a )}{{( u \times a )}^{2}} + u\end{matrix} ) \cdot \frac{\frac{da}{d τ}}{\sqrt{a \cdot a}} == \\ - \frac{1}{{u}^{0} \sqrt{\frac{{( a \cdot a )}^{2}}{{( u \times a )}^{2}}}} [ ( \begin{matrix}0 \\ \frac{a \times ( u \times a )}{{( u \times a )}^{2}}\end{matrix} ) + u ] \cdot \frac{da}{d τ} == \\ - \frac{1}{{u}^{0} \sqrt{\frac{{( a \cdot a )}^{2}}{{( u \times a )}^{2}}}} [ ( \begin{matrix}0 \\ \frac{a \times ( u \times a )}{{( u \times a )}^{2}}\end{matrix} ) \cdot \frac{da}{d τ} - ( a \cdot a ) ] == \\ - \frac{1}{{u}^{0} \sqrt{\frac{{( a \cdot a )}^{2}}{{( u \times a )}^{2}}}} [ \frac{a \times ( u \times a )}{{( u \times a )}^{2}} \cdot \frac{da}{d τ} - ( a \cdot a ) ] == \\ - \frac{1}{{u}^{0} \sqrt{{( u \times a )}^{2} {( a \cdot a )}^{2}}} [ ( \frac{da}{d τ} \times a ) \cdot ( u \times a ) - {( u \times a )}^{2} ( a \cdot a ) ] == \\ \frac{1}{{u}^{0} \sqrt{{( u \times a )}^{2} {( a \cdot a )}^{2}}} [ ( a \times \frac{da}{d τ} ) \cdot ( u \times a ) + ( a \cdot a ) {( u \times a )}^{2} ] ==\end{matrix} \qquad ( 107 )$$

$$\begin{matrix}\frac{1}{{u}^{0} \sqrt{{( u \times a )}^{2} {( a \cdot a )}^{2}}} \{ [ ( a \times \frac{da}{d τ} ) + ( a \cdot a ) ( u \times a ) ] \cdot ( u \times a ) \} == \\ \frac{1}{{u}^{0} \sqrt{{( u \times a )}^{2} {( a \cdot a )}^{2}}} \{ ( u \times a ) \cdot [ a \times ( \frac{da}{d τ} - {a}^{2} u ) ] \} = …\end{matrix}$$

To continue we need the following relationship:

$$\vert \begin{matrix}{\overline{N}}_{1} & {\overline{N}}_{2} & {{N}^{⌣}}_{3}\end{matrix} \vert = {{N}^{⌣}}_{3} \cdot [ {\overline{N}}_{1} \times {\overline{N}}_{2} ] =$$

$$\begin{matrix}equ . ( 23 ) & \\ {=}^{↓} & \frac{u \times a}{\sqrt{{( u \times a )}^{2}}} \cdot [ \frac{a}{\sqrt{a \cdot a}} \times \frac{1}{{ρ}_{2}} ( \frac{1}{\sqrt{a \cdot a}} \{ \frac{da}{d τ} - \frac{a \cdot \frac{da}{d τ}}{{a}^{2}} a \} - \sqrt{a \cdot a} u ) ] ==\end{matrix}$$

$$\frac{u \times a}{{ρ}_{2} {a}^{2} \sqrt{{( u \times a )}^{2}}} \cdot [ a \times ( \frac{da}{d τ} - {a}^{2} u ) ]$$

Now we can continue

$$\begin{matrix}… = \frac{1}{{u}^{0} \sqrt{{( u \times a )}^{2} {( a \cdot a )}^{2}}} {ρ}_{2} {a}^{2} \sqrt{{( u \times a )}^{2}} \vert \begin{matrix}{\overline{N}}_{1} & {\overline{N}}_{2} & {{N}^{⌣}}_{3}\end{matrix} \vert == \\ \frac{{ρ}_{2}}{{u}^{0}} \vert \begin{matrix}{\overline{N}}_{1} & {\overline{N}}_{2} & {{N}^{⌣}}_{3}\end{matrix} \vert =\end{matrix}$$

$$\begin{matrix}equ . ( 103 ) & \\ {=}^{↓} & 〈 \pm 〉 \sqrt{{ρ}_{2}^{2} - {\{ \frac{1}{\sqrt{( a \cdot a ) {( u \times a )}^{2}}} [ \frac{da}{d τ} \cdot ( u \times a ) ] \}}^{2}}\end{matrix}$$

$$\begin{matrix}\frac{{{c}^{⌣}}_{1}}{\sqrt{{{c}^{⌣}}_{1}^{2}}} \cdot \frac{\frac{d {{c}^{⌣}}_{2}}{d τ}}{\sqrt{{{c}^{⌣}}_{2}^{2}}} = - \frac{1}{\sqrt{a \cdot a}} \frac{1}{{u}^{0} \sqrt{\frac{a \cdot a}{{( u \times a )}^{2}}}} \cdot \\ \cdot ( \begin{matrix}{a}^{0} \\ a\end{matrix} ) \cdot ( \begin{matrix}{a}^{0} \\ - \frac{2 ( u \times a ) \cdot ( u \times \frac{da}{d τ} )}{{( u \times a )}^{4}} a \times ( u \times a ) + \frac{\frac{da}{d τ} \times ( u \times a ) + a \times ( u \times \frac{da}{d τ} )}{{( u \times a )}^{2}} + a\end{matrix} ) == \\ - \frac{1}{{u}^{0} \sqrt{\frac{{( a \cdot a )}^{2}}{{( u \times a )}^{2}}}} \cdot \{ - {( {a}^{0} )}^{2} + {a}^{2} + \frac{a \cdot [ \frac{da}{d τ} \times ( u \times a ) ]}{{( u \times a )}^{2}} \} == \\ - \frac{1}{{u}^{0} \sqrt{{( a \cdot a )}^{2} {( u \times a )}^{2}}} \cdot [ {( u \times a )}^{2} ( a \cdot a ) + a \cdot ( \frac{da}{d τ} \times ( u \times a ) ) ] == \\ - \frac{1}{{u}^{0} \sqrt{{( a \cdot a )}^{2} {( u \times a )}^{2}}} \cdot [ ( u \times a ) \cdot ( a \times \frac{da}{d τ} ) + {( u \times a )}^{2} ( a \cdot a ) ] == \\ - equ . ( 107 ) \\ \frac{{{c}^{⌣}}_{2}}{\sqrt{{{c}^{⌣}}_{2}^{2}}} \cdot \frac{\frac{d {{c}^{⌣}}_{3}}{d τ}}{\sqrt{{{c}^{⌣}}_{3}^{2}}} = - \frac{1}{{u}^{0} \sqrt{\frac{a \cdot a}{{( u \times a )}^{2}}}} ( \begin{matrix}{u}^{0} \\ \frac{a \times ( u \times a )}{{( u \times a )}^{2}}\end{matrix} + u ) \cdot \frac{1}{\sqrt{{( u \times a )}^{2}}} ( \begin{matrix}0 \\ u \times \frac{da}{d τ}\end{matrix} ) == \\ - \frac{1}{{u}^{0} \sqrt{a \cdot a}} ( \begin{matrix}{u}^{0} \\ \frac{a \times ( u \times a )}{{( u \times a )}^{2}} + u\end{matrix} ) \cdot ( \begin{matrix}0 \\ u \times \frac{da}{d τ}\end{matrix} ) == \\ - \frac{1}{{u}^{0} \sqrt{a \cdot a}} [ \frac{a \times ( u \times a )}{{( u \times a )}^{2}} + u ] \cdot ( u \times \frac{da}{d τ} ) == \\ - \frac{1}{{{u}^{0} ( u \times a )}^{2} \sqrt{a \cdot a}} ( u \times \frac{da}{d τ} ) \cdot [ a \times ( u \times a ) ] == \\ - \frac{1}{{{u}^{0} ( u \times a )}^{2} \sqrt{a \cdot a}} a \cdot [ ( u \times a ) \times ( u \times \frac{da}{d τ} ) ] == \\ - \frac{1}{{{u}^{0} ( u \times a )}^{2} \sqrt{a \cdot a}} a \cdot [ ( u \cdot ( a \times \frac{da}{d τ} ) ) u ] == \\ - \frac{( a \cdot u ) [ u \cdot ( a \times \frac{da}{d τ} ) ]}{{{u}^{0} ( u \times a )}^{2} \sqrt{a \cdot a}} == \\ - \frac{{a}^{0} {u}^{0} [ u \cdot ( a \times \frac{da}{d τ} ) ]}{{{u}^{0} ( u \times a )}^{2} \sqrt{a \cdot a}} = - \frac{{a}^{0} [ u \cdot ( a \times \frac{da}{d τ} ) ]}{{( u \times a )}^{2} \sqrt{a \cdot a}} == \\ \frac{{a}^{0}}{\sqrt{{( u \times a )}^{2}}} \frac{[ a \cdot ( u \times \frac{da}{d τ} ) ]}{\sqrt{( a \cdot a ) {( u \times a )}^{2}}}\end{matrix}$$

The final result can be brought into various forms:

$${D}^{⌣} η = ( \begin{matrix}0 & {{D}^{⌣}}_{1}^{T} \\ {{D}^{⌣}}_{1} & {[ {{D}^{⌣}}_{2} ]}_{x}\end{matrix} ) = [ {η ( {L}^{⌣} η )}^{T} η ] \frac{d ( {L}^{⌣} η )}{d τ} =$$

$$\begin{matrix}equ . ( 109 ) \\ {=}^{↓}\end{matrix} η ( \begin{matrix}0 & u \cdot \frac{\frac{d {{c}^{⌣}}_{1}}{d τ}}{\sqrt{{{c}^{⌣}}_{1}^{2}}} & u \cdot \frac{\frac{d {{c}^{⌣}}_{2}}{d τ}}{\sqrt{{{c}^{⌣}}_{2}^{2}}} & u \cdot \frac{\frac{d {{c}^{⌣}}_{3}}{d τ}}{\sqrt{{{c}^{⌣}}_{3}^{2}}} \\ \frac{{{c}^{⌣}}_{1}}{\sqrt{{{c}^{⌣}}_{1}^{2}}} \cdot a & 0 & \frac{{{c}^{⌣}}_{1}}{\sqrt{{{c}^{⌣}}_{1}^{2}}} \cdot \frac{\frac{d {{c}^{⌣}}_{2}}{d τ}}{\sqrt{{{c}^{⌣}}_{2}^{2}}} & \frac{{{c}^{⌣}}_{1}}{\sqrt{{{c}^{⌣}}_{1}^{2}}} \cdot \frac{\frac{d {{c}^{⌣}}_{3}}{d τ}}{\sqrt{{{c}^{⌣}}_{3}^{2}}} \\ \frac{{{c}^{⌣}}_{2}}{\sqrt{{{c}^{⌣}}_{2}^{2}}} \cdot a & \frac{{{c}^{⌣}}_{2}}{\sqrt{{{c}^{⌣}}_{2}^{2}}} \cdot \frac{\frac{d {{c}^{⌣}}_{1}}{d τ}}{\sqrt{{{c}^{⌣}}_{1}^{2}}} & 0 & \frac{{{c}^{⌣}}_{2}}{\sqrt{{{c}^{⌣}}_{2}^{2}}} \cdot \frac{\frac{d {{c}^{⌣}}_{3}}{d τ}}{\sqrt{{{c}^{⌣}}_{3}^{2}}} \\ \frac{{{c}^{⌣}}_{3}}{\sqrt{{{c}^{⌣}}_{3}^{2}}} \cdot a & \frac{{{c}^{⌣}}_{3}}{\sqrt{{{c}^{⌣}}_{3}^{2}}} \cdot \frac{\frac{d {{c}^{⌣}}_{1}}{d τ}}{\sqrt{{{c}^{⌣}}_{1}^{2}}} & \frac{{{c}^{⌣}}_{3}}{\sqrt{{{c}^{⌣}}_{3}^{2}}} \cdot \frac{\frac{d {{c}^{⌣}}_{2}}{d τ}}{\sqrt{{{c}^{⌣}}_{2}^{2}}} & 0\end{matrix} ) ==$$

$$η ( \begin{matrix}0 & * & 0 & 0 \\ \sqrt{a \cdot a} & 0 & * & * \\ 0 & \frac{{ρ}_{2}}{{u}^{0}} \vert \begin{matrix}{\overline{N}}_{1} & {\overline{N}}_{2} & {{N}^{⌣}}_{3}\end{matrix} \vert & 0 & * \\ 0 & - \frac{a \cdot ( u \times \frac{da}{d τ} )}{\sqrt{( a \cdot a ) {( u \times a )}^{2}}} & - \frac{{a}^{0} [ a \cdot ( u \times \frac{da}{d τ} ) ]}{{( u \times a )}^{2} \sqrt{a \cdot a}} & 0\end{matrix} ) = …$$

wherein the stars * complete the skew symmetric matrix η [symbol] η

$$\begin{matrix} & equ . ( 19 ) \\ … & {=}^{↓}\end{matrix} η ( \begin{matrix}0 & * & 0 & 0 \\ {ρ}_{1} & 0 & * & * \\ 0 & \frac{{ρ}_{2}}{{u}^{0}} \vert \begin{matrix}{\overline{N}}_{1} & {\overline{N}}_{2} & {{N}^{⌣}}_{3}\end{matrix} \vert & 0 & * \\ 0 & \frac{\vert \begin{matrix}u & a & \frac{da}{d τ}\end{matrix} \vert}{{ρ}_{1} \sqrt{{( u \times a )}^{2}}} & \frac{{a}^{0} \vert \begin{matrix}u & a & \frac{da}{d τ}\end{matrix} \vert}{{{ρ}_{1} ( u \times a )}^{2}} & 0\end{matrix} ) \begin{matrix}equ . ( 103 ) \\ {=}^{↓}\end{matrix}$$

$$\begin{matrix}= η ( \begin{matrix}0 & * & 0 & 0 \\ {ρ}_{1} & 0 & * & * \\ 0 & 〈 \pm 〉 \sqrt{{ρ}_{2}^{2} - {( \frac{\vert \begin{matrix}u & a & \frac{da}{d τ}\end{matrix} \vert}{{ρ}_{1} \sqrt{{( u \times a )}^{2}}} )}^{2}} & 0 & * \\ 0 & \frac{\vert \begin{matrix}u & a & \frac{da}{d τ}\end{matrix} \vert}{{ρ}_{1} \sqrt{{( u \times a )}^{2}}} & \frac{{a}^{0} \vert \begin{matrix}u & a & \frac{da}{d τ}\end{matrix} \vert}{{{ρ}_{1} ( u \times a )}^{2}} & 0\end{matrix} ) == \\ η ( \begin{matrix}0 & * & 0 & 0 \\ {ρ}_{1} & 0 & * & * \\ 0 & 〈 \pm 〉 {ρ}_{2} \sqrt{1 - {( \frac{\vert \begin{matrix}u & a & \frac{da}{d τ}\end{matrix} \vert}{{ρ}_{1} {ρ}_{2} \sqrt{{( u \times a )}^{2}}} )}^{2}} & 0 & * \\ 0 & {ρ}_{2} \frac{\vert \begin{matrix}u & a & \frac{da}{d τ}\end{matrix} \vert}{{ρ}_{1} {ρ}_{2} \sqrt{{( u \times a )}^{2}}} & {ρ}_{2} \frac{{a}^{0} \vert \begin{matrix}u & a & \frac{da}{d τ}\end{matrix} \vert}{{ρ}_{1} {{ρ}_{2} ( u \times a )}^{2}} & 0\end{matrix} ) =\end{matrix}$$

$$\begin{matrix}equ . ( 104 ) \\ {=}^{↓}\end{matrix} ( \begin{matrix}0 & {ρ}_{1} & 0 & 0 \\ {ρ}_{1} & 0 & - 〈 \pm 〉 {ρ}_{2} \sqrt{1 - {{f}^{2}}^{⌣}} & - {ρ}_{2} {f}^{⌣} \\ 0 & 〈 \pm 〉 {ρ}_{2} \sqrt{1 - {{f}^{2}}^{⌣}} & 0 & - {ρ}_{2} {f}^{⌣} \frac{{a}^{0}}{\sqrt{{( u \times a )}^{2}}} \\ 0 & {ρ}_{2} {f}^{⌣} & {ρ}_{2} {f}^{⌣} \frac{{a}^{0}}{\sqrt{{( u \times a )}^{2}}} & 0\end{matrix} ) ==$$

$$\begin{matrix}( \begin{matrix}0 & {ρ}_{1} & 0 & 0 \\ {ρ}_{1} & 0 & - 〈 \pm 〉 \sqrt{{ρ}_{2}^{2} - {x}^{2}} & - x \\ 0 & 〈 \pm 〉 \sqrt{{ρ}_{2}^{2} - {x}^{2}} & 0 & - x \frac{{a}^{0}}{\sqrt{{( u \times a )}^{2}}} \\ 0 & x & x \frac{{a}^{0}}{\sqrt{{( u \times a )}^{2}}} & 0\end{matrix} ) \\ with\end{matrix}$$

$$\begin{matrix} & equ . ( 104 ) \\ x = {ρ}_{2} {f}^{⌣} & {=}^{↓}\end{matrix} \frac{1}{{ρ}_{1}} \frac{\vert \begin{matrix}u & a & \frac{da}{d τ}\end{matrix} \vert}{\sqrt{{( u \times a )}^{2}}}$$

The last equation is replicated as equ. (50) in the description.

For later reference we bring [symbol] ₂ (for definition see equ. (13)) in the following form:

$$⇒ {{D}^{⌣}}_{2} = {ρ}_{2} ( \begin{matrix}\frac{{a}^{0}}{\sqrt{{( u \times a )}^{2}}} {f}^{⌣} \\ - {f}^{⌣} \\ 〈 \pm 〉 \sqrt{1 - {{f}^{2}}^{⌣}}\end{matrix} ) \qquad ( 108 )$$

with [symbol] being defined in equ. (104).

Annex 16—Simplification of the calculation of the transport property of an arbitrary local frame

For any local frame Lη the following relations apply:

$$\begin{matrix} & equ . ( 7 ) & \\ {N}_{μ} \cdot {N}_{v} & {=}^{↓} & 0 ⇔ \frac{{c}_{μ}}{\sqrt{{c}_{μ}^{2}}} \cdot \frac{{c}_{v}}{\sqrt{{c}_{v}^{2}}} = 0 ⇔ {c}_{μ} \cdot {c}_{v} = 0\end{matrix} \qquad ( 109 )$$

$$⇒ \frac{{dN}_{μ}}{d τ} \cdot {N}_{v} = [ {c}_{μ} \frac{d}{d τ} ( \frac{1}{\sqrt{{c}_{μ}^{2}}} ) + \frac{1}{\sqrt{{c}_{μ}^{2}}} \frac{{dc}_{μ}}{d τ} ] \cdot \frac{{c}_{v}}{\sqrt{{c}_{v}^{2}}} = \frac{\frac{{dc}_{μ}}{d τ}}{\sqrt{{c}_{μ}^{2}}} \cdot \frac{{c}_{v}}{\sqrt{{c}_{v}^{2}}}$$

Thus

$$\begin{matrix} & equ . ( 11 ) & & equ . ( 7 ) & \\ D η & {=}^{↓} & {( L η )}^{- 1} \frac{d ( L η )}{d τ} & {=}^{↓} & {η ( L η )}^{T} η \frac{d ( L η )}{d τ} ==\end{matrix} \qquad ( 110 )$$

$$η ( \begin{matrix}0 & {N}_{0} \cdot \frac{{dN}_{1}}{d τ} & {N}_{0} \cdot \frac{{dN}_{2}}{d τ} & {N}_{0} \cdot \frac{{dN}_{3}}{d τ} \\ {N}_{1} \cdot \frac{{dN}_{0}}{d τ} & 0 & {N}_{1} \cdot \frac{{dN}_{2}}{d τ} & {N}_{1} \cdot \frac{{dN}_{3}}{d τ} \\ {N}_{2} \cdot \frac{{dN}_{0}}{d τ} & {N}_{2} \cdot \frac{{dN}_{1}}{d τ} & 0 & {N}_{2} \cdot \frac{{dN}_{3}}{d τ} \\ {N}_{3} \cdot \frac{{dN}_{0}}{d τ} & {N}_{3} \cdot \frac{{dN}_{1}}{d τ} & {N}_{3} \cdot \frac{{dN}_{2}}{d τ} & 0\end{matrix} ) =$$

$$\begin{matrix}equ . ( 109 ) & \\ {=}^{↓} & η\end{matrix} ( \begin{matrix}0 & u \cdot \frac{\frac{{dc}_{1}}{d τ}}{\sqrt{{c}_{1}^{2}}} & u \cdot \frac{\frac{{dc}_{2}}{d τ}}{\sqrt{{c}_{2}^{2}}} & u \cdot \frac{\frac{{dc}_{3}}{d τ}}{\sqrt{{c}_{3}^{2}}} \\ \frac{{c}_{1}}{\sqrt{{c}_{1}^{2}}} \cdot a & 0 & \frac{{c}_{1}}{\sqrt{{c}_{1}^{2}}} \cdot \frac{\frac{{dc}_{2}}{d τ}}{\sqrt{{c}_{2}^{2}}} & \frac{{c}_{1}}{\sqrt{{c}_{1}^{2}}} \cdot \frac{\frac{{dc}_{3}}{d τ}}{\sqrt{{c}_{3}^{2}}} \\ \frac{{c}_{2}}{\sqrt{{c}_{2}^{2}}} \cdot a & \frac{{c}_{2}}{\sqrt{{c}_{2}^{2}}} \cdot \frac{\frac{{dc}_{1}}{d τ}}{\sqrt{{c}_{1}^{2}}} & 0 & \frac{{c}_{2}}{\sqrt{{c}_{2}^{2}}} \cdot \frac{\frac{{dc}_{3}}{d τ}}{\sqrt{{c}_{3}^{2}}} \\ \frac{{c}_{3}}{\sqrt{{c}_{3}^{2}}} \cdot a & \frac{{c}_{3}}{\sqrt{{c}_{3}^{2}}} \cdot \frac{\frac{{dc}_{1}}{d τ}}{\sqrt{{c}_{1}^{2}}} & \frac{{c}_{3}}{\sqrt{{c}_{3}^{2}}} \cdot \frac{\frac{{dc}_{2}}{d τ}}{\sqrt{{c}_{2}^{2}}} & 0\end{matrix} ) ==$$

$$( \begin{matrix}0 & - u \cdot \frac{\frac{{dc}_{1}}{d τ}}{\sqrt{{c}_{1}^{2}}} & - u \cdot \frac{\frac{{dc}_{2}}{d τ}}{\sqrt{{c}_{2}^{2}}} & - u \cdot \frac{\frac{{dc}_{3}}{d τ}}{\sqrt{{c}_{3}^{2}}} \\ \frac{{c}_{1}}{\sqrt{{c}_{1}^{2}}} \cdot a & 0 & \frac{{c}_{1}}{\sqrt{{c}_{1}^{2}}} \cdot \frac{\frac{{dc}_{2}}{d τ}}{\sqrt{{c}_{2}^{2}}} & \frac{{c}_{1}}{\sqrt{{c}_{1}^{2}}} \cdot \frac{\frac{{dc}_{3}}{d τ}}{\sqrt{{c}_{3}^{2}}} \\ \frac{{c}_{2}}{\sqrt{{c}_{2}^{2}}} \cdot a & \frac{{c}_{2}}{\sqrt{{c}_{2}^{2}}} \cdot \frac{\frac{{dc}_{1}}{d τ}}{\sqrt{{c}_{1}^{2}}} & 0 & \frac{{c}_{2}}{\sqrt{{c}_{2}^{2}}} \cdot \frac{\frac{{dc}_{3}}{d τ}}{\sqrt{{c}_{3}^{2}}} \\ \frac{{c}_{3}}{\sqrt{{c}_{3}^{2}}} \cdot a & \frac{{c}_{3}}{\sqrt{{c}_{3}^{2}}} \cdot \frac{\frac{{dc}_{1}}{d τ}}{\sqrt{{c}_{1}^{2}}} & \frac{{c}_{3}}{\sqrt{{c}_{3}^{2}}} \cdot \frac{\frac{{dc}_{2}}{d τ}}{\sqrt{{c}_{2}^{2}}} & 0\end{matrix} )$$

Annex 17—Calculation of the transport property \tilde{D}η of local frame \tilde{L}η generalising frames \dot{L}η and L̊η

Local frame \tilde{L}η is defined by

$$\tilde{L} η := ( \begin{matrix}{u}^{0} & \sqrt{{u}^{2}} & 0 & 0 \\ u & \frac{{u}^{0}}{\sqrt{{u}^{2}}} u & - \frac{u \times ( u \times d )}{\sqrt{{[ u \times ( u \times d ) ]}^{2}}} & \frac{u \times d}{\sqrt{{( u \times d )}^{2}}}\end{matrix} ) = \qquad ( 111 )$$

$$= ( \begin{matrix}{u}^{0} & \sqrt{{u}^{2}} & 0 & 0 \\ \sqrt{{u}^{2}} \hat{u} & {u}^{0} \hat{u} & - \hat{u} \times ( ) & \end{matrix} ) = \qquad ( 112 )$$

$$= ( \begin{matrix}{\tilde{N}}_{0}^{0} & {\tilde{N}}_{1}^{0} & {\tilde{N}}_{2}^{0} & {\tilde{N}}_{3}^{0} \\ {\tilde{N}}_{0} & {\tilde{N}}_{1} & {\tilde{N}}_{2} & {\tilde{N}}_{3}\end{matrix} ) = ( \begin{matrix}{\tilde{N}}_{0} & {\tilde{N}}_{1} & {\tilde{N}}_{2} & {\tilde{N}}_{3}\end{matrix} ) \qquad ( 113 )$$

with d=d(τ) being an arbitrary proper time dependent three-dimensional vector with d [symbol] u.

The determinant can be calculated as follows:

$$\begin{matrix}det ( \tilde{L} η ) = {u}^{0} \vert {u}^{0} \hat{u} - \hat{u} \times ( ) \vert - \sqrt{{u}^{2}} \vert \sqrt{{u}^{2}} \hat{u} - \hat{u} \times ( ) \vert == \\ [ {( {u}^{0} )}^{2} - {u}^{2} ] \vert \hat{u} - \hat{u} \times ( ) \vert == \\ \vert \hat{u} \hat{u} \times ( ) \vert = 1 as required by equ . ( 8 )\end{matrix}$$

That frame \tilde{L}η fulfils condition (7), i.e. that the column vectors of \tilde{L}η are Minkowski-orthonormal, is apparent from equ. (111). That condition (9) is fulfilled, i.e. that the first column vector of \tilde{L}η is u, is likewise apparent. Frame \tilde{L}η is thus a local frame. For analogous reasons also frames L̊η (d to be replaced with a) and \dot{L}η (d to be replaced with b) are local frames.

In order to calculate the transport property \tilde{D}η we use equ. (110) from annex 16 “Simplification of the calculation of the transport property of an arbitrary local frame”:

$$\tilde{D} η = [ {η ( \tilde{L} η )}^{T} η ] \frac{d ( \tilde{L} η )}{d τ} == η ( \begin{matrix}0 & u \cdot \frac{\frac{\tilde{{dc}_{1}}}{d τ}}{\sqrt{{\tilde{c}}_{1}^{2}}} & u \cdot \frac{\frac{d {\tilde{c}}_{2}}{d τ}}{\sqrt{{\tilde{c}}_{2}^{2}}} & u \cdot \frac{\frac{d {\tilde{c}}_{3}}{d τ}}{\sqrt{{\tilde{c}}_{3}^{2}}} \\ \frac{{\tilde{c}}_{1}}{\sqrt{{\tilde{c}}_{1}^{2}}} \cdot a & 0 & \frac{{\tilde{c}}_{1}}{\sqrt{{\tilde{c}}_{1}^{2}}} \cdot \frac{\frac{d {\tilde{c}}_{2}}{d τ}}{\sqrt{{\tilde{c}}_{2}^{2}}} & \frac{{\tilde{c}}_{1}}{\sqrt{{\tilde{c}}_{1}^{2}}} \cdot \frac{\frac{d {\tilde{c}}_{3}}{d τ}}{\sqrt{{\tilde{c}}_{3}^{2}}} \\ \frac{{\tilde{c}}_{2}}{\sqrt{{\tilde{c}}_{2}^{2}}} \cdot a & \frac{{\tilde{c}}_{2}}{\sqrt{{\tilde{c}}_{2}^{2}}} \cdot \frac{\frac{d {\tilde{c}}_{1}}{d τ}}{\sqrt{{\tilde{c}}_{1}^{2}}} & 0 & \frac{{\tilde{c}}_{2}}{\sqrt{{\tilde{c}}_{2}^{2}}} \cdot \frac{\frac{d {\tilde{c}}_{3}}{d τ}}{\sqrt{{\tilde{c}}_{3}^{2}}} \\ \frac{{\tilde{c}}_{3}}{\sqrt{{\tilde{c}}_{3}^{2}}} \cdot a & \frac{{\tilde{c}}_{3}}{\sqrt{{\tilde{c}}_{3}^{2}}} \cdot \frac{\frac{d {\tilde{c}}_{1}}{d τ}}{\sqrt{{\tilde{c}}_{1}^{2}}} & \frac{{\tilde{c}}_{3}}{\sqrt{{\tilde{c}}_{3}^{2}}} \cdot \frac{\frac{d {\tilde{c}}_{2}}{d τ}}{\sqrt{{\tilde{c}}_{2}^{2}}} & 0\end{matrix} )$$

Due to the symmetry of \tilde{D}η (see Annex 1 “Symmetry of transport property Dη”) it is sufficient to calculate only half of the off-diagonal components. However as a cross check we calculated all components:

$$\begin{matrix}\frac{{\tilde{c}}_{2}}{\sqrt{{\tilde{c}}_{2}^{2}}} \cdot \frac{\frac{d {\tilde{c}}_{1}}{d τ}}{\sqrt{{\tilde{c}}_{1}^{2}}} = ( \begin{matrix}0 \\ - \frac{u \times ( u \times d )}{\sqrt{{[ u \times ( u \times d ) ]}^{2}}}\end{matrix} ) \cdot \frac{{u}^{0}}{\sqrt{{u}^{2}}} ( \begin{matrix}\frac{d}{d τ} ( \frac{{u}^{2}}{{u}^{0}} ) \\ a\end{matrix} ) == \\ - \frac{{u}^{0}}{\sqrt{{u}^{2}}} \frac{[ u \times ( u \times d ) ] \cdot a}{\sqrt{{[ u \times ( u \times d ) ]}^{2}}} = - \frac{{u}^{0}}{{u}^{2}} \frac{[ u \times ( u \times d ) ] \cdot a}{\sqrt{{( u \times d )}^{2}}} \\ \frac{{\tilde{c}}_{2}}{\sqrt{{\tilde{c}}_{2}^{2}}} \cdot \frac{\frac{d {\tilde{c}}_{3}}{d τ}}{\sqrt{{\tilde{c}}_{3}^{2}}} = - ( \begin{matrix}0 \\ \frac{u \times ( u \times d )}{\sqrt{{[ u \times ( u \times d ) ]}^{2}}}\end{matrix} ) \cdot ( \begin{matrix}0 \\ \frac{a \times d + u \times \frac{dd}{d τ}}{\sqrt{{( u \times d )}^{2}}}\end{matrix} ) == \\ - \frac{u \times ( u \times d )}{\sqrt{{[ u \times ( u \times d ) ]}^{2}}} \cdot \frac{a \times d + u \times \frac{dd}{d τ}}{\sqrt{{( u \times d )}^{2}}} = … \\ u \times ( u \times d ) = ( u \cdot d ) u - {u}^{2} d \\ [ ( u \cdot d ) u - {u}^{2} d ] \cdot ( a \times d + u \times \frac{dd}{d τ} ) = ( u \cdot d ) u \cdot ( a \times d ) - {u}^{2} d \cdot ( u \times \frac{dd}{d τ} ) == \\ ( u \cdot d ) a \cdot ( d \times u ) - {u}^{2} \frac{dd}{d τ} \cdot ( d \times u ) == \\ [ ( u \cdot d ) a - {u}^{2} \frac{dd}{d τ} ] \cdot ( d \times u ) \\ … = - \frac{[ ( u \cdot d ) a - {u}^{2} \frac{dd}{d τ} ] \cdot ( d \times u )}{\sqrt{{{( u \times d )}^{2} [ u \times ( u \times d ) ]}^{2}}} == \\ - \frac{[ ( u \cdot d ) a - {u}^{2} \frac{dd}{d τ} ] \cdot ( d \times u )}{\sqrt{{( u \times d )}^{2} {{u}^{2} ( u \times d )}^{2}}} == \\ - \frac{[ ( u \cdot d ) a - {u}^{2} \frac{dd}{d τ} ] \cdot ( d \times u )}{{( u \times d )}^{2} \sqrt{{u}^{2}}} \\ \frac{{\tilde{c}}_{3}}{\sqrt{{\tilde{c}}_{3}^{2}}} \cdot \frac{\frac{d {\tilde{c}}_{1}}{d τ}}{\sqrt{{\tilde{c}}_{1}^{2}}} = ( \begin{matrix}0 \\ \frac{u \times d}{\sqrt{{( u \times d )}^{2}}}\end{matrix} ) \cdot \frac{{u}^{0}}{\sqrt{{u}^{2}}} ( \begin{matrix}\frac{d}{d τ} ( \frac{{u}^{2}}{{u}^{0}} ) \\ a\end{matrix} ) = \frac{{u}^{0}}{\sqrt{{u}^{2}}} \frac{a \cdot ( u \times d )}{\sqrt{{( u \times d )}^{2}}} \\ \frac{{\tilde{c}}_{1}}{\sqrt{{\tilde{c}}_{1}^{2}}} \cdot a = \frac{{u}^{0}}{\sqrt{{u}^{2}}} ( \begin{matrix}\frac{{u}^{2}}{{u}^{0}} - {u}^{0} + {u}^{0} \\ u\end{matrix} ) \cdot a = \frac{{u}^{0}}{\sqrt{{u}^{2}}} ( \begin{matrix}\frac{{u}^{2}}{{u}^{0}} - {u}^{0} \\ 0\end{matrix} ) \cdot a == \\ - \frac{{u}^{0}}{\sqrt{{u}^{2}}} ( \frac{{u}^{2}}{{u}^{0}} - {u}^{0} ) {a}^{0} = - \frac{1}{\sqrt{{u}^{2}}} ( {u}^{2} - {( {u}^{0} )}^{2} ) {a}^{0} = \frac{{a}^{0}}{\sqrt{{u}^{2}}}\end{matrix}$$

Inserting the results

$$( \frac{{\tilde{c}}_{2}}{\sqrt{{\tilde{c}}_{2}^{2}}} \cdot a and \frac{{\tilde{c}}_{3}}{\sqrt{{\tilde{c}}_{3}^{2}}} \cdot a$$

can be calculated directly) yields

$$\tilde{D} η = η ( \begin{matrix}0 & * & * & * \\ \frac{{a}^{0}}{\sqrt{{u}^{2}}} & 0 & * & * \\ - \frac{1}{\sqrt{{u}^{2}}} \frac{[ u \times ( u \times d ) ] \cdot a}{\sqrt{{( u \times d )}^{2}}} & - \frac{{u}^{0}}{{u}^{2}} \frac{[ u \times ( u \times d ) ] \cdot a}{\sqrt{{( u \times d )}^{2}}} & 0 & * \\ \frac{a \cdot ( u \times d )}{\sqrt{{( u \times d )}^{2}}} & \frac{{u}^{0}}{\sqrt{{u}^{2}}} \frac{a \cdot ( u \times d )}{\sqrt{{( u \times d )}^{2}}} & \frac{[ ( u \cdot d ) a - {u}^{2} \frac{dd}{d τ} ] \cdot ( d \times u )}{{( u \times d )}^{2} \sqrt{{u}^{2}}} & 0\end{matrix} ) \qquad ( 114 )$$

wherein the stars * complement the skew symmetric matrix (η\tilde{D}η is skew symmetric according to equ. (85), but \tilde{D}η is not). According to equ. (13) this result can also be brought in the following form:

$${\tilde{D}}_{1} = ( \begin{matrix}\frac{{a}^{0}}{\sqrt{{u}^{2}}} \\ - \frac{1}{\sqrt{{u}^{2}}} \frac{[ u \times ( u \times d ) ] \cdot a}{\sqrt{{( u \times d )}^{2}}} \\ \frac{a \cdot ( u \times d )}{\sqrt{{( u \times d )}^{2}}}\end{matrix} ) ∧ {\tilde{D}}_{2} ( \begin{matrix}\frac{[ ( u \cdot d ) a - {u}^{2} \frac{dd}{d τ} ] \cdot ( d \times u )}{{( u \times d )}^{2} \sqrt{{u}^{2}}} \\ - \frac{{u}^{0}}{\sqrt{{u}^{2}}} \frac{a \cdot ( u \times d )}{\sqrt{{( u \times d )}^{2}}} \\ - \frac{{u}^{0}}{{u}^{2}} \frac{[ u \times ( u \times d ) ] \cdot a}{\sqrt{{( u \times d )}^{2}}}\end{matrix} )$$

As a further check it is shown in the following that the condition of equ. (15) (\tilde{D}₁²=a²) is fulfilled for all d and all worldlines:

$$\begin{matrix}a = ( \frac{u}{\sqrt{{u}^{2}}} \cdot a ) \frac{u}{\sqrt{{u}^{2}}} + ( \frac{u \times d}{\sqrt{{( u \times d )}^{2}}} \cdot a ) \frac{u \times d}{\sqrt{{( u \times d )}^{2}}} + \\ - ( \frac{u \times ( u \times d )}{\sqrt{{u}^{2}} \sqrt{{( u \times d )}^{2}}} \cdot a ) \frac{u \times ( u \times d )}{\sqrt{{u}^{2}} \sqrt{{( u \times d )}^{2}}} \\ {a}^{2} = {( \frac{u}{\sqrt{{u}^{2}}} \cdot a )}^{2} + {( \frac{u \times d}{\sqrt{{( u \times d )}^{2}}} \cdot a )}^{2} + {( \frac{u \times ( u \times d )}{\sqrt{{u}^{2}} \sqrt{{( u \times d )}^{2}}} \cdot a )}^{2} \\ ⇔ {a}^{2} - {( \frac{u}{\sqrt{{u}^{2}}} \cdot a )}^{2} = {( \frac{u \times d}{\sqrt{{( u \times d )}^{2}}} \cdot a )}^{2} + {( \frac{u \times ( u \times d )}{\sqrt{{u}^{2}} \sqrt{{( u \times d )}^{2}}} \cdot a )}^{2} \\ {\tilde{D}}_{1}^{2} = {( \frac{{a}^{0}}{\sqrt{{u}^{2}}} )}^{2} + {( \frac{u \times d}{\sqrt{{( u \times d )}^{2}}} \cdot a )}^{2} + {( \frac{u \times ( u \times d )}{\sqrt{{u}^{2}} \sqrt{{( u \times d )}^{2}}} \cdot a )}^{2} == \\ {( \frac{{a}^{0}}{\sqrt{{u}^{2}}} )}^{2} + {a}^{2} - {( \frac{u \cdot a}{\sqrt{{u}^{2}}} )}^{2} = {( \frac{{a}^{0}}{\sqrt{{u}^{2}}} )}^{2} + {a}^{2} - {( \frac{{a}^{0} {u}^{0}}{\sqrt{{u}^{2}}} )}^{2} == \\ {( \frac{{a}^{0}}{\sqrt{{u}^{2}}} )}^{2} + {a}^{2} - {( \frac{{a}^{0}}{\sqrt{{u}^{2}}} )}^{2} ( {u}^{2} + 1 ) == \\ {a}^{2} - {( \frac{{a}^{0}}{\sqrt{{u}^{2}}} )}^{2} {u}^{2} = - {( {a}^{0} )}^{2} + {a}^{2} = a \cdot a\end{matrix} \qquad ( 115 )$$

Annex 18—Einsteinian notation of four-vectors N̊₁, N̊₂, N̊₃ and \dot{N}₁, \dot{N}₂, \dot{N}₃

In order to determine the Einsteinian notation of four-vectors N̊₁, N̊₂, N̊₃ and four-vectors \dot{N}₁, \dot{N}₂, \dot{N}₃, we determine first the Einsteinian notation of the four-vectors Ñ₁, Ñ₂, Ñ₃ of the local frame \tilde{L}η defined in equ. (111) in annex 17 “Calculation of the transport property \tilde{D}η of local frame \tilde{L}η generalising frames \dot{L}η and L̊η”

In order to derive the Einsteinian form of Ñ₃ it is helpful to start with \tilde{c}₃ defined in equ. (10):

$$\begin{matrix} & equ ( 10 ) & \\ {\tilde{c}}_{3} & {=}^{↓} & {\underbrace{\sqrt{\begin{matrix}( u \times & {d )}^{2}\end{matrix}}}}_{\sqrt{{\tilde{c}}_{3} \cdot {\tilde{c}}_{3}}} {\tilde{N}}_{3} = ( \begin{matrix}0 \\ u \times d\end{matrix} ) ==\end{matrix}$$

$$( \begin{matrix}0 & {( u \times d )}^{T} \\ u \times d & {[ {u}^{0} d - {d}^{0} u ]}_{x}\end{matrix} ) n$$

$$\begin{matrix}equ ( 98 ) & \\ {}^{↓} & {\tilde{c}}_{3}^{μ} = {d}^{α} {u}^{β} {E}_{{αβ}_{v}^{μ}} {n}^{v} = {d}_{α} {u}_{β} {E}_{v}^{αβμ} {n}^{v}\end{matrix} \qquad ( 116 )$$

$${\tilde{N}}_{3}^{μ} = \frac{{\tilde{c}}_{3}^{μ}}{\sqrt{{\tilde{c}}_{3 γ} {\tilde{c}}_{3}^{γ}}}$$

In order to derive the Einsteinian form of Ñ₂ it is helpful to start with \tilde{c}₂ defined in equ. (10):

$$\begin{matrix}{\tilde{c}}_{2} = {\underbrace{\sqrt{{[ u \times ( u \times d ) ]}^{2}}}}_{\sqrt{{\tilde{c}}_{2} \cdot {\tilde{c}}_{2}}} {\tilde{N}}_{2} = - ( \begin{matrix}0 \\ u \times ( u \times d )\end{matrix} ) == \\ ( \begin{matrix}0 \\ ( u \times d ) \times u\end{matrix} ) = ( \begin{matrix}0 & {[ ( u \times d ) \times u ]}^{T} \\ ( u \times d ) \times u & {[ - {u}^{0} ( u \times d ) ]}_{x}\end{matrix} ) n == \\ ( \begin{matrix}0 & {( {\tilde{c}}_{3} \times u )}^{T} \\ {\tilde{c}}_{3} \times u & {[ {\tilde{c}}_{3}^{0} u - {u}^{0} {\tilde{c}}_{3} ) ]}_{x}\end{matrix} ) n\end{matrix}$$

$$\begin{matrix}equ ( 98 ) & \\ {}^{↓} & {\tilde{c}}_{2}^{μ} = {d}^{α} {\tilde{c}}_{3}^{β} {E}_{{αβ}_{v}^{μ}} {n}^{v} = {d}_{α} {\tilde{c}}_{3 β} {E}_{v}^{αβμ} {n}^{v} \\ {\tilde{N}}_{2}^{μ} = \frac{{\tilde{c}}_{2}^{μ}}{\sqrt{{\tilde{c}}_{2 γ} {\tilde{c}}_{2}^{γ}}} & \end{matrix} \qquad ( 117 )$$

In order to derive the Einsteinian form of Ñ₁ we start with the following identity:

$$\begin{matrix}( \begin{matrix}0 & {[ ( u \times d ) \times u ]}^{T} \\ ( u \times d ) \times u & {[ - {u}^{0} ( u \times d ) ]}_{x}\end{matrix} ) \cdot ( \begin{matrix}0 \\ ( u \times d ) \times u\end{matrix} ) == \\ ( \begin{matrix}{[ ( u \times d ) \times u ]}^{2} \\ - {u}^{0} ( u \times d ) \times [ ( u \times d ) \times u ]\end{matrix} ) == \\ ( \begin{matrix}{( u \times d )}^{2} {u}^{2} \\ {{u}^{0} ( u \times d )}^{2} u\end{matrix} ) = {( u \times d )}^{2} ( \begin{matrix}{u}^{2} \\ {u}^{0} u\end{matrix} ) == \\ {( u \times d )}^{2} \sqrt{{u}^{2}} ( \begin{matrix}\sqrt{{u}^{2}} \\ \frac{{u}^{0}}{\sqrt{{u}^{2}}} u\end{matrix} ) = {( u \times d )}^{2} \sqrt{{u}^{2}} {\tilde{N}}_{1} == \\ ( {\tilde{c}}_{3} \cdot {\tilde{c}}_{3} ) \sqrt{{( u \cdot n )}^{2} - 1} {\tilde{N}}_{1}\end{matrix}$$

Resolving for Ñ₁ yields

$$\begin{matrix}{\tilde{N}}_{1} = \frac{1}{( {\tilde{c}}_{3} \cdot {\tilde{c}}_{3} ) \sqrt{{( u \cdot n )}^{2} - 1}} ( \begin{matrix}0 & {[ ( u \times d ) \times u ]}^{T} \\ ( u \times d ) \times u & {[ - {u}^{0} ( u \times d ) ]}_{x}\end{matrix} ) \cdot ( \begin{matrix}0 \\ ( u \times d ) \times u\end{matrix} ) == \\ \frac{1}{( {\tilde{c}}_{3} \cdot {\tilde{c}}_{3} ) \sqrt{{( u \cdot n )}^{2} - 1}} ( \begin{matrix}0 & {( {\tilde{c}}_{3} \times u )}^{T} \\ {\tilde{c}}_{3} \times u & {[ {\tilde{c}}_{3}^{0} u - {u}^{0} {\tilde{c}}_{3} ) ]}_{x}\end{matrix} ) \cdot ( \begin{matrix}0 \\ {\tilde{c}}_{3} \times u\end{matrix} ) == \\ \frac{1}{( {\tilde{c}}_{3} \cdot {\tilde{c}}_{3} ) \sqrt{{( u \cdot n )}^{2} - 1}} ( \begin{matrix}0 & {( {\tilde{c}}_{3} \times u )}^{T} \\ {\tilde{c}}_{3} \times u & {[ {\tilde{c}}_{3}^{0} u - {u}^{0} {\tilde{c}}_{3} ) ]}_{x}\end{matrix} ) \cdot {\tilde{c}}_{2}\end{matrix}$$

$$\begin{matrix} & equ ( 98 ) & \\ ⇒ {\tilde{N}}_{1}^{μ} & {=}^{↓} & \frac{1}{( {\tilde{c}}_{3 γ} {\tilde{c}}_{3}^{γ} ) \sqrt{{( {u}_{ϵ} {n}^{ϵ} )}^{2} - 1}} {u}_{α} {\tilde{c}}_{3 β} {E}_{v}^{αβμ} {\tilde{c}}_{2}^{v}\end{matrix}$$

with \tilde{c}₂ and \tilde{c}₃ being given in equ. (117) and (116) above in Einsteinian notation.

Four-vectors N̊₁, N̊₂, N̊₃ can be determined in Einsteinian notation from the Einsteinian notation of Ñ₁, Ñ₂, Ñ₃ by replacing \tilde{ } with ̊ and d with a. The results are equations (58), (59) and (60) in the description.

Four-vectors \dot{N}₁, \dot{N}₂, \dot{N}₃ can be determined in Einsteinian notation from the Einsteinian notation of Ñ₁, Ñ₂, Ñ₃ by replacing \tilde{ } with \dot{ } and d with b. The results are equations (67), (68) and (69) in the description.

Annex 19—Calculation of the transport property D̊η of local frame L̊η

The transport property of frame L̊η can be derived from the transport property \tilde{D}η of the more general frame \tilde{L}η, which transport property is calculated in equ. (114) in annex 17 “Calculation of the transport property \tilde{D}η of local frame \tilde{L}η generalising frames \dot{L}η and L̊η”, by replacing d with a:

$$\mathring{D} η = η ( \begin{matrix}0 & * & * & * \\ \frac{{a}^{0}}{\sqrt{{u}^{2}}} & 0 & * & * \\ \frac{\sqrt{{( u \times a )}^{2}}}{\sqrt{{u}^{2}}} & \frac{{u}^{0}}{{u}^{2}} \sqrt{{( u \times a )}^{2}} & 0 & * \\ 0 & 0 & \frac{\sqrt{{u}^{2}} \frac{da}{d τ} \cdot {( u \times a )}^{2}}{{( u \times c )}^{2}} & 0\end{matrix} ) = \\ {=}^{{↓}^{equ . ( 87 )}} ( \begin{matrix}0 & \frac{{a}^{0}}{\sqrt{{u}^{2}}} & {u}^{2} κ & 0 \\ \frac{{a}^{0}}{\sqrt{{u}^{2}}} & 0 & - {u}^{0} \sqrt{{u}^{2}} & 0 \\ {u}^{2} κ & {u}^{0} \sqrt{{u}^{2} κ} & 0 & - τ \sqrt{{u}^{2}} \\ 0 & 0 & τ \sqrt{{u}^{2}} & 0\end{matrix} )$$

According to equ. (13) this result can also be brought in the following form:

$${{D}^{˚}}_{1} = ( \begin{matrix}\frac{{a}^{0}}{\sqrt{{u}^{2}}} \\ {u}^{2} κ \\ 0\end{matrix} ) ∧ {{D}^{˚}}_{2} = ( \begin{matrix}τ \sqrt{{u}^{2}} \\ 0 \\ {u}^{0} \sqrt{{u}^{2} κ}\end{matrix} ) \qquad ( 118 )$$

In the following we check again that equ. (15) (D̊₁²=a²) is fulfilled (this was already checked with regard to the more general vector \tilde{D}₁ in equ. (115) above)

$${{D}^{˚}}_{1}^{2} = {( \frac{{a}^{0}}{\sqrt{{u}^{2}}} )}^{2} + {( {u}^{2} κ )}^{2} = {=}^{{↓}^{equ . ( 125 )}} {( \frac{\sqrt{{u}^{2}} \frac{d \sqrt{{u}^{2}}}{d τ}}{\sqrt{{u}^{2}} \sqrt{{u}^{2} + 1}} )}^{2} + {u}^{4} {κ}^{2} = \frac{{( \frac{d \sqrt{{u}^{2}}}{d τ} )}^{2}}{{u}^{2} + 1} + {u}^{4} {κ}^{2} {=}^{{↓}^{equ . ( 126 )}} a \cdot a \qquad ( 119 )$$

Annex 20—Calculation of the rotation R̊η=(L̊ηq)⁻¹ [symbol] 72

In the following we calculate the four nontrivial components of the matrix

$$\begin{matrix}{R}^{˚} η = {( {L}^{˚} η )}^{- 1} \breve{L} η \\ = {η ( {L}^{˚} η )}^{T} η ( \breve{L} η ) \\ = ( \begin{matrix}1 & 0 & 0 & 0 \\ 0 & {{N}^{˚}}_{1} \cdot {\breve{N}}_{1} & {{N}^{˚}}_{1} \cdot {\breve{N}}_{2} & 0 \\ 0 & {{N}^{˚}}_{2} \cdot {\breve{N}}_{1} & {{N}^{˚}}_{2} \cdot {\breve{N}}_{2} & 0 \\ 0 & 0 & 0 & 1\end{matrix} )\end{matrix}$$

Although it is due to the properties of a rotation sufficient to calculate only two of the nontrivial components, we calculate in the following all four nontrivial components as a check:

$$\begin{matrix}{\mathring{N}}_{1} \cdot {\breve{N}}_{1}\end{matrix} = \frac{{u}^{0}}{\sqrt{{u}^{2}}} ( \begin{matrix}\frac{{u}^{2}}{{u}^{0}} - {u}^{0} + {u}^{0} \\ u\end{matrix} ) \cdot \frac{a}{\sqrt{{a}^{2}}} =$$

$$= \frac{{u}^{0}}{\sqrt{{u}^{2}}} ( \begin{matrix}\frac{{u}^{2}}{{u}^{0}} - {u}^{0} \\ 0\end{matrix} ) \cdot \frac{a}{\sqrt{{a}^{2}}} = - \frac{{a}^{0} {u}^{0}}{\sqrt{{a}^{2} {u}^{2}}} ( \frac{{u}^{2}}{{u}^{0}} - {u}^{0} ) =$$

$$= - \frac{{a}^{0}}{\sqrt{{a}^{2} {u}^{2}}} ( {u}^{2} - {( {u}^{0} )}^{2} ) = \frac{{a}^{0}}{\sqrt{{a}^{2} {u}^{2}}} {=}^{{↓}^{equ . ( 19 )}} \begin{matrix}\frac{{a}^{0}}{{ρ}_{1} \sqrt{{u}^{2}}}\end{matrix}$$

$$\begin{matrix}{\mathring{N}}_{1} \cdot {\breve{N}}_{1}\end{matrix} = \frac{{u}^{0}}{\sqrt{{u}^{2}}} ( \begin{matrix}\frac{{u}^{2}}{{u}^{0}} - {u}^{0} + {u}^{0} \\ u\end{matrix} ) \cdot {\breve{N}}_{2} =$$

$$= \frac{{u}^{0}}{\sqrt{{u}^{2}}} ( \begin{matrix}\frac{{u}^{2}}{{u}^{0}} - {u}^{0} \\ 0\end{matrix} ) \cdot {\breve{N}}_{2} = \frac{1}{\sqrt{{u}^{2}}} ( \begin{matrix}{u}^{2} - {( {u}^{0} )}^{2} \\ 0\end{matrix} ) \cdot {\breve{N}}_{2} = \frac{1}{\sqrt{{u}^{2}}} ( \begin{matrix}- 1 \\ 0\end{matrix} ) \cdot {\breve{N}}_{2} =$$

$$= \frac{1}{\sqrt{{u}^{2}}} {\breve{N}}_{2}^{0} = - \frac{\sqrt{{( u \times a )}^{2}}}{\sqrt{{u}^{2} {a}^{2}}} {=}^{{equ . ( 19 )}_{↓}} \begin{matrix}- \frac{\sqrt{{( u \times a )}^{2}}}{{ρ}_{1} \sqrt{{u}^{2}}} {=}^{{equ . ( 87 )}_{↓}} - \frac{{u}^{2}}{{ρ}_{1}}\end{matrix}$$

$$\begin{matrix}{\mathring{N}}_{2} \cdot {\breve{N}}_{1}\end{matrix} = ( \begin{matrix}0 \\ - \frac{u \times ( u \times a )}{\sqrt{{[ u \times ( u \times a ) ]}^{2}}}\end{matrix} ) \cdot \frac{a}{\sqrt{{a}^{2}}} = - \frac{1}{\sqrt{{a}^{2}}} \frac{[ u \times ( u \times a ) ] \cdot a}{\sqrt{{[ u \times ( u \times a ) ]}^{2}}} =$$

$$= \frac{\sqrt{{( u \times a )}^{2}}}{\sqrt{{u}^{2} {a}^{2}}} {=}^{{equ . ( 19 )}_{↓}} \begin{matrix}\frac{\sqrt{{( u \times a )}^{2}}}{{ρ}_{1} \sqrt{{u}^{2}}} {=}^{{equ . ( 87 )}_{↓}} - \frac{{u}^{2}}{{ρ}_{1}}\end{matrix} = - {\mathring{N}}_{1} \cdot {\breve{N}}_{2}$$

$$\begin{matrix}{\mathring{N}}_{2} \cdot {\breve{N}}_{1}\end{matrix} = ( \begin{matrix}0 \\ - \frac{u \times ( u \times a )}{\sqrt{{[ u \times ( u \times a ) ]}^{2}}}\end{matrix} ) \cdot ( \begin{matrix}- \frac{{( u \times a )}^{2}}{\sqrt{( a \cdot a ) {( u \times a )}^{2}}} \\ - \frac{( {u}^{0} a - {a}^{0} u ) \times ( u \times a )}{\sqrt{( a \cdot a ) {( u \times a )}^{2}}}\end{matrix} ) =$$

$$= \frac{[ u \times ( u \times a ) ] \cdot [ ( {u}^{0} a - {a}^{0} u ) \times ( u \times a ) ]}{\sqrt{{[ u \times ( u \times a ) ]}^{2}} \sqrt{( a \cdot a ) {( u \times a )}^{2}}} =$$

$$= \frac{( {u}^{0} a - {a}^{0} u ) \cdot \{ ( u \times a ) \times [ u \times ( u \times a ) ] \}}{\sqrt{{{u}^{2} ( u \times a )}^{2}} \sqrt{( a \cdot a ) {( u \times a )}^{2}}} =$$

$$= \frac{( {u}^{0} a - {a}^{0} u ) \cdot \{ ( ) \times [ \hat{u} \times ( ) ] \}}{\sqrt{( a \cdot a )}} =$$

$$= \frac{( {u}^{0} a - {a}^{0} u ) \cdot \hat{u}}{\sqrt{( a \cdot a )}} = \frac{( {u}^{0} a - {a}^{0} u ) \cdot u}{\sqrt{{u}^{2} ( a \cdot a )}} = …$$

$$( {u}^{0} a - {a}^{0} u ) \cdot u = {u}^{0} a \cdot u - {a}^{0} {u}^{2} = {{a}^{0} ( {u}^{0} )}^{2} - {a}^{0} [ {( {u}^{0} )}^{2} - 1 ) ] = {a}^{0}$$

$$… = \frac{{a}^{0}}{\sqrt{{a}^{2} {u}^{2}}} {=}^{{equ . ( 19 )}_{↓}} \begin{matrix}\frac{{a}^{0}}{{ρ}_{1} \sqrt{{u}^{2}}}\end{matrix} = {{N}^{˚}}_{1} \cdot {\breve{N}}_{1}$$

Further check:

$${( {{N}^{˚}}_{1} \cdot {\breve{N}}_{1} )}^{2} + {( {{N}^{˚}}_{1} \cdot {\breve{N}}_{2} )}^{2} = \frac{{( {a}^{0} )}^{2} + {( u \times a )}^{2}}{{a}^{2} {u}^{2}} {=}^{{↓}^{equ . ( 127 )}} 1$$

The final result can be brought into various forms:

$$⇒ {R}^{˚} η = ( \begin{matrix}1 & 0 & 0 & 0 \\ 0 & {{N}^{˚}}_{1} \cdot {\breve{N}}_{1} & {{N}^{˚}}_{2} \cdot {\breve{N}}_{2} & 0 \\ 0 & {{N}^{˚}}_{2} \cdot {\breve{N}}_{1} & {{N}^{˚}}_{2} \cdot {\breve{N}}_{2} & 0 \\ 0 & 0 & 0 & 1\end{matrix} ) = ( \begin{matrix}1 & 0 & 0 & 0 \\ 0 & \frac{{a}^{0}}{{ρ}_{1} \sqrt{{u}^{2}}} & - \frac{\sqrt{{( u \times a )}^{2}}}{{ρ}_{1} \sqrt{{u}^{2}}} & 0 \\ 0 & \frac{\sqrt{{( u \times a )}^{2}}}{{ρ}_{1} \sqrt{{u}^{2}}} & \frac{{a}^{0}}{{ρ}_{1} \sqrt{{u}^{2}}} & 0 \\ 0 & 0 & 0 & 1\end{matrix} ) = …$$

The preceding expression is equivalent to equ. (61) and the first alternative of equ. (62) of the description.

$$… {=}^{{↓}^{equ . ( 87 )}} ( \begin{matrix}1 & 0 & 0 & 0 \\ 0 & \frac{{a}^{0}}{\vert {a}^{0} \vert} \sqrt{1 - \frac{{u}^{4}}{{a}^{2}} {κ}^{2}} & - \frac{{u}^{2}}{\sqrt{{a}^{2}}} κ & 0 \\ 0 & \frac{{u}^{2}}{\sqrt{{a}^{2}}} κ & \frac{{a}^{0}}{\vert {a}^{0} \vert} \sqrt{1 - \frac{{u}^{4}}{{a}^{2}} {κ}^{2}} & 0 \\ 0 & 0 & 0 & 1\end{matrix} ) = = ( \begin{matrix}1 & 0 & 0 & 0 \\ 0 & \frac{{a}^{0}}{\vert {a}^{0} \vert} \sqrt{1 - \frac{{u}^{4}}{{ρ}_{1}^{2}} {κ}^{2}} & - \frac{{u}^{2}}{{ρ}_{1}} κ & 0 \\ 0 & \frac{{u}^{2}}{{ρ}_{1}} κ & \frac{{a}^{0}}{\vert {a}^{0} \vert} \sqrt{1 - \frac{{u}^{4}}{{ρ}_{1}^{2}} {κ}^{2}} & 0 \\ 0 & 0 & 0 & 1\end{matrix} ) = …$$

The preceding expression is equivalent to equ. (61) and the first alternative of equ. (63) of the description.

$$… = ( \begin{matrix}1 & {0}^{T} \\ 0 & {R}^{˚}\end{matrix} ) with \mathring{R} = ( \begin{matrix}\frac{{a}^{0}}{\vert {a}^{0} \vert} \sqrt{1 - {\mathring{f}}^{2}} & - \mathring{f} & 0 \\ \mathring{f} & \frac{{a}^{0}}{\vert {a}^{0} \vert} \sqrt{1 - {\mathring{f}}^{2}} & 0 \\ 0 & 0 & 1\end{matrix} )$$

which defines f̊ (120) Thus

$$\begin{matrix}{f}^{˚} = \frac{{u}^{2}}{\sqrt{{a}^{2}}} κ = \sqrt{1 - {( \frac{{a}^{0}}{\sqrt{{a}^{2} {u}^{2}}} )}^{2}} \geq 0\end{matrix} ⇒ [ {f}^{˚} = 0 ⇔ κ = 0 ] and [ {f}^{˚} = 1 ⇔ {a}^{0} = 0 ⇔ \frac{d \sqrt{{u}^{2}}}{d τ} = 0 ] \qquad ( 121 )$$

For later reference we calculate also

$${[ {Ω}^{˚} ]}_{x} := {{R}^{˚}}^{T} \frac{d {R}^{˚}}{d τ}$$

(see equ. (34)):

$${f}^{˚} = 1 ⇒ \frac{d {{R}^{˚}}^{T}}{d τ} {R}^{˚} = {[ ( \begin{matrix}0 \\ 0 \\ 0\end{matrix} ) ]}_{x}$$

$${f}^{˚} \neq 1 ⇒ \frac{d {{R}^{˚}}^{T}}{d τ} {R}^{˚} =$$

$$= ( \begin{matrix}\frac{{a}^{0}}{\vert {a}^{0} \vert} \frac{- \mathring{f} \frac{d \mathring{f}}{d τ}}{\sqrt{1 - \mathring{{f}^{2}}}} & \frac{d \mathring{f}}{d τ} & 0 \\ - \frac{d \mathring{f}}{d τ} & \frac{{a}^{0}}{\vert {a}^{0} \vert} \frac{- \mathring{f} \frac{d \mathring{f}}{d τ}}{\sqrt{1 - \mathring{{f}^{2}}}} & 0 \\ 0 & 0 & 0\end{matrix} ) ( \begin{matrix}\frac{{a}^{0}}{\vert {a}^{0} \vert} \sqrt{1 - \mathring{{f}^{2}}} & - \mathring{f} & 0 \\ \mathring{f} & \frac{{a}^{0}}{\vert {a}^{0} \vert} \sqrt{1 - \mathring{{f}^{2}}} & 0 \\ 0 & 0 & 1\end{matrix} ) =$$

$$= \frac{d {f}^{˚}}{d τ} ( \begin{matrix}\frac{{a}^{0}}{\vert {a}^{0} \vert} \frac{- {f}^{˚}}{\sqrt{1 - {{f}^{˚}}^{2}}} & 1 & 0 \\ - 1 & \frac{{a}^{0}}{\vert {a}^{0} \vert} \frac{- {f}^{˚}}{\sqrt{1 - {{f}^{˚}}^{2}}} & 0 \\ 0 & 0 & 0\end{matrix} ) ( \begin{matrix}\frac{{a}^{0}}{\vert {a}^{0} \vert} \sqrt{1 - {{f}^{˚}}^{2}} & - {f}^{˚} & 0 \\ {f}^{˚} & \frac{{a}^{0}}{\vert {a}^{0} \vert} \sqrt{1 - {{f}^{˚}}^{2}} & 0 \\ 0 & 0 & 1\end{matrix} ) =$$

$$= \frac{d {f}^{˚}}{d τ} ( \begin{matrix}0 & \frac{{a}^{0}}{\vert {a}^{0} \vert} \sqrt{1 - {{f}^{˚}}^{2}} + \frac{{{f}^{˚}}^{2}}{\sqrt{1 - {{f}^{˚}}^{2}}} & 0 \\ - \frac{{a}^{0}}{\vert {a}^{0} \vert} \sqrt{1 - {{f}^{˚}}^{2}} + \frac{{{f}^{˚}}^{2}}{\sqrt{1 - {{f}^{˚}}^{2}}} & 0 & 0 \\ 0 & 0 & 0\end{matrix} ) =$$

$$= - \frac{{a}^{0}}{\vert {a}^{0} \vert} \frac{\frac{d {f}^{˚}}{d τ}}{\sqrt{1 - {{f}^{˚}}^{2}}} ( \begin{matrix}0 & - 1 & 0 \\ 1 & 0 & 0 \\ 0 & 0 & 0\end{matrix} ) = - \frac{{a}^{0}}{\vert {a}^{0} \vert} {\frac{\frac{d {f}^{˚}}{d τ}}{\sqrt{1 - {{f}^{˚}}^{2}}} [ ( \begin{matrix}0 \\ 0 \\ 1\end{matrix} ) ]}_{x}$$

$$⇒ {[ {Ω}^{˚} ]}_{x} := {{R}^{˚}}^{T} \frac{d {R}^{˚}}{d τ} = - \frac{d {{R}^{˚}}^{T}}{d τ} {R}^{˚} = \{ \begin{matrix}{[ ( \begin{matrix}0 \\ 0 \\ 1\end{matrix} ) ]}_{x} & if {f}^{˚} = 1 \\ \frac{{a}^{0}}{\vert {a}^{0} \vert} {\frac{\frac{d {f}^{˚}}{d τ}}{\sqrt{1 - {{f}^{˚}}^{2}}} [ ( \begin{matrix}0 \\ 0 \\ 1\end{matrix} ) ]}_{x} & if {f}^{˚} \neq 1\end{matrix}$$

Annex 21—Calculation of the rotation \dot{R}η=(\dot{L}η)⁻¹ L̊η

We have to calculate the components of the following matrix:

$$\begin{matrix}\dot{R} η = {( \dot{L} η )}^{- 1} \mathring{L} η \\ = {η ( \dot{L} η )}^{T} η ( \mathring{L} η ) \\ = ( \begin{matrix}1 & 0 & 0 & 0 \\ 0 & 1 & 0 & 0 \\ 0 & 0 & {\dot{N}}_{2} \cdot {\mathring{N}}_{2} & {\dot{N}}_{2} \cdot {\mathring{N}}_{3} \\ 0 & & {\dot{N}}_{3} \cdot {\mathring{N}}_{2} & {\dot{N}}_{3} \cdot {\mathring{N}}_{3}\end{matrix} )\end{matrix} \qquad ( 122 )$$

Although it is due to the properties of a rotation sufficient to calculate only two of the nontrivial components, we calculate in the following all four nontrivial components as a check:

$$\begin{matrix}{\dot{N}}_{2} \cdot {\mathring{N}}_{2}\end{matrix} = ( \begin{matrix}0 \\ - \frac{u \times ( u \times b )}{\sqrt{[ u \times {( u \times b )}^{2}}}\end{matrix} ) \cdot ( \begin{matrix}0 \\ - \frac{u \times ( u \times a )}{\sqrt{[ u \times {( u \times a )}^{2}}}\end{matrix} ) =$$

$$= \frac{[ u \times ( u \times b ) ] \cdot [ u \times ( u \times a ) ]}{\sqrt{[ u \times {( u \times b )}^{2} [ u \times {( u \times a )}^{2}}} =$$

$$= \frac{( u \times a ) \cdot \{ [ u \times ( u \times b ) ] \times u \}}{\sqrt{{{u}^{2} ( u \times b )}^{2} {( u \times a )}^{2}}} =$$

$$= \frac{{\sqrt{{u}^{2}}}^{3} ( u \times a ) \cdot ( \hat{u} \times b )}{{u}^{2} \sqrt{{( u \times b )}^{2} {( u \times a )}^{2}}} = \begin{matrix}\frac{( u \times a ) \cdot ( u \times b )}{\sqrt{{( u \times b )}^{2} {( u \times a )}^{2}}}\end{matrix}$$

$$\begin{matrix}{\dot{N}}_{3} \cdot {\mathring{N}}_{3}\end{matrix} = ( \begin{matrix}0 \\ \frac{u \times b}{\sqrt{{( u \times b )}^{2}}}\end{matrix} ) \cdot ( \begin{matrix}0 \\ \frac{u \times a}{\sqrt{{( u \times a )}^{2}}}\end{matrix} ) =$$

$$= \begin{matrix}\frac{( u \times a ) \cdot ( u \times b )}{\sqrt{{( u \times b )}^{2} {( u \times a )}^{2}}}\end{matrix} = {\dot{N}}_{2} \cdot {\mathring{N}}_{2}$$

$$\begin{matrix}{\dot{N}}_{3} \cdot {\mathring{N}}_{3}\end{matrix} = ( \begin{matrix}0 \\ - \frac{u \times ( u \times b )}{\sqrt{{[ u \times ( u \times b ) ]}^{2}}}\end{matrix} ) \cdot ( \begin{matrix}0 \\ \frac{u \times a}{\sqrt{{( u \times a )}^{2}}}\end{matrix} ) =$$

$$= - \frac{[ u \times ( u \times b ) ] \cdot ( u \times a )}{\sqrt{{[ u \times ( u \times b ) ]}^{2} \cdot {( u \times a )}^{2}}} =$$

$$= \frac{a \cdot \{ [ u \times ( u \times b ) ] \times u \}}{\sqrt{{{u}^{2} ( u \times b )}^{2} {( u \times a )}^{2}}} =$$

$$= \frac{{\sqrt{{u}^{2}}}^{3} a \cdot ( \hat{u} \times b )}{\sqrt{{{u}^{2} ( u \times b )}^{2} {( u \times a )}^{2}}} = \begin{matrix}\frac{\sqrt{{u}^{2}} a \cdot ( u \times b )}{\sqrt{{( u \times b )}^{2} {( u \times a )}^{2}}}\end{matrix}$$

$$\begin{matrix}{\dot{N}}_{3} \cdot {\mathring{N}}_{3}\end{matrix} = ( \begin{matrix}0 \\ \frac{u \times b}{\sqrt{{( u \times b )}^{2}}}\end{matrix} ) \cdot ( - \begin{matrix}0 \\ \frac{u \times ( u \times a )}{\sqrt{{[ u \times ( u \times a ) ]}^{2}}}\end{matrix} ) = …$$

like \dot{N}₂·N̊₃, but with a and b exchanged

$$… = \frac{\sqrt{{u}^{2}} b \cdot ( u \times a )}{\sqrt{{( u \times b )}^{2} {( u \times a )}^{2}}} = \begin{matrix}- \frac{\sqrt{{u}^{2}} a \cdot ( u \times b )}{\sqrt{{( u \times b )}^{2} {( u \times a )}^{2}}}\end{matrix} = - {\dot{N}}_{2} \cdot {{N}^{˚}}_{3}$$

Further check: from relations

[(u×a)×(u×b)]²+[(u×a)·(u×b)]²=(u×b)²(u×a)²

(u×a)×(u×b)=[u·(a×b)]u=−[a·(u×b)]u

one can see that

$${[ \frac{( u \times a ) \cdot ( u \times b )}{\sqrt{{( u \times b )}^{2} {( u \times a )}^{2}}} ]}^{2} + {[ \frac{\sqrt{{u}^{2}} a \cdot ( u \times b )}{\sqrt{{( u \times b )}^{2} {( u \times a )}^{2}}} ]}^{2} = 1$$

$$⇔ {( {\dot{N}}_{2} \cdot {{N}^{˚}}_{2} )}^{2} + {( {\dot{N}}_{2} \cdot {{N}^{˚}}_{3} )}^{2} = 1$$

Inserting the results in equ. (122) yields

$$\dot{R} η = ( \begin{matrix}1 & 0 & 0 & 0 \\ 0 & 1 & 0 & 0 \\ 0 & 0 & \frac{( u \times a ) \cdot ( u \times b )}{\sqrt{{( u \times b )}^{2} {( u \times a )}^{2}}} & \frac{\sqrt{{u}^{2}} a \cdot ( u \times b )}{\sqrt{{( u \times b )}^{2} {( u \times a )}^{2}}} \\ 0 & 0 & - \frac{\sqrt{{u}^{2}} a \cdot ( u \times b )}{\sqrt{{( u \times b )}^{2} {( u \times a )}^{2}}} & \frac{( u \times a ) \cdot ( u \times b )}{\sqrt{{( u \times b )}^{2} {( u \times a )}^{2}}}\end{matrix} ) \qquad ( 123 )$$

This equation corresponds to equ. (70) and the first alternative of equ. (71) of the description.

Annex 22—Determination of the transport property \dot{D}η of local frame \dot{L}η

The transport property \dot{D}η of local frame \dot{L}η can be directly read from the transport property \tilde{D}η (see equ. (114) in annex 17) of the more general local frame \tilde{L}η by replacing d(τ) with b (b is an arbitrary constant vector

$$( \frac{db}{d τ} = 0 )$$

with b [symbol] u):

$$equ . ( 114 ) and equ . ( 125 ) , ( 90 )$$

$$\dot{D} η = [ {η ( \dot{L} η )}^{T} η ] \frac{d ( \dot{L} η )}{d τ} {=}^{↓} \\ = η ( \begin{matrix}0 & * & * & * \\ \frac{{a}^{0}}{\sqrt{{u}^{2}}} & 0 & * & * \\ - \frac{1}{\sqrt{{u}^{2}}} \frac{[ u \times ( u \times b ) ] \cdot a}{\sqrt{{( u \times b )}^{2}}} & - \frac{{u}^{0}}{{u}^{2}} \frac{[ u \times ( u \times b ) ] \cdot a}{\sqrt{{( u \times b )}^{2}}} & 0 & * \\ \frac{a \cdot ( u \times b )}{\sqrt{{( u \times b )}^{2}}} & \frac{{u}^{0}}{\sqrt{{u}^{2}}} \frac{a \cdot ( u \times b )}{\sqrt{{( u \times b )}^{2}}} & \frac{( u \cdot b ) [ a \cdot ( b \times u ) ]}{{( u \times b )}^{2} \sqrt{{u}^{2}}} & 0\end{matrix} ) = \\ = η ( \begin{matrix}0 & * & * & * \\ \frac{1}{{u}^{0}} \frac{d \sqrt{{u}^{2}}}{d τ} & 0 & * & * \\ - \sqrt{{u}^{2}} \frac{[ \hat{u} \times ( \hat{u} \times b ) ] \cdot \frac{d \hat{u}}{d τ}}{\sqrt{{( \hat{u} \times b )}^{2}}} & - {u}^{0} \frac{[ \hat{u} \times ( \hat{u} \times b ) ] \cdot \frac{d \hat{u}}{d τ}}{\sqrt{{( \hat{u} \times b )}^{2}}} & 0 & * \\ \sqrt{{u}^{2}} \frac{\frac{d \hat{u}}{d τ} \cdot ( \hat{u} \times b )}{\sqrt{{( \hat{u} \times b )}^{2}}} & {u}^{0} \frac{\frac{d \hat{u}}{d τ} \cdot ( \hat{u} \times b )}{\sqrt{{( \hat{u} \times b )}^{2}}} & \frac{( \hat{u} \cdot b ) [ \frac{d \hat{u}}{d τ} \cdot ( b \times \hat{u} ) ]}{{( \hat{u} \times b )}^{2}} & 0\end{matrix} )$$

wherein the stars * complement the skew symmetric matrix (η\dot{D}η is skew symmetric according to equ. (85), but \dot{D}η is not).

Annex 23—Proof of the second alternative of equ. (62)/(63) and the second and third alternatives of equ. (71)

The proof of the second alternative of equ. (49) corresponding to the case ρ₂=0∧a [symbol] u, which implies ρ₁≠0, was already given in the paragraph below equ. (52). The proof of the second alternative of equ. (62)/(63) and of the second and third alternatives of equ. (71) corresponding to the case a∥ u and the proof that these alternatives ensure that expression (43) provides in all cases all possible 4D-Frenet-Serret frames is given in the following.

One can see from equ. (72)/(73) that only two components of \dot{D}η do not vanish, if a∥ u, because regarding equ. (72) the following applies

a∥u⇒a·(u×b)=[u×(u×b)]·a=0

and because regarding equ. (73) the following applies

$$a ‖ u ⇒ \frac{d \hat{u}}{d τ} = 0$$

That the absolute values of the two remaining identical components

$$\frac{{a}^{0}}{\sqrt{{u}^{2}}} = \frac{1}{{u}^{0}} \frac{d \sqrt{{u}^{2}}}{d τ}$$

are for a∥ u equal to the first curvature of the 4D-Frenet-Serret frame ρ₁=\sqrt{a·a} defined in equations (19) and (27) above follows from equ. (15) or equ. (115) (by replacing d(τ) with b) or directly from equ. (127). But one can see that for a∥u ∧ρ₁≠0 said two remaining identical components are equal to ρ₁ only if

$$\frac{\frac{d \sqrt{{u}^{2}}}{d τ}}{\vert \frac{d \sqrt{{u}^{2}}}{d τ} \vert} = \frac{{a}^{0}}{\vert {a}^{0} \vert} = \hat{u} \cdot \hat{a} = 1 ,$$

but equal to −ρ₁ otherwise. The transport property by \dot{D}η with a∥ u assumes thus the form

$$a ‖ u \dot{D} η = ( \begin{matrix}0 & \frac{{a}^{0}}{\vert {a}^{0} \vert} {ρ}_{1} & 0 & 0 \\ \frac{{a}^{0}}{\vert {a}^{0} \vert} {ρ}_{1} & 0 & 0 & 0 \\ 0 & 0 & 0 & 0 \\ 0 & 0 & 0 & 0\end{matrix} ) \qquad ( 124 )$$

Now two cases have to be distinguished:

1. a∥u∧ρ₁=0

Comparing equ. (124) with equ. (26) one can see that local frame \dot{L}η is a 4D-Frenet-Serret frame if ρ₁=0. According to statement (37) above the 4D-Frenet-Serret frame is in this case determined by equ. (27) only up to a rotation [symbol] with an arbitrary, but constant axis and an arbitrary, but constant angle. Since the three rotations [symbol] form an Euler cradle, they can form an arbitrary rotation [symbol] with an arbitrary, but constant axis and with an arbitrary, but constant angle by choosing for the three angles [symbol] , α̊, \dot{α} appropriate constant values as defined in the second alternative of equ. (49), in the second alternative of equ. (62)/(63) and in the third alternative of equ. (71). In this way expression (43) provides in this case all possible 4D-Frenet-Serret frames.

2. a∥u∧ρ₁≠0

Comparing equ. 124 with equ. (26) one can see that local frame \dot{L}η is a 4D-Frenet-Serret frame if

$$\frac{\frac{d \sqrt{{u}^{2}}}{d τ}}{\vert \frac{d \sqrt{{u}^{2}}}{d τ} \vert} = \frac{{a}^{0}}{\vert {a}^{0} \vert} = \hat{u} \cdot \hat{a} = 1 ,$$

but not if

$$\frac{\frac{d \sqrt{{u}^{2}}}{d τ}}{\vert \frac{d \sqrt{{u}^{2}}}{d τ} \vert} = \frac{{a}^{0}}{\vert {a}^{0} \vert} = \hat{u} \cdot \hat{a} = - 1.$$

In case of a∥u ∧ρ₁ #0 the angle α̊ assumes according to equ. (62)/(63) the value

$$a ‖ u ∧ {ρ}_{1} \neq 0 ⇒ {α}^{˚} = a tan 2 ( 0 , \frac{{a}^{0}}{\vert {a}^{0} \vert} ) = \frac{{a}^{0}}{\vert {a}^{0} \vert} \frac{π}{2}$$

and the rotation R̊η thus assumes according to equ. (61) the form

$$a ‖ u ∧ {ρ}_{1} \neq 0 ⇒ {R}^{˚} η = ( \begin{matrix}1 & 0 & 0 & 0 \\ 0 & \frac{{a}^{0}}{\vert {a}^{0} \vert} & 0 & 0 \\ 0 & 0 & \frac{{a}^{0}}{\vert {a}^{0} \vert} & 0 \\ 0 & 0 & 0 & 1\end{matrix} )$$

The product \dot{L}ηR̊η, which constitutes another local frame, thus assumes the form

$$a ‖ u ∧ {ρ}_{1} \neq 0 ⇒ \dot{L} η {R}^{˚} η = ( \begin{matrix}{\dot{N}}_{0} & \frac{{a}^{0}}{\vert {a}^{0} \vert} {\dot{N}}_{1} & \frac{{a}^{0}}{\vert {a}^{0} \vert} {\dot{N}}_{2} & {\dot{N}}_{3}\end{matrix} )$$

As shown in annex 32 “Calculation of

$${\overline{N}}_{1} = \frac{a}{\sqrt{a \cdot a}}$$

in case of a∥u ∧ρ₁≠0” in this case the following identity holds:

$$a ‖ u ∧ {ρ}_{1} \neq 0 ⇒ {\overline{N}}_{1} = \frac{a}{\sqrt{a \cdot a}} = \frac{{a}^{0}}{\vert {a}^{0} \vert} ( \begin{matrix}\sqrt{{u}^{2}} \\ \frac{{u}^{0}}{\sqrt{{u}^{2}}} u\end{matrix} ) = \frac{{a}^{0}}{\vert {a}^{0} \vert} {\dot{N}}_{1}$$

Using equ. (33) and (124) one can see that the transport property of the local frame \dot{L}ηR̊η constructed in this way is in case of a∥u ∧ρ₁≠0 given by

$$( \begin{matrix}0 & {ρ}_{1} & 0 & 0 \\ {ρ}_{1} & 0 & 0 & 0 \\ 0 & 0 & 0 & 0 \\ 0 & 0 & 0 & 0\end{matrix} )$$

i.e. the local frame constructed in this way is a 4D-Frenet-Serret frame in case of a∥u ∧ρ₁≠0. Because of a∥u⇒ρ₂=0 (reasons given in the paragraph below equ. (31) above) this is a subcase of the statement (36) above, i.e. the 4D-Frenet-Serret frame is in this case determined by equ. (27) only up to a rotation [symbol] with axis (1 0 0)^{T} and an arbitrary, but constant angle. Now the axis of [symbol] is (1 0 0)^{T} and for this reason the angle ᾰ, which is not well defined in the first alternative of equ. (49), if a∥u, can assume according to the second alternative of equ. (49) any constant value ∈ [symbol] in this case, while [symbol] has to be the unity matrix, i.e. \dot{α}=0, as defined in the second alternative of equ. (71). In this way expression (43) provides in this case all possible 4D-Frenet-Serret frames.

Annex 24—Calculation of the first 4D-curvature ρ₁=ρ₂ [symbol] , \sqrt{u²}) in terms of the 3D-curvature [symbol] and the magnitude \sqrt{u²} of the three-dimensional spatial part u of the four-velocity

$$u = ( \begin{matrix}{u}^{0} \\ u\end{matrix} )$$

Starting from relations

$${u}^{0} {=}^{{↓}^{equ . ( 3 )}} \sqrt{{u}^{2} + 1} \qquad ( 125 )$$

$$u = \sqrt{{u}^{2}} \hat{u} = \vert u \vert \hat{u}$$

$${\hat{u}}^{2} = 1 ⇒ \hat{u} \cdot \frac{d \hat{u}}{d τ} = 0 ⇒ {a}^{0} = \frac{\vert u \vert \frac{d \vert u \vert}{d τ}}{\sqrt{{u}^{2} + 1}}$$

ρ₁ can be calculated:

$$\begin{matrix}{ρ}_{1}^{2}\end{matrix} {=}^{{↓}^{equ . ( 19 )}} {a}^{2} = - \frac{{{u}^{2} ( \frac{d \vert u \vert}{d τ} )}^{2}}{{u}^{2} + 1} + {( \frac{d u}{d τ} )}^{2} = - \frac{{{u}^{2} ( \frac{d \vert u \vert}{d τ} )}^{2}}{{u}^{2} + 1} + {( \frac{d \vert u \vert}{d τ} \hat{u} + \vert u \vert \frac{d \hat{u}}{d τ} )}^{2} == - \frac{{{u}^{2} ( \frac{d \vert u \vert}{d τ} )}^{2}}{{u}^{2} + 1} + {( \frac{d \vert u \vert}{d τ} \hat{u} )}^{2} + {( \vert u \vert \frac{d \hat{u}}{d τ} )}^{2} == - \frac{{{u}^{2} ( \frac{d \vert u \vert}{d τ} )}^{2}}{{u}^{2} + 1} + {( \frac{d \vert u \vert}{d τ} )}^{2} + {{u}^{2} ( \frac{d \hat{u}}{d τ} )}^{2} == \frac{1}{{u}^{2} + 1} {( \frac{d \vert u \vert}{d τ} )}^{2} + {{u}^{2} ( \frac{d \hat{u}}{d τ} )}^{2} = {=}^{{↓}^{equ . ( 88 )}} \begin{matrix}\frac{1}{{u}^{2} + 1} {( \frac{d \vert u \vert}{d τ} )}^{2} + {u}^{4} {2}^{}\end{matrix} = … \qquad ( 126 )$$

The preceding equation is replicated as equ. (74) in the description.

$$… {=}^{{↓}^{equ . ( 125 ) ( 87 )}} \frac{{( {a}^{0} )}^{2}}{{u}^{2}} + {{u}^{4} ( \frac{\sqrt{{( u \times a )}^{2}}}{{\sqrt{{u}^{2}}}^{3}} )}^{2} == \frac{{( {a}^{0} )}^{2} + {( u \times a )}^{2}}{{u}^{2}} \qquad ( 127 )$$

Annex 25—Calculation of the second 4D-curvature ρ₂=ρ₂( [symbol] , τ, \sqrt{u²}) (first torsion) in terms of the 3D-curvature [symbol] , the 3D-torsion τ and the magnitude \sqrt{u²} of the three-dimensional spatial part u of the four-velocity

$$u = ( \begin{matrix}{u}^{0} \\ u\end{matrix} )$$

In the following [symbol] ₂ is calculated from D̊₂ and [symbol] according to equation (33) and the result is equated with [symbol] ₂ calculated in equ. (108):

$$( 128 )$$

$${L}^{⌣} η = {L}^{˚} η \cdot {R}^{˚} η ⇒ {{D}^{⌣}}_{2} = {{R}^{˚}}^{T} {{D}^{˚}}_{2} + {Ω}^{˚} = {=}^{{↓}^{equ . ( 120 ) , ( 118 )}} {( \begin{matrix}\frac{{a}^{0}}{\vert {a}^{0} \vert} \sqrt{1 - {{f}^{˚}}^{2}} & - {f}^{˚} & 0 \\ {f}^{˚} & \frac{{a}^{0}}{\vert {a}^{0} \vert} \sqrt{1 - {{f}^{˚}}^{2}} & 0 \\ 0 & 0 & 1\end{matrix} )}^{T} ( \begin{matrix}\begin{matrix}τ \sqrt{{u}^{2}} \\ 0\end{matrix} \\ {u}^{0} \sqrt{{u}^{2}}\end{matrix} ) + {Ω}^{˚} == ( \begin{matrix}\frac{{a}^{0}}{\vert {a}^{0} \vert} \sqrt{1 - {{f}^{˚}}^{2}} & {f}^{˚} & 0 \\ - {f}^{˚} & \frac{{a}^{0}}{\vert {a}^{0} \vert} \sqrt{1 - {{f}^{˚}}^{2}} & 0 \\ 0 & 0 & 1\end{matrix} ) ( \begin{matrix}\begin{matrix}τ \sqrt{{u}^{2}} \\ 0\end{matrix} \\ {u}^{0} \sqrt{{u}^{2}}\end{matrix} ) + {Ω}^{˚} == ( \begin{matrix}τ \sqrt{{u}^{2}} \frac{{a}^{0}}{\vert {a}^{0} \vert} \sqrt{1 - {{f}^{˚}}^{2}} \\ - {f}^{˚} τ \sqrt{{u}^{2}} \\ {u}^{0} \sqrt{{u}^{2}}\end{matrix} ) + {Ω}^{˚} == \{ \begin{matrix}( \begin{matrix}τ \sqrt{{u}^{2}} \frac{{a}^{0}}{\vert {a}^{0} \vert} \sqrt{1 - {{f}^{˚}}^{2}} \\ - {f}^{˚} τ \sqrt{{u}^{2}} \\ {u}^{0} \sqrt{{u}^{2}}\end{matrix} ) & if {f}^{˚} = 1 \\ ( \begin{matrix}τ \sqrt{{u}^{2}} \frac{{a}^{0}}{\vert {a}^{0} \vert} \sqrt{1 - {{f}^{˚}}^{2}} \\ - {f}^{˚} τ \sqrt{{u}^{2}} \\ {u}^{0} \sqrt{{u}^{2}}\end{matrix} ) + \frac{{a}^{0}}{\vert {a}^{0} \vert} {\frac{\frac{d {f}^{˚}}{d τ}}{\sqrt{1 - {{f}^{˚}}^{2}}} [ ( \begin{matrix}\begin{matrix}0 \\ 0\end{matrix} \\ 1\end{matrix} ) ]}_{\times } & if {f}^{˚} \neq 1\end{matrix} \} == \{ \begin{matrix}( \begin{matrix}τ \sqrt{{u}^{2}} \frac{{a}^{0}}{\vert {a}^{0} \vert} \sqrt{1 - {{f}^{˚}}^{2}} \\ - {f}^{˚} τ \sqrt{{u}^{2}} \\ {u}^{0} \sqrt{{u}^{2}}\end{matrix} ) & if {f}^{˚} = 1 \\ ( \begin{matrix}τ \sqrt{{u}^{2}} \frac{{a}^{0}}{\vert {a}^{0} \vert} \sqrt{1 - {{f}^{˚}}^{2}} \\ - {f}^{˚} τ \sqrt{{u}^{2}} \\ \frac{{a}^{0}}{\vert {a}^{0} \vert} \frac{\frac{d {f}^{˚}}{d τ}}{\sqrt{1 - {{f}^{˚}}^{2}}} + {u}^{0} \sqrt{{u}^{2}}\end{matrix} ) & if {f}^{˚} \neq 1\end{matrix} \} == \{ \begin{matrix}( \begin{matrix}0 \\ - τ \sqrt{{u}^{2}} \\ {u}^{0} \sqrt{{u}^{2}}\end{matrix} ) & if {f}^{˚} = 1 \\ ( \begin{matrix}τ \sqrt{{u}^{2}} \frac{{a}^{0}}{\vert {a}^{0} \vert} \sqrt{1 - {{f}^{˚}}^{2}} \\ - {f}^{˚} τ \sqrt{{u}^{2}} \\ \frac{{a}^{0}}{\vert {a}^{0} \vert} \frac{\frac{d {f}^{˚}}{d τ}}{\sqrt{1 - {{f}^{˚}}^{2}}} + {u}^{0} \sqrt{{u}^{2}}\end{matrix} ) & if {f}^{˚} \neq 1\end{matrix} \} {=}^{{↓}^{equ . ( 108 )}} {ρ}_{2} ( \begin{matrix}\begin{matrix}\frac{{a}^{0}}{\sqrt{{( u \times a )}^{2}}} {f}^{⌣} \\ - {f}^{⌣}\end{matrix} \\ 〈 \pm 〉 \sqrt{1 - {{f}^{⌣}}^{2}}\end{matrix} ) = {{D}^{⌣}}_{2}$$

We get thus three equations, one for each component of [symbol] ₂.

The equation for the first component produces for f̊=1⇔α⁰=0 (see equ. (121)) a true statement. For f̊≠1 the equation for the first component reproduces the definition of [symbol] given in equ. (87):

$$- \frac{{a}^{0}}{\vert {a}^{0} \vert} \sqrt{1 - {{f}^{˚}}^{2}} τ \sqrt{{u}^{2}} = - {ρ}_{2} {f}^{⌣} \frac{{a}^{0}}{\sqrt{{( u \times a )}^{2}}} {⇔}^{{↓}^{equ . ( 121 ) , ( 1 \; 29 )}} - \frac{{a}^{0}}{\sqrt{{a}^{2} {u}^{2}}} τ \sqrt{{u}^{2}} = - τ \sqrt{{u}^{2}} \sqrt{{u}^{2}} \frac{\sqrt{{u}^{2}}}{\sqrt{{a}^{2}}} \frac{{a}^{0}}{\sqrt{{( u \times a )}^{2}}} ⇔ \frac{\sqrt{{( u \times a )}^{2}}}{{\sqrt{{u}^{2}}}^{3}} =$$

The equation for the second component reproduces for both cases f̊=1 and f̊≠1 merely the following correct relationship:

$${ρ}_{2} {f}^{⌣} {=}^{{↓}^{equ . ( 104 )}} \frac{\frac{d a}{d τ} \cdot ( u \times a )}{\sqrt{( a \cdot a ) {( u \times a )}^{2}}} == \frac{\sqrt{{u}^{2}} \frac{d a}{d τ} \cdot ( u \times a )}{{( u \times a )}^{2}} \frac{\sqrt{{( u \times a )}^{2}}}{{u}^{2}} \frac{\sqrt{{u}^{2}}}{\sqrt{{a}^{2}}} {=}^{{↓}^{equ . ( 87 )}} τ \frac{{\sqrt{{u}^{2}}}^{3}}{\sqrt{{a}^{2}}} {=}^{{↓}^{equ . ( 121 )}} {f}^{˚} τ \sqrt{{u}^{2}} \qquad ( 129 )$$

The equation for the third component is the interesting one. For

$${f}^{˚} = 1 ⇔ {a}^{0} = 0 ⇔ \frac{d \sqrt{{u}^{2}}}{d τ} = 0$$

(see equ. (121) above) the equation for the third component expresses ρ₂ in terms of [symbol] , τ and \sqrt{u²}.

$$\frac{d \sqrt{{u}^{2}}}{d τ} = 0 ⇒ {ρ}_{2}^{2} = {( {u}^{0} \sqrt{{u}^{2}} )}^{2} + {( {ρ}_{2} {f}^{⌣} )}^{2} {=}^{{↓}^{equ . ( 129 )}} {( {u}^{0} \sqrt{{u}^{2}} )}^{2} + {( {f}^{˚} τ \sqrt{{u}^{2}} )}^{2} {=}^{{↓}^{{f}^{˚} = 1}} = {( {u}^{0} \sqrt{{u}^{2}} )}^{2} + {τ}^{2} {u}^{2} = ( {u}^{2} + 1 ) {u}^{2} {2}^{} + {τ}^{2} {u}^{2} ⇔ \begin{matrix}{ρ}_{2} = \sqrt{{u}^{2} [ ( {u}^{2} + 1 ) {2}^{} + {τ}^{2} ]}\end{matrix} ( {ρ}_{2} > 0 see equ . ( 21 ) ) \qquad ( 130 )$$

Also for

$${f}^{˚} \neq 1 ⇔ \frac{d \sqrt{{u}^{2}}}{d τ} \neq 0 ⇔ y \neq 0$$

(see equ. (121) above) the equation for the third component can be used to express ρ₂ in terms of [symbol] , τ and \sqrt{u²}:

$$\frac{{a}^{0}}{\vert {a}^{0} \vert} \frac{\frac{d {f}^{˚}}{d τ}}{\sqrt{1 - {{f}^{˚}}^{2}}} + {u}^{0} \sqrt{{u}^{2}} = 〈 \pm 〉 \sqrt{{ρ}_{2}^{2} - {ρ}_{2}^{2} {{f}^{⌣}}^{2}} ⇔ {( \frac{{a}^{0}}{\vert {a}^{0} \vert} \frac{\frac{d {f}^{˚}}{d τ}}{\sqrt{1 - {{f}^{˚}}^{2}}} + {u}^{0} \sqrt{{u}^{2}} )}^{2} + {ρ}_{2}^{2} {{f}^{⌣}}^{2} = {ρ}_{2}^{2} {⇔}^{{↓}^{equ . ( 129 )}} {ρ}_{2}^{2} = {( \frac{{a}^{0}}{\vert {a}^{0} \vert} \frac{\frac{d {f}^{˚}}{d τ}}{\sqrt{1 - {{f}^{˚}}^{2}}} + {u}^{0} \sqrt{{u}^{2}} )}^{2} + {( {f}^{˚} τ \sqrt{{u}^{2}} )}^{2} \qquad ( 131 )$$

In order to express ρ₂ in terms of \sqrt{u²}=|u|, [symbol] and τ, we have only to express f̊ and

$$\frac{\frac{d {f}^{˚}}{d τ}}{\sqrt{1 - {{f}^{˚}}^{2}}}$$

in terms of \sqrt{u²}=|u| and [symbol] :

$${{f}^{˚}}^{2} {=}^{{↓}^{equ . ( 121 )}} \frac{{u}^{4}}{{a}^{2}} {2}^{} {=}^{{↓}^{equ . ( 126 )}} \frac{{u}^{4} {2}^{}}{\frac{1}{{u}^{2} + 1} {( \frac{d \sqrt{{u}^{2}}}{d τ} )}^{2} + {u}^{4} {2}^{}} {=}^{{↓}^{\neq 0}} \frac{1}{\frac{1}{( {u}^{2} + 1 ) {u}^{4} {2}^{}} {( \frac{d \sqrt{{u}^{2}}}{d τ} )}^{2} + 1} == \frac{1}{{( \frac{1}{} \frac{1}{{u}^{2} \sqrt{{u}^{2} + 1}} \frac{d \sqrt{{u}^{2}}}{d τ} )}^{2} + 1} = \frac{1}{{y}^{2} + 1} \qquad ( 132 )$$

$$with$$

$$y := \frac{1}{} \frac{1}{{u}^{2} \sqrt{{u}^{2} + 1}} \frac{d \sqrt{{u}^{2}}}{d τ} = \frac{\frac{\vert u \vert \frac{d \vert u \vert}{d τ}}{\sqrt{{u}^{2} + 1}}}{{\sqrt{{u}^{2}}}^{3}} {=}^{{↓}^{equ . ( 125 ) and ( 87 )}} \frac{{a}^{0}}{\sqrt{{( u \times a )}^{2}}}$$

$${⟹}^{{↓}^{{f}^{˚} > 0 equ . ( 121 )}} {f}^{˚} = \frac{1}{\sqrt{{y}^{2} + 1}} \qquad ( 133 )$$

$$⇒ [ {f}^{˚} \neq 1 ⇔ y \neq 0 ⇔ \frac{d \sqrt{{u}^{2}}}{d τ} \neq 0 ] \qquad ( 134 )$$

$$equ . ( 133 ) ⇔ 1 - {{f}^{˚}}^{2} = 1 - \frac{1}{{y}^{2} + 1} = \frac{{y}^{2}}{{y}^{2} + 1} ⇔ \frac{1}{\sqrt{1 - {{f}^{˚}}^{2}}} = \frac{\sqrt{{y}^{2} + 1}}{\vert y \vert} equ . ( 133 ) ⇒ \frac{d {f}^{˚}}{d τ} = - \frac{y \frac{dy}{d τ}}{{\sqrt{{y}^{2} + 1}}^{3}} ⇒ \frac{\frac{d {f}^{˚}}{d τ}}{\sqrt{1 - {{f}^{˚}}^{2}}} = - \frac{y}{\vert y \vert} \frac{\frac{dy}{d τ}}{{y}^{2} + 1} {=}^{{↓}^{equ . ( 132 )}} - \frac{{a}^{0}}{\vert {a}^{0} \vert} \frac{\frac{dy}{d τ}}{{y}^{2} + 1} ⇔ \frac{{a}^{0}}{\vert {a}^{0} \vert} \frac{\frac{d {f}^{˚}}{d τ}}{\sqrt{1 - {{f}^{˚}}^{2}}} = - \frac{\frac{dy}{d τ}}{{y}^{2} + 1} \qquad ( 135 )$$

Inserting the results of equ. (133) and (135) into equ. (131) yields

$${ρ}_{2} = \sqrt{{( \frac{{a}^{0}}{\vert {a}^{0} \vert} \frac{\frac{d {f}^{˚}}{d τ}}{\sqrt{1 - {{f}^{˚}}^{2}}} + {u}^{0} \sqrt{{u}^{2}} κ )}^{2} + {( {f}^{˚} τ \sqrt{{u}^{2}} )}^{2}} == \sqrt{{( - \frac{\frac{dy}{d τ}}{{y}^{2} + 1} + κ \sqrt{{u}^{2}} \sqrt{{u}^{2} + 1} )}^{2} + \frac{{τ}^{2} {u}^{2}}{1 + {y}^{2}}} = … \qquad ( 136 )$$

(in order to continue the transformation we need the following relationship:

$$- \frac{\frac{dy}{d τ}}{{y}^{2} + 1} + κ \sqrt{{u}^{2}} \sqrt{{u}^{2} + 1} = {=}^{{{f}^{˚} \neq 1 ⇔ \frac{d \sqrt{{u}^{2}}}{d τ} \neq 0 ⇔ y \neq 0}_{↓}} - \frac{\frac{dy}{d τ}}{{y}^{2} + 1} + \frac{1}{\frac{\sqrt{{u}^{2}}}{\frac{d \sqrt{{u}^{2}}}{d τ}} \frac{1}{κ {u}^{2} \sqrt{{u}^{2} + 1}} \frac{d \sqrt{{u}^{2}}}{d τ}} == - \frac{\frac{dy}{d τ}}{{y}^{2} + 1} + \frac{\frac{\frac{d \sqrt{{u}^{2}}}{d τ}}{\sqrt{{u}^{2}}}}{y} == \frac{1}{y} ( \frac{\frac{d \sqrt{{u}^{2}}}{d τ}}{\sqrt{{u}^{2}}} - \frac{y \frac{dy}{d τ}}{{y}^{2} + 1} ) = \frac{1}{y} \frac{d}{d τ} [ ln \sqrt{{u}^{2}} - \frac{1}{2} ln ( {y}^{2} + 1 ) ] == \frac{1}{2 y} \frac{d}{d τ} [ ln ( {u}^{2} ) - ln ( {y}^{2} + 1 ) ] = \frac{1}{2 y} \frac{d}{d τ} ( ln \frac{{u}^{2}}{{y}^{2} + 1} ) \qquad ( 137 )$$

now we can continue the transformation)

$$… = \begin{matrix}\sqrt{{[ \frac{1}{2 y} \frac{d}{d τ} ( ln \frac{{u}^{2}}{{y}^{2} + 1} ) ]}^{2} + {τ}^{2} \frac{{u}^{2}}{{y}^{2} + 1}}\end{matrix}$$

$$if {f}^{˚} \neq 1 ⇔ \frac{d \sqrt{{u}^{2}}}{d τ} \neq 0 ⇔ y \neq 0 .$$

Note that y is well defined only for [symbol] ≠0⇔u [symbol] a⇒a²≠0. If y is well defined, also the following relationship holds:

$$\frac{{y}^{2} + 1}{{u}^{2}} = \frac{\frac{{( {a}^{0} )}^{2}}{{( u \times a )}^{2}} + 1}{{u}^{2}} = \frac{{( {a}^{0} )}^{2} + {( u \times a )}^{2}}{{{u}^{2} ( u \times a )}^{2}} {{=}^{↓}}^{equ . ( 127 )} \frac{{a}^{2}}{{( u \times a )}^{2}} \qquad ( 138 )$$

Thus in total we get:

$${ρ}_{2} = \{ \begin{matrix}\sqrt{{u}^{2}} \sqrt{{κ}^{2} ( {u}^{2} + 1 ) + {τ}^{2}} & if {f}^{˚} = 1 ⇔ y = 0 ⇔ \frac{d \sqrt{{u}^{2}}}{d τ} = 0 \\ \sqrt{{[ \frac{1}{2 y} \frac{d}{d τ} ( ln \frac{{u}^{2}}{{y}^{2} + 1} ) ]}^{2} + {τ}^{2} \frac{{u}^{2}}{{y}^{2} + 1}} & if {f}^{˚} \neq 1 ⇔ y \neq 0 ⇔ \frac{d \sqrt{{u}^{2}}}{d τ} \neq 0\end{matrix}$$

This equation is replicated as equ. (76) in the description of the application.

Annex 26—Calculation of the third 4D-curvature ρ₃=ρ₃( [symbol] , τ, \sqrt{u²}) (second torsion, hyper-torsion, bi-torsion) in terms of the 3D-curvature [symbol] , the 3D torsion τ and the magnitude \sqrt{u²} of the three-dimensional spatial part u of the four-velocity

$$u = ( \begin{matrix}{u}^{0} \\ u\end{matrix} )$$

In the following D̅₂ is calculated from [symbol] ₂ and [symbol] according to equation (33) and the result is equated with D̅₂ as calculated in equ. (28):

$${}^{⋆} {}^{⋆} \overline{L} η = {L}^{⌣} η {R}^{⌣} η ⇒ {\overline{D}}_{2} = {{R}^{⌣}}^{T} {{D}^{⌣}}_{2} + {Ω}^{⌣} = {{=}^{↓}}^{equ . ( 102 ) , ( 108 )} {( \begin{matrix}1 & 0 & 0 \\ 0 & 〈 \pm 〉 \sqrt{1 - {{f}^{⌣}}^{2}} & - {f}^{⌣} \\ 0 & {f}^{⌣} & 〈 \pm 〉 \sqrt{1 - {{f}^{⌣}}^{2}}\end{matrix} )}^{T} {ρ}_{2} ( \begin{matrix}\begin{matrix}\frac{{a}^{0}}{\sqrt{{( u \times a )}^{2}}} {f}^{⌣} \\ - {f}^{⌣}\end{matrix} \\ 〈 \pm 〉 \sqrt{1 - {{f}^{⌣}}^{2}}\end{matrix} ) + {Ω}^{⌣} == {ρ}_{2} ( \begin{matrix}1 & 0 & 0 \\ 0 & 〈 \pm 〉 \sqrt{1 - {{f}^{⌣}}^{2}} & {f}^{⌣} \\ 0 & - {f}^{⌣} & 〈 \pm 〉 \sqrt{1 - {{f}^{⌣}}^{2}}\end{matrix} ) ( \begin{matrix}\begin{matrix}\frac{{a}^{0}}{\sqrt{{( u \times a )}^{2}}} {f}^{⌣} \\ - {f}^{⌣}\end{matrix} \\ 〈 \pm 〉 \sqrt{1 - {{f}^{⌣}}^{2}}\end{matrix} ) + {Ω}^{⌣} == {ρ}_{2} ( \begin{matrix}\begin{matrix}\frac{{a}^{0}}{\sqrt{{( u \times a )}^{2}}} {f}^{⌣} \\ - 〈 \pm 〉 {f}^{⌣} \sqrt{1 - {{f}^{⌣}}^{2}} + 〈 \pm 〉 {f}^{⌣} \sqrt{1 - {{f}^{⌣}}^{2}}\end{matrix} \\ {{f}^{⌣}}^{2} + 1 - {{f}^{⌣}}^{2}\end{matrix} ) + {Ω}^{⌣} == {ρ}_{2} ( \begin{matrix}\begin{matrix}\frac{{a}^{0}}{\sqrt{{( u \times a )}^{2}}} {f}^{⌣} \\ 0\end{matrix} \\ 1\end{matrix} ) + {Ω}^{⌣} {{=}^{↓}}^{equ . ( 105 ) and ( 106 )} = \{ \begin{matrix}( \begin{matrix}\begin{matrix}\frac{{ρ}_{2} {a}^{0}}{\sqrt{{( u \times a )}^{2}}} \\ 0\end{matrix} \\ {ρ}_{2}\end{matrix} ) & if \vert {f}^{⌣} \vert = 1 \\ ( \begin{matrix}\begin{matrix}\frac{{ρ}_{2} {a}^{0}}{\sqrt{{( u \times a )}^{2}}} {f}^{⌣} + \frac{\frac{d {f}^{⌣}}{d τ}}{〈 \pm 〉 \sqrt{1 - {{f}^{⌣}}^{2}}} \\ 0\end{matrix} \\ {ρ}_{2}\end{matrix} ) & if \vert {f}^{⌣} \vert \neq 1\end{matrix} \} = {\overline{D}}_{2} {{=}^{↓}}^{equ . ( 28 )} ( \begin{matrix}\begin{matrix}{ρ}_{3} \\ 0\end{matrix} \\ {ρ}_{2}\end{matrix} ) \qquad ( 139 )$$

As in equ. (128) one gets thus three equations, one for each component of D̅₂. The equations for the second and the third component produce merely true statements, but the equation for the first component is interesting and produces a new formula to calculate ρ₃

$$\begin{matrix}{ρ}_{3} = \{ \begin{matrix}\frac{{a}^{0}}{\sqrt{{( u \times a )}^{2}}} {ρ}_{2} & if \vert {f}^{⌣} \vert = 1 \\ \frac{{a}^{0}}{\sqrt{{( u \times a )}^{2}}} {ρ}_{2} {f}^{⌣} + \frac{\frac{d {f}^{⌣}}{d τ}}{〈 \pm 〉 \sqrt{1 - {{f}^{⌣}}^{2}}} & if \vert {f}^{⌣} \vert \neq 1\end{matrix}\end{matrix} \qquad ( 140 )$$

with [symbol] ± [symbol] being defined in equ. (103)/(51) and with [symbol] being defined in equ. (104).

In the following we express all elements of the above equation for ρ₃ in terms of 3D-curvature [symbol] , 3D-torsion τ and the magnitude \sqrt{u²} of the three-dimensional spatial part u of the four-velocity

$$u = ( \begin{matrix}{u}^{0} \\ u\end{matrix} ) .$$

Since [ρ₁ 0 V ρ₂=0]⇒ρ₃=0 the following calculations are restricted to [symbol] :

$${f}^{⌣} {=}^{{equ . ( 129 )}_{↓}} {f}^{˚} \frac{τ \sqrt{{u}^{2}}}{{ρ}_{2}} {=}^{{equ . ( 133 )}_{↓}} \frac{τ \sqrt{{u}^{2}}}{{ρ}_{2}} \frac{1}{\sqrt{{y}^{2} + 1}} \qquad ( 141 )$$

$$⇓$$

$$\vert {f}^{⌣} \vert = 1 {⇔}^{{↓}^{equ . ( 141 )}} {ρ}_{2} = \vert \frac{τ \sqrt{{u}^{2}}}{\sqrt{{y}^{2} + 1}} \vert \qquad ( 142 )$$

$${⇔}^{{↓}^{equ . ( 76 )}} [ y \neq 0 ∧ \frac{{y}^{2} + 1}{{u}^{2}} = const . ] \qquad ( 143 )$$

$${⇔}^{{↓}^{equ . ( 104 )}} \vert \begin{matrix}\begin{matrix}{\overline{N}}_{1} & {\overline{N}}_{2}\end{matrix} & {{N}^{⌣}}_{3}\end{matrix} \vert = 0 \qquad ( 144 )$$

Determination of [symbol] ± [symbol] from equ. (128) in case of

$${f}^{˚} \neq 1 {⇔}^{{↓}^{equ . ( 121 )}} y \neq 0 {⇔}^{{↓}^{equ . ( 132 )}} \frac{d \sqrt{{u}^{2}}}{d τ} \neq 0 and \vert {f}^{⌣} \vert \neq 1 : \frac{{a}^{0}}{\vert {a}^{0} \vert} \frac{\frac{d {f}^{˚}}{d τ}}{\sqrt{1 - {{f}^{˚}}^{2}}} + {u}^{0} \sqrt{{u}^{2} κ} = 〈 \pm 〉 {ρ}_{2} \sqrt{1 - {{f}^{⌣}}^{2}} {⇔}^{{↓}^{equ . ( 135 )}} - \frac{\frac{d y}{d τ}}{{y}^{2} + 1} + {u}^{0} \sqrt{{u}^{2} κ} = 〈 \pm 〉 {ρ}_{2} \sqrt{1 - {{f}^{⌣}}^{2}} ⇒ 〈 \pm 〉 1 = \frac{- \frac{\frac{dy}{d τ}}{1 + {y}^{2}} + κ \sqrt{{u}^{2}} \sqrt{{u}^{2} + 1}}{\vert - \frac{\frac{d y}{d τ}}{1 + {y}^{2}} + κ \sqrt{{u}^{2}} \sqrt{{u}^{2} + 1} \vert} {=}^{{↓}^{equ . ( 137 )}} \frac{\frac{1}{2 y} \frac{d}{d τ} ( ln \frac{{u}^{2}}{{y}^{2} + 1} )}{\vert \frac{1}{2 y} \frac{d}{d τ} ( ln \frac{{u}^{2}}{{y}^{2} + 1} ) \vert} \qquad ( 145 )$$

Determination of [symbol] ± [symbol] from equ. (128) in case of

$${f}^{˚} = 1 ⇔ y = 0 ⇔ \frac{d \sqrt{{u}^{2}}}{d τ} = 0 and \vert {f}^{⌣} \vert \neq 1 : {u}^{0} \sqrt{{u}^{2} κ} = 〈 \pm 〉 {ρ}_{2} \sqrt{1 - {{f}^{2}}^{⌣}} ⇒ 〈 \pm 〉 1 = \frac{{u}^{0} \sqrt{{u}^{2}} κ}{\vert {u}^{0} \sqrt{{u}^{2}} κ \vert} = 1$$

Further we need

$$\vert {f}^{⌣} \vert \neq 1 ⇒ \frac{\frac{d {f}^{⌣}}{d τ}}{\sqrt{1 - {{f}^{⌣}}^{2}}} = \frac{d}{d τ} arc sin {f}^{⌣} \qquad ( 146 )$$

$$and$$

$$\frac{{a}^{0}}{\sqrt{{( u \times a )}^{2}}} {ρ}_{2} {f}^{⌣} {=}^{{↓}^{equ . ( 129 )}} \frac{{a}^{0}}{\sqrt{{( u \times a )}^{2}}} {f τ}^{˚} \sqrt{{u}^{2}} {=}^{{↓}^{equ . ( 133 )}} \frac{{a}^{0}}{\sqrt{{( u \times a )}^{2}}} \frac{τ \sqrt{{u}^{2}}}{\sqrt{{y}^{2} + 1}} = {=}^{{↓}^{equ . ( 132 )}} y \frac{τ \sqrt{{u}^{2}}}{\sqrt{{y}^{2} + 1}}$$

The latter relationship is valid both for | [symbol] |≠1 and for | [symbol] |=1.

Now we insert all expressions in equ. (140). Four cases have to be distinguished:

$$\{ \vert {f}^{⌣} \vert \neq 1 ⇔ [ y = 0 ⋁ \frac{d}{d τ} ( \frac{{y}^{2} + 1}{{u}^{2}} ) \neq 0 ] ∧ {f}^{˚} \neq 1 ⇔ y \neq 0 ⇔ \frac{d \sqrt{{u}^{2}}}{d τ} \neq 0 \} ⇔ [ y \neq 0 ∧ \frac{d}{d τ} ( \frac{{y}^{2} + 1}{{u}^{2}} ) \neq 0 ] : {ρ}_{3} {=}^{{↓}^{equ . ( 140 ) , ( 146 ) , ( 141 ) , ( 1 \; 47 )}} 〈 \pm 〉 \frac{d}{d τ} arcsin ( \frac{1}{{ρ}_{2}} \frac{τ \sqrt{{u}^{2}}}{\sqrt{{y}^{2} + 1}} ) + y \frac{τ \sqrt{{u}^{2}}}{\sqrt{{y}^{2} + 1}} = {=}^{{↓}^{equ . ( 76 ) if y \neq 0}} 〈 \pm 〉 \frac{d}{d τ} arcsin ( \frac{1}{\sqrt{{[ \frac{1}{2 y} \frac{d}{d τ} ( ln \frac{{u}^{2}}{{y}^{2} + 1} ) ]}^{2} + {τ}^{2} \frac{{u}^{2}}{{y}^{2} + 1}}} \frac{τ \sqrt{{u}^{2}}}{\sqrt{{y}^{2} + 1}} ) ++ y \frac{τ \sqrt{{u}^{2}}}{\sqrt{{y}^{2} + 1}} = {{=}^{↓}}^{if τ \neq 0 , y \neq 0} 〈 \pm 〉 \frac{d}{d τ} arcsin ( \frac{\frac{τ}{\vert τ \vert}}{\sqrt{{[ \frac{1}{2 τ y} \frac{\sqrt{{y}^{2} + 1}}{\sqrt{{u}^{2}}} \frac{d}{d τ} ( ln \frac{{u}^{2}}{{y}^{2} + 1} ) ]}^{2} + 1}} ) + y \frac{τ \sqrt{{u}^{2}}}{\sqrt{{y}^{2} + 1}} = {=}^{{↓}^{if τ \neq 0 , y \neq 0}} 〈 \pm 〉 \frac{τ}{\vert τ \vert} \frac{d}{d τ} arcsin ( \frac{1}{\sqrt{{[ \frac{1}{2 τ y} \frac{\sqrt{{y}^{2} + 1}}{\sqrt{{u}^{2}}} \frac{d}{d τ} ( ln \frac{{u}^{2}}{{y}^{2} + 1} ) ]}^{2} + 1}} ) + y \frac{τ \sqrt{{u}^{2}}}{\sqrt{{y}^{2} + 1}} = … \qquad Case 1$$

To continue the transformation we need the following relationships:

$$\frac{d}{d x} arcsin \frac{1}{\sqrt{1 + {x}^{2}}} = \frac{\frac{- 2 x}{2 {\sqrt{1 + {x}^{2}}}^{3}}}{\sqrt{1 - {( \frac{1}{\sqrt{1 + {x}^{2}}} )}^{2}}} == \frac{\frac{- x}{{\sqrt{1 + {x}^{2}}}^{3}}}{\sqrt{1 - \frac{1}{1 + {x}^{2}}}} = \frac{\frac{- x}{{\sqrt{1 + {x}^{2}}}^{3}}}{\sqrt{\frac{{x}^{2}}{1 + {x}^{2}}}} = \frac{\frac{- x}{{\sqrt{1 + {x}^{2}}}^{3}}}{\frac{\vert x \vert}{\sqrt{1 + {x}^{2}}}} == - \frac{x}{\vert x \vert} \frac{1}{1 + {x}^{2}} = - \frac{x}{\vert x \vert} \frac{d}{d x} arctan ( x ) \frac{\frac{1}{2 τ y} \frac{\sqrt{{y}^{2} + 1}}{\sqrt{{u}^{2}}} \frac{d}{d τ} ( ln \frac{{u}^{2}}{{y}^{2} + 1} )}{\vert \frac{1}{2 τ y} \frac{\sqrt{{y}^{2} + 1}}{\sqrt{{u}^{2}}} \frac{d}{d τ} ( ln \frac{{u}^{2}}{{y}^{2} + 1} ) \vert} = \frac{τ}{\vert τ \vert} \frac{\frac{1}{2 y} \frac{d}{d τ} ( ln \frac{{u}^{2}}{{y}^{2} + 1} )}{\vert \frac{1}{2 y} \frac{d}{d τ} ( ln \frac{{u}^{2}}{{y}^{2} + 1} ) \vert} {=}^{{↓}^{equ . ( 145 )}} 〈 \pm 〉 \frac{τ}{\vert τ \vert} \qquad ( 148 )$$

Now we can continue the transformation:

$$… = ( 〈 \pm 〉 \frac{τ}{\vert τ \vert} ) \cdot ( 〈 \pm 〉 \frac{τ}{\vert τ \vert} ) \frac{\frac{d}{d τ} [ \frac{1}{τ y} \frac{d}{d τ} ( \frac{\sqrt{{y}^{2} + 1}}{\sqrt{{u}^{2}}} ) ]}{1 + {[ \frac{1}{τ y} \frac{d}{d τ} ( \frac{\sqrt{{y}^{2} + 1}}{\sqrt{{u}^{2}}} ) ]}^{2}} + y \frac{τ \sqrt{{u}^{2}}}{\sqrt{{y}^{2} + 1}} =$$

$$= \frac{\frac{d}{d τ} [ \frac{1}{τ y} \frac{d}{d τ} ( \frac{\sqrt{{y}^{2} + 1}}{\sqrt{{u}^{2}}} ) ]}{1 + {[ \frac{1}{τ y} \frac{d}{d τ} ( \frac{\sqrt{{y}^{2} + 1}}{\sqrt{{u}^{2}}} ) ]}^{2}} + \frac{1}{\frac{1}{τ y} \frac{d}{d τ} ( \frac{\sqrt{{y}^{2} + 1}}{\sqrt{{u}^{2}}} )} \frac{\frac{d}{d τ} ( \frac{\sqrt{{y}^{2} + 1}}{\sqrt{{u}^{2}}} )}{\frac{\sqrt{{y}^{2} + 1}}{\sqrt{{u}^{2}}}} =$$

$$= \frac{1}{\frac{1}{τ y} \frac{d}{d τ} ( \frac{\sqrt{{y}^{2} + 1}}{\sqrt{{u}^{2}}} )} \{ \frac{\frac{1}{τ y} \frac{d}{d τ} ( \frac{\sqrt{{y}^{2} + 1}}{\sqrt{{u}^{2}}} )}{1 + {[ \frac{1}{τ y} \frac{d}{d τ} ( \frac{\sqrt{{y}^{2} + 1}}{\sqrt{{u}^{2}}} ) ]}^{2}} \frac{d}{d τ} [ \frac{1}{τ y} \frac{d}{d τ} ( \frac{\sqrt{{y}^{2} + 1}}{\sqrt{{u}^{2}}} ) ] +$$

$$+ \frac{\frac{d}{d τ} ( \frac{\sqrt{{y}^{2} + 1}}{\sqrt{{u}^{2}}} )}{\frac{\sqrt{{y}^{2} + 1}}{\sqrt{{u}^{2}}}} \} =$$

$$= \frac{1}{\frac{1}{τ y} \frac{d}{d τ} ( \frac{\sqrt{{y}^{2} + 1}}{\sqrt{{u}^{2}}} )} \{ \frac{1}{2} \frac{d}{d τ} ln 〈 1 + {[ \frac{1}{τ y} \frac{d}{d τ} ( \frac{\sqrt{{y}^{2} + 1}}{\sqrt{{u}^{2}}} ) ]}^{2} 〉 +$$

$$+ \frac{d}{d τ} ln ( \frac{\sqrt{{y}^{2} + 1}}{\sqrt{{u}^{2}}} ) \} =$$

$$= \frac{1}{\frac{1}{τ y} \frac{d}{d τ} ( \frac{\sqrt{{y}^{2} + 1}}{\sqrt{{u}^{2}}} )} \{ \frac{d}{d τ} ln \sqrt{1 + {[ \frac{1}{τ y} \frac{d}{d τ} ( \frac{\sqrt{{y}^{2} + 1}}{\sqrt{{u}^{2}}} ) ]}^{2}} +$$

$$+ \frac{d}{d τ} ln ( \frac{\sqrt{{y}^{2} + 1}}{\sqrt{{u}^{2}}} ) \} =$$

$$= \frac{1}{\frac{1}{τ y} \frac{d}{d τ} ( \frac{\sqrt{{y}^{2} + 1}}{\sqrt{{u}^{2}}} )} \frac{d}{d τ} \{ ln \sqrt{1 + {[ \frac{1}{τ y} \frac{d}{d τ} ( \frac{\sqrt{{y}^{2} + 1}}{\sqrt{{u}^{2}}} ) ]}^{2}} +$$

$$+ ln ( \frac{\sqrt{{y}^{2} + 1}}{\sqrt{{u}^{2}}} ) \} =$$

$$= \frac{1}{\frac{1}{τ y} \frac{d}{d τ} ( \frac{\sqrt{{y}^{2} + 1}}{\sqrt{{u}^{2}}} )} \frac{d}{d τ} ln \{ \sqrt{1 + {[ \frac{1}{τ y} \frac{d}{d τ} ( \frac{\sqrt{{y}^{2} + 1}}{\sqrt{{u}^{2}}} ) ]}^{2}} \cdot ( \frac{\sqrt{{y}^{2} + 1}}{\sqrt{{u}^{2}}} ) \}$$

$$\{ \vert {f}^{⌣} \vert \neq 1 ⇔ [ \text{} y = 0 ∨ \frac{d}{d τ} ( \frac{{y}^{2} + 1}{{u}^{2}} ) \neq 0 ] ∧ [ \mathring{f} = 1 ⇔ y = 0 ⇔ \frac{d \sqrt{{u}^{2}}}{d τ} = 0 ] \} \\ ⇔ y = 0 \\ {ρ}_{3} {{=}^{↓}}^{equ . ( 140 )} \frac{{{f}^{⌣}}^{′}}{〈 \pm 〉 \sqrt{1 - {{f}^{⌣}}^{2}}} + {\underbrace{\frac{{a}^{0}}{\sqrt{{( u \times a )}^{2}}}}}_{y ( equ . ( 132 ) )} {ρ}_{2} {f}^{⌣} = y = 0 , {{equ . ( 141 ) , ( 146 )}_{↓}}_{=} 〈 \pm 〉 \frac{d}{d τ} arcsin ( \frac{1}{{ρ}_{2}} \frac{τ \sqrt{{u}^{2}}}{\sqrt{{y}^{2} + 1}} ) = {{=}^{↓}}^{equ . ( 76 )} \frac{d}{d τ} arcsin ( \frac{τ \sqrt{{u}^{2}}}{\sqrt{{u}^{2}} \sqrt{{κ}^{2} ( {u}^{2} + 1 ) + {τ}^{2}}} ) = \frac{d}{d τ} arcsin ( \frac{τ}{\sqrt{{κ}^{2} ( {u}^{2} + 1 ) + {τ}^{2}}} ) = {{=}^{↓}}^{only if τ \neq 0} \frac{d}{d τ} arcsin ( \text{} \frac{1}{\sqrt{\frac{{κ}^{2}}{{τ}^{2}} ( {u}^{2} + 1 ) + 1}} ) = {{=}^{↓}}^{equ . ( 148 )} - \frac{d}{d τ} arctan ( \frac{κ}{\vert τ \vert} \sqrt{{u}^{2} + 1} ) = - \frac{d}{d τ} arctan ( \frac{κ}{\vert τ \vert} {u}^{0} )$$

Case 3

$$\{ \vert {f}^{⌣} \vert = 1 ⇔ [ y \neq 0 ∧ \frac{d}{d τ} ( \frac{{y}^{2} + 1}{{u}^{2}} ) = 0 ] ∧ \mathring{f} \neq 1 ⇔ y \neq 0 \} \\ ⇔ y \neq 0 ∧ \frac{d}{d τ} ( \frac{{y}^{2} + 1}{{u}^{2}} ) = 0 \\ {ρ}_{3} {{=}^{↓}}^{equ . ( 140 )} \frac{{a}^{0}}{\sqrt{{( u \times a )}^{2}}} {ρ}_{2} {f}^{⌣} {{=}^{↓}}^{equ . ( 147 )} y \frac{τ \sqrt{{u}^{2}}}{\sqrt{{y}^{2} + 1}}$$

Case 4

$$\{ \vert {f}^{⌣} \vert = 1 ⇔ [ y \neq 0 ∧ \frac{d}{d τ} ( \frac{{y}^{2} + 1}{{u}^{2}} ) = 0 ] ∧ \mathring{f} = 1 ⇔ y = 0 \} ⇔ y \neq 0 ∧ y = 0 :$$

not possible

In total: If ρ₂=0 or τ=0, then ρ₃=0. If ρ₂≠0 ∧τ≠0 (⇒ [symbol] ≠0 ∧\sqrt{u²}≠0), then

$${ρ}_{3} = \{ \begin{matrix}\frac{1}{\frac{1}{τ y} \frac{d}{d τ} \sqrt{( \frac{{y}^{2} + 1}{{u}^{2}} )}} . & \\ \cdot \frac{d}{d τ} ln \{ \sqrt{1 + {[ \frac{1}{τ y} \frac{d}{d τ} ( \frac{\sqrt{{y}^{2} + 1}}{\sqrt{{u}^{2}}} ) ]}^{2}} \cdot ( \frac{\sqrt{{y}^{2} + 1}}{\sqrt{{u}^{2}}} ) \} & if y \neq 0 ∧ \frac{d}{d τ} ( \frac{{y}^{2} + 1}{{u}^{2}} ) \neq 0 \\ y \frac{τ \sqrt{{u}^{2}}}{\sqrt{{y}^{2} + 1}} & if y \neq 0 ∧ \frac{d}{d τ} ( \frac{{y}^{2} + 1}{{u}^{2}} ) = 0 \\ - \frac{d}{d τ} arctan ( \frac{κ}{\vert τ \vert} \sqrt{{u}^{2} + 1} ) & if y = 0\end{matrix}$$

This equation is replicated as equ. (77) in the description of the application.

Annex 27-3D-condition for ρ₂=0

For ρ₂=0 both summands of the radicand in any of the alternatives of equ. (76) have to be zero, i.e. τ=0 and either [symbol] =0 or

$$\frac{{y}^{2} + 1}{{u}^{2}} = \frac{{( \frac{1}{} \frac{1}{{u}^{2} \sqrt{{u}^{2} + 1}} \frac{d \sqrt{{u}^{2}}}{d τ} )}^{2} + 1}{{u}^{2}} = c = const . \\ ⇔ {cu}^{2} - 1 = {( \frac{1}{} \frac{1}{{u}^{2} \sqrt{{u}^{2} + 1}} \frac{d \sqrt{{u}^{2}}}{d τ} )}^{2} ⇒ c \geq \frac{1}{{u}^{2}} ⇔ \sqrt{c {u}^{2} - 1} = \vert \frac{1}{} \frac{1}{{u}^{2} \sqrt{{u}^{2} + 1}} \frac{d \sqrt{{u}^{2}}}{d τ} \vert ⇔ \sqrt{c {u}^{2} - 1} = \frac{1}{} \frac{1}{{u}^{2} \sqrt{{u}^{2} + 1}} \vert \frac{d \sqrt{{u}^{2}}}{d τ} \vert ⇔ {u}^{2} \sqrt{{u}^{2} + 1} \sqrt{c {u}^{2} - 1} = \frac{1}{} \vert \frac{d \sqrt{{u}^{2}}}{d τ} \vert ⇔ = \frac{\vert \frac{d \sqrt{{u}^{2}}}{d τ} \vert}{{u}^{2} \sqrt{{u}^{2} + 1} \sqrt{c {u}^{2} - 1}} \geq 0 ⇔ = \vert \frac{\frac{d \sqrt{{u}^{2}}}{d τ}}{{u}^{2} \sqrt{{u}^{2} + 1} \sqrt{c {u}^{2} - 1}} \vert$$

This equation corresponds to equ. (79) in the description.

Because of equ. (88)

$$= \frac{\sqrt{{( u \times a )}^{2}}}{{\sqrt{{u}^{2}}}^{3}} = \frac{\sqrt{{( \frac{d \hat{u}}{d τ} )}^{2}}}{\sqrt{{u}^{2}}}$$

equ. (79) is equivalent to

$$\frac{\sqrt{{( \frac{d \hat{u}}{d τ} )}^{2}}}{\sqrt{{u}^{2}}} = \vert \frac{\frac{d \sqrt{{u}^{2}}}{d τ}}{{u}^{2} \sqrt{{u}^{2} + 1} \sqrt{c {u}^{2} - 1}} \vert ⇔ \sqrt{{( \frac{d \hat{u}}{d τ} )}^{2}} = \frac{\frac{d \sqrt{{u}^{2}}}{d τ}}{\vert \frac{d \sqrt{{u}^{2}}}{d τ} \vert} \frac{\frac{d \sqrt{{u}^{2}}}{d τ}}{\sqrt{{u}^{2}} \sqrt{{u}^{2} + 1} \sqrt{c {u}^{2} - 1}}$$

The right hand side can be integrated:

$$\frac{d}{d x} arctan \sqrt{\frac{c {x}^{2} - 1}{{x}^{2} + 1}} == \frac{1}{1 + \frac{c {x}^{2} - 1}{{x}^{2} + 1}} \frac{1}{2 \sqrt{\frac{c {x}^{2} - 1}{{x}^{2} + 1}}} \frac{2 c x ( {x}^{2} + 1 ) - 2 x ( c {x}^{2} - 1 )}{{( {x}^{2} + 1 )}^{2}} == \frac{1}{{x}^{2} + 1 + c {x}^{2} - 1} \frac{1}{\sqrt{\frac{c {x}^{2} - 1}{{x}^{2} + 1}}} \frac{c x + x}{{x}^{2} + 1} == \frac{1}{{x}^{2} + c {x}^{2}} \frac{1}{\sqrt{\frac{c {x}^{2} - 1}{{x}^{2} + 1}}} \frac{c x + x}{{x}^{2} + 1} == \frac{1}{x} \frac{1}{\sqrt{\frac{c {x}^{2} - 1}{{x}^{2} + 1}}} \frac{1}{{x}^{2} + 1} = \frac{1}{x} \frac{1}{\sqrt{c {x}^{2} - 1}} \frac{1}{\sqrt{{x}^{2} + 1}} Thus ⇔ \int \sqrt{{( \frac{d \hat{u}}{d τ} )}^{2}} d τ = \frac{\frac{d \sqrt{{u}^{2}}}{d τ}}{\vert \frac{d \sqrt{{u}^{2}}}{d τ} \vert} arctan \sqrt{\frac{c {u}^{2} - 1}{{u}^{2} + 1}} + {c}^{′} ⇔ tan ( \int \sqrt{{( \frac{d \hat{u}}{d τ} )}^{2}} d τ - {c}^{′} ) = \frac{\frac{d \sqrt{{u}^{2}}}{d τ}}{\vert \frac{d \sqrt{{u}^{2}}}{d τ} \vert} \sqrt{\frac{c {u}^{2} - 1}{{u}^{2} + 1}} ⇔ {tan}^{2} ( {\underbrace{\int \sqrt{{( \frac{d \hat{u}}{d τ} )}^{2}} d τ - {c}^{′}}}_{:= σ} ) = \frac{c {u}^{2} - 1}{{u}^{2} + 1} ⇔ ( {u}^{2} + 1 ) {tan}^{2} σ - ( c {u}^{2} - 1 ) = 0 ⇔ {u}^{2} ( {tan}^{2} σ - c ) + {tan}^{2} σ + 1 = 0 ⇔ {u}^{2} = \frac{{tan}^{2} σ + 1}{c - {tan}^{2} σ} = \frac{{tan}^{2} σ + 1}{c + 1 - ( 1 + {tan}^{2} σ )} == \frac{1}{\frac{c + 1}{{tan}^{2} σ + 1} - 1} = \frac{1}{( c + 1 ) {cos}^{2} σ - 1} == {[ ( c + 1 ) {cos}^{2} ( \int \sqrt{{( \frac{d \hat{u}}{d τ} )}^{2}} d τ - {c}^{′} ) - 1 ]}^{- 1}$$

This equation corresponds to equ. (80) in the description.

Annex 28—Construction of a general curve with ρ₂=0

As stated in the paragraph below equ. (31) ρ₂=0 applies if and only if the timelike worldline is lying in a two-dimensional linear subspace spanned by two basis four-vectors. Using these two basis four-vectors it is always possible to construct another four-vector G lying within this subspace with the following properties:

$$G = ( \begin{matrix}0 \\ G\end{matrix} ) with G \cdot G = 1 ⇔ {G}^{2} = 1$$

It is further possible using the Gram-Schmidt orthonormalisation procedure to construct another four-vector B lying within this subspace with the following properties:

$$B = ( \begin{matrix}{B}^{0} \\ B\end{matrix} ) with \vert B \cdot B \vert = 1 and G \cdot B = 0 ⇔ G \cdot B = 0$$

One can thus make the following general ansatz for the four-velocity u:

u=βB+γG

### From equ. (3)

$${u}^{2} = {β}^{2} ( B \cdot B ) + {γ}^{2} ( G \cdot G ) = {β}^{2} ( B \cdot B ) + {γ}^{2} = - 1 ⇔ {β}^{2} = - \frac{1 + {γ}^{2}}{B \cdot B}$$

then follows

$$⇒ {B}^{2} < 0 {{⇒}^{↓}}^{\vert B \cdot B \vert = 1} B \cdot B = - 1 {{⇔}^{↓}}^{{B}^{0} > 0} B = ( \begin{matrix}\sqrt{1 + {B}^{2}} \\ B\end{matrix} )$$

because a ([2, p. 35 and p. 16]) and thus also B must be future-directed, i.e. u⁰>0⇒B⁰>0. Thus for any two-dimensional linear subspace, which can acco-modate a timelike worldline, one can find two basis four-vectors B, G with the above properties. Thus in the most general case the four-velocity of a timelike worldline with ρ₂=0 can always be brought in the following form:

$$u = \pm \sqrt{1 + {γ}^{2}} ( \begin{matrix}\sqrt{1 + {B}^{2}} \\ B\end{matrix} ) + γ ( \begin{matrix}0 \\ G\end{matrix} ) with {G}^{2} = 1 and G \cdot B = 0$$

This form is replicated in the description of the application as equ. (81).

Using this form we calculate in the following the relation [symbol] (\sqrt{u²}):

$$a = \frac{d u}{d τ} = [ \pm \frac{γ}{\sqrt{1 + {γ}^{2}}} ( \begin{matrix}\sqrt{1 + {B}^{2}} \\ B\end{matrix} ) + ( \begin{matrix}0 \\ G\end{matrix} ) ] \frac{d γ}{d τ} u \times a == ( \pm \sqrt{1 + {γ}^{2}} B + γ G ) \times ( \pm \frac{γ \frac{d γ}{d τ}}{\sqrt{1 + {γ}^{2}}} B + \frac{d γ}{d τ} G ) == γG \times ( \pm \frac{γ \frac{d γ}{d τ}}{\sqrt{1 + {γ}^{2}}} B ) + ( \pm \sqrt{1 + {γ}^{2}} B ) \times \frac{d γ}{d τ} G == \pm \frac{{γ}^{2} \frac{d γ}{d τ}}{\sqrt{1 + {γ}^{2}}} G \times B \pm \frac{d γ}{d τ} \sqrt{1 + {γ}^{2}} B \times G == \pm ( \frac{{γ}^{2}}{\sqrt{1 + {γ}^{2}}} - \sqrt{1 + {γ}^{2}} ) \frac{d γ}{d τ} G \times B == ∓ \frac{\frac{d γ}{d τ}}{\sqrt{1 + {γ}^{2}}} G \times B \\ κ {{=}^{↓}}^{equ . ( 87 )} \frac{\sqrt{{( u \times a )}^{2}}}{{\sqrt{{u}^{2}}}^{3}} = \frac{\sqrt{{( G \times B )}^{2}}}{\sqrt{1 + {γ}^{2}} {\sqrt{{( \pm \sqrt{1 + {γ}^{2}} B + γ G )}^{2}}}^{3}} \vert \frac{d γ}{d τ} \vert == \frac{\sqrt{{( G \times B )}^{2}}}{\sqrt{1 + {γ}^{2}} {( \pm \sqrt{1 + {γ}^{2}} B + γ G )}^{2} \sqrt{{( \pm \sqrt{1 + {γ}^{2}} B + γ G )}^{2}}} \vert \frac{d γ}{d τ} \vert \frac{d \sqrt{{u}^{2}}}{d τ} = \frac{( \pm \sqrt{1 + {γ}^{2}} B + γ G ) ( \pm \frac{γ \frac{d γ}{d τ}}{\sqrt{1 + {γ}^{2}}} B + \frac{d γ}{d τ} G )}{\sqrt{{( \pm \sqrt{1 + {γ}^{2}} B + γ G )}^{2}}} = = \frac{d γ}{d τ} \frac{( \pm \sqrt{1 + {γ}^{2}} B + γ G ) ( \pm \frac{γ}{\sqrt{1 + {γ}^{2}}} B + G )}{\sqrt{{( \pm \sqrt{1 + {γ}^{2}} B + γ G )}^{2}}} == \frac{d γ}{d τ} \frac{( \pm \sqrt{1 + {γ}^{2}} B + γ G ) \cdot ( \pm γ B + \sqrt{1 + {γ}^{2}} G )}{\sqrt{1 + {γ}^{2}} \sqrt{{( \pm \sqrt{1 + {γ}^{2}} B + γ G )}^{2}}} ⇒ κ = \frac{\sqrt{{( G \times B )}^{2}}}{\sqrt{1 + {γ}^{2}} {( \pm \sqrt{1 + {γ}^{2}} B + γ G )}^{2} \sqrt{{( \pm \sqrt{1 + {γ}^{2}} B + γ G )}^{2}}} \vert \frac{d γ}{d τ} \vert == \frac{\sqrt{{( G \times B )}^{2}} \vert \frac{d \sqrt{{u}^{2}}}{d τ} \vert}{{( \pm \sqrt{1 + {γ}^{2}} B + γ G )}^{2} \vert ( \pm \sqrt{1 + {γ}^{2}} B + γ G ) \cdot ( \pm γ B + \sqrt{1 + {γ}^{2}} G ) \vert} == \frac{\sqrt{{( G \times B )}^{2}} \vert \frac{d \sqrt{{u}^{2}}}{d τ} \vert}{{u}^{2} \vert ( \pm \sqrt{1 + {γ}^{2}} B + γ G ) \cdot ( \pm γ B + \sqrt{1 + {γ}^{2}} G ) \vert} = {{=}^{↓}}^{equ . ( 81 )} \frac{\sqrt{{B}^{2}} \vert \frac{d . \sqrt{{u}^{2}}}{d τ} \vert}{{u}^{2} \vert {\underbrace{( \pm \sqrt{1 + {γ}^{2}} B + γG ) \cdot ( \pm γ B + \sqrt{1 + {γ}^{2}} G )}}_{f ( {u}^{2} )} \vert} \\ {u}^{2} = {( \pm \sqrt{1 + {γ}^{2}} B + γ G )}^{2} {{=}^{↓}}^{equ . ( 81 )} ( 1 + {γ}^{2} ) {B}^{2} + {γ}^{2} ⇔ \frac{{u}^{2} - {B}^{2}}{{B}^{2} + 1} = {γ}^{2} f ( {u}^{2} ) = ( \pm \sqrt{1 + {γ}^{2}} B + γ G ) \cdot ( \pm γ B + \sqrt{1 + {γ}^{2}} G ) == γ \sqrt{1 + {γ}^{2}} {B}^{2} \pm ( 1 + 2 {γ}^{2} ) B \cdot G + γ \sqrt{1 + {γ}^{2}} {G}^{2} == γ \sqrt{1 + {γ}^{2}} {B}^{2} + γ \sqrt{1 + {γ}^{2}} = γ \sqrt{1 + {γ}^{2}} ( {B}^{2} + 1 ) ⇒ f ( {u}^{2} ) = \pm \sqrt{\frac{{u}^{2} - {B}^{2}}{{B}^{2} + 1}} \sqrt{1 + \frac{{u}^{2} - {B}^{2}}{{B}^{2} + 1}} ( {B}^{2} + 1 ) == \pm \sqrt{{u}^{2} - {B}^{2}} \sqrt{{B}^{2} + 1 + {u}^{2} - {B}^{2}} == \pm \sqrt{{u}^{2} - {B}^{2}} \sqrt{1 + {u}^{2}} = \pm \sqrt{{B}^{2}} \sqrt{\frac{{u}^{2}}{{B}^{2}} - 1} \sqrt{1 + {u}^{2}} ⇒ κ = \frac{\sqrt{{B}^{2}} \vert \frac{d \sqrt{{u}^{2}}}{d τ} \vert}{{u}^{2} \vert f ( {u}^{2} ) \vert} = \frac{\sqrt{{B}^{2}} \vert \frac{d \sqrt{{u}^{2}}}{d τ} \vert}{{u}^{2} \sqrt{{B}^{2}} \sqrt{\frac{{u}^{2}}{{B}^{2}} - 1} \sqrt{1 + {u}^{2}}} == \frac{\vert \frac{d \sqrt{{u}^{2}}}{d τ} \vert}{{u}^{2} \sqrt{1 + {u}^{2}} \sqrt{\frac{{u}^{2}}{{B}^{2}} - 1}}$$

This result corresponds to equ. (79) in the description

$$κ = \vert \frac{\frac{d \sqrt{{u}^{2}}}{d τ}}{{u}^{2} \sqrt{{u}^{2} + 1} \sqrt{c {u}^{2} - 1}} \vert \geq 0 \\ with \\ c = \frac{1}{{B}^{2}} = \frac{1}{{( G \times B )}^{2}} \qquad ( 149 )$$

Annex 29—Circular movement with β₂=0

The three-dimensional spatial part r(τ) of the worldline

$$r = ( \begin{matrix}{r}^{0} ( τ ) \\ r ( τ )\end{matrix} )$$

should have the following form:

r(τ)=R sin(β(τ))B+R cos(β(τ))G

where as in equ. (81) G²=1∧G·B=0, but now additionally

$${B}^{2} = 1 ⇒ c {=}^{{↓}^{equ . ( 149 )}} \frac{1}{{B}^{2}} = \frac{1}{{( G \times B )}^{2}} = 1 \qquad ( 150 )$$

$$Thus$$

$$u = R \frac{d β}{{d τ}_{\underbrace{\pm \sqrt{{u}^{2}}}}} {\underbrace{( cos β B - sin β G )}}_{\hat{u}} \qquad ( 151 )$$

where we have again removed the explicit dependence from proper time τ to improve the readability.

From equ. (81) one can derive

$${u}^{2} = ( 1 + {γ}^{2} ) {B}^{2} + {γ}^{2} {=}^{{↓}^{{B}^{2} = 1}} 1 + 2 {γ}^{2} \qquad ( 152 )$$

$$\hat{u} = \frac{1}{\sqrt{( 1 + {γ}^{2} ) {B}^{2} + {γ}^{2}}} [ ( \pm \sqrt{1 + {γ}^{2}} ) B + γ G ] = {=}^{{↓}^{{B}^{2} = 1}} \frac{1}{\sqrt{1 + 2 {γ}^{2}}} [ ( \pm \sqrt{1 + {γ}^{2}} ) B + γ G ]$$

Comparing this with equ. (151) we get

$$- sin β = \frac{γ}{\sqrt{1 + 2 {γ}^{2}}}$$

$$⇔ {sin}^{2} β = \frac{{γ}^{2}}{1 + 2 {γ}^{2}}$$

$$⇔ ( 1 + 2 {γ}^{2} ) {sin}^{2} β - {γ}^{2} = 0$$

$$⇔ {γ}^{2} ( 2 {sin}^{2} β - 1 ) + {sin}^{2} β = 0$$

$$⇔ {γ}^{2} = \frac{{sin}^{2} β}{1 - 2 {sin}^{2} β}$$

Inserting this result in equ. (152) yields

$${u}^{2} = 1 + 2 {γ}^{2} = 1 + \frac{2 {sin}^{2} β}{1 - 2 {sin}^{2} β} = \frac{1}{1 - 2 {sin}^{2} β}$$

Comparing this with the result for \sqrt{u²} in equ. (151) one gets

$${( R \frac{d β}{d τ} )}^{2} = \frac{1}{1 - 2 {sin}^{2} β} \qquad ( 153 )$$

$$⇔ \sqrt{1 - 2 {sin}^{2} β} \frac{d β}{d τ} = \pm \frac{1}{R} \qquad ( 154 )$$

This condition was derived without any reference to equ. (79) or (80), but it is identical to equ. (80) as shown in the following. From equ. (151) one can derive

$$\sqrt{{( \frac{d \hat{u}}{d τ} )}^{2}} = \vert \frac{d β}{d τ} \vert \qquad ( 155 )$$

$$⇔ \int \sqrt{{( \frac{d \hat{u}}{d τ} )}^{2}} d τ = \pm β + constant to be combined with {c}^{′}$$

Inserting this in equ. (80) yields

$${( R \frac{d β}{d τ} )}^{2} {=}^{{↓}^{equ . ( 151 )}} {u}^{2} = {[ ( c + 1 ) {cos}^{2} ( \int \sqrt{{( \frac{d \hat{u}}{d τ} )}^{2}} d τ - {c}^{′} ) - 1 ]}^{- 1} = {=}^{{↓}^{equ . ( 150 ) , ( 155 )}} \frac{1}{2 {cos}^{2} ( \pm β - {c}^{′} ) - 1} = \frac{1}{2 [ 1 - {sin}^{2} ( \pm β - {c}^{′} ) ] - 1} == \frac{1}{1 - 2 {sin}^{2} ( \pm β - {c}^{′} )}$$

which is because of sin²(−β−c′)=sin²(β+c′) identical to equ. (153) apart from the phase constant c′, which was chosen to be 0 in equ. (153).

Equ. (154) can be resolved for #. In the following we denote an incomplete elliptic integral of the second kind in Legendre form for the parameter m as usual with

$$E ( ϕ , m ) = {\int }_{0}^{ϕ} \sqrt{1 - m {sin}^{2} θ} d θ$$

Note that m=2 is an unusually large parameter for an elliptic integral of the second kind and limits the interval of ϕ, for which the integral is real, to [−π/2, π/2]. Integrating equ. (154) yields thus

$$E ( β ( τ ) , 2 ) = \pm \frac{1}{R} τ + {c}^{″}$$

$$⇔ β ( τ ) = {E}^{〈 - 1 〉} ( \pm \frac{1}{R} τ + {c}^{″} , 2 )$$

with c″ being an arbitrary constant and with [symbol] (x, m) being the inversion of E(ϕ, m).

[symbol]

The complete worldline can be written

$$\begin{matrix}r ( τ ) = ( \begin{matrix}{r}^{0} ( τ ) \\ r ( τ )\end{matrix} ) \\ = ( \begin{matrix}\int \sqrt{{( R \frac{d β}{d τ} )}^{2} + 1} d τ \\ R sin ( β ( τ ) ) B + R cos ( β ( τ ) ) G\end{matrix} ) = \\ = \int \sqrt{1 + {γ ( τ )}^{2}} ( \begin{matrix}\sqrt{2} \\ B\end{matrix} ) + γ ( τ ) ( \begin{matrix}0 \\ G\end{matrix} ) d τ\end{matrix}$$

This equation is replicated as equ. (82) in the description.

Annex 30—3D-condition for ρ₃=0

Having regard to equ. (77) the condition ρ₃=0 yields in case of y=0:

$$\frac{\vert τ \vert}{} \sqrt{{u}^{2} + 1} = c = const . \qquad ( 156 )$$

The condition ρ₃=0 in equ. (77) has no solution in case of

$$y \neq 0 ∧ \frac{d}{d τ} ( \frac{{y}^{2} + 1}{{u}^{2}} ) = 0 ,$$

because of y≠0, τ≠0 and \sqrt{u²}≠0, with the last inequal-ity being implied by

$$y \neq 0 ⇔ \frac{d \sqrt{{u}^{2}}}{d τ} \neq 0.$$

Applying condition ρ₃=0 to equ. (77) yields the following in case of

$$y \neq 0 ∧ \frac{d}{d τ} ( \frac{{y}^{2} + 1}{{u}^{2}} ) \neq 0 : \qquad ( 157 )$$

$$\{ 1 + {[ \frac{1}{τ y} \frac{d}{d τ} ( \frac{\sqrt{{y}^{2} + 1}}{\sqrt{{u}^{2}}} ) ]}^{2} \} \cdot {( \frac{\sqrt{{y}^{2} + 1}}{\sqrt{{u}^{2}}} )}^{2} = c = const .$$

$$⇔ {( \frac{\sqrt{{y}^{2} + 1}}{\sqrt{{u}^{2}}} )}^{2} + {[ \frac{1}{τ y} \frac{\sqrt{{y}^{2} + 1}}{\sqrt{{u}^{2}}} \frac{d}{d τ} ( \frac{\sqrt{{y}^{2} + 1}}{\sqrt{{u}^{2}}} ) ]}^{2} = c$$

$$⇔ {( \frac{\sqrt{{y}^{2} + 1}}{\sqrt{{u}^{2}}} )}^{2} + {\{ \frac{1}{2} \frac{1}{τ y} \frac{d}{d τ} [ {( \frac{\sqrt{{y}^{2} + 1}}{\sqrt{{u}^{2}}} )}^{2} ] \}}^{2} = c$$

$$⇔ \frac{{y}^{2} + 1}{{u}^{2}} + {[ \frac{1}{2} \frac{1}{τ y} \frac{d}{d τ} ( \frac{{y}^{2} + 1}{{u}^{2}} ) ]}^{2} = c$$

$$⇔ \frac{1}{2} \frac{1}{τ y} \frac{d}{d τ} ( \frac{{y}^{2} + 1}{{u}^{2}} ) = \pm \sqrt{c - \frac{{y}^{2} + 1}{{u}^{2}}}$$

$$⇔ τ = \pm \frac{\frac{1}{y} \frac{d}{d τ} ( \frac{{y}^{2} + 1}{{u}^{2}} )}{2 \sqrt{c - \frac{{y}^{2} + 1}{{u}^{2}}}}$$

$$⇔ τ = ∓ \frac{1}{y} \frac{d}{d τ} \sqrt{c - \frac{{y}^{2} + 1}{{u}^{2}}}$$

This equation corresponds to equ. (83) in the description.

Annex 31—Construction of a general curve with ρ₃=0

As stated in the paragraph below equ. (31) above P3=0 applies if and only if the timelike worldline is lying in a three-dimensional linear subspace spanned by three basis four-vectors. Since the Minkowski space has 4 dimensions this is equivalent to require that there is a constant four-vector

$$H = ( \begin{matrix}{H}^{0} \\ H\end{matrix} ) ,$$

Which is at all proper times Minkowski-orthogonal to the timelike worldline r(τ) and to the four-velocity u(τ) and which can be chosen to be Minkowski-normal:

$${u}^{2} = - 1 ∧ {H}^{2} = \{ \pm \} 1 ⇔ - {( {H}^{0} )}^{2} + {H}^{2} = \{ \pm \} 1 ⇔ {H}^{0} = [ \pm ] \sqrt{{H}^{2} \{ ∓ \} 1} u \cdot H = 0 ⇔ u \cdot H = [ \pm ] \sqrt{{u}^{2} + 1} \sqrt{{H}^{2} \{ ∓ \} 1} ⇔ {( u \cdot H )}^{2} = ( {u}^{2} + 1 ) ( {H}^{2} \{ ∓ \} 1 ) = {u}^{2} {H}^{2} + {H}^{2} \{ ∓ \} {u}^{2} \{ ∓ \} 1 ⇔ {( u \cdot H )}^{2} - {u}^{2} {H}^{2} = {H}^{2} \{ ∓ \} ( {u}^{2} + 1 ) ⇔ - {( u ⨯ H )}^{2} = {H}^{2} \{ ∓ \} ( {u}^{2} + 1 ) ⇒ \{ ∓ \} 1 = - 1 ∧ ( {u}^{2} + 1 ) \geq {H}^{2} ⇒ {H}^{2} = + 1 ⇔ {H}^{0} = [ \pm ] \sqrt{{H}^{2} - 1} ⇒ u \cdot H = [ \pm ] \sqrt{{u}^{2} + 1} \sqrt{{H}^{2} - 1} ⇒ {( u \cdot H )}^{2} = {u}^{2} {H}^{2} + {H}^{2} - {u}^{2} - 1 ⇔ 0 = {u}^{2} {H}^{2} - {u}^{2} {{H}^{2} ( \hat{u} \cdot \hat{H} )}^{2} + {H}^{2} - {u}^{2} - 1 ⇔ 0 = {u}^{2} [ {H}^{2} - {{H}^{2} ( \hat{u} \cdot \hat{H} )}^{2} - 1 ] + {H}^{2} - 1 ⇔ {u}^{2} = \frac{1 - {H}^{2}}{{H}^{2} - {{H}^{2} ( \hat{u} \cdot \hat{H} )}^{2} - 1} = \frac{1 - {H}^{2}}{{( \hat{u} ⨯ H )}^{2} - 1} ⇔ {( {u}^{0} )}^{2} = {u}^{2} + 1 = \frac{1 - {H}^{2} + {H}^{2} - {{H}^{2} ( \hat{u} \cdot \hat{H} )}^{2} - 1}{{H}^{2} - {{H}^{2} ( \hat{u} \cdot \hat{H} )}^{2} - 1} = = \frac{{{H}^{2} ( \hat{u} \cdot \hat{H} )}^{2}}{{{H}^{2} ( \hat{u} \cdot \hat{H} )}^{2} - {H}^{2} + 1} = \frac{1}{1 + \frac{1 - {H}^{2}}{{( \hat{u} \cdot H )}^{2}}} ⇒ u ( τ ) = ( \frac{\frac{1}{\sqrt{1 + \frac{1 - {H}^{2}}{{[ \hat{u} ( τ ) \cdot H ]}^{2}}}}}{\pm \sqrt{\frac{1 - {H}^{2}}{{[ \hat{u} ( τ ) ⨯ H ]}^{2} - 1}} \hat{u} ( τ )} ) \qquad ( 158 )$$

This equation is replicated as equ. (84) in the description.

Starting from this equation we calculate the relation τ( [symbol] , \sqrt{u²}). From equ. (158) follows

$$\hat{u} \cdot \hat{H} = [ \pm ] \sqrt{\frac{( {u}^{2} + 1 ) ( {H}^{2} - 1 )}{{u}^{2} {H}^{2}}} ⇒ \frac{d}{d τ} ( \hat{u} \cdot \hat{H} ) = [ \pm ] \sqrt{\frac{{H}^{2} - 1}{{H}^{2}}} \frac{d}{d τ} \sqrt{\frac{{u}^{2} + 1}{{u}^{2}}} = = [ \pm ] \sqrt{\frac{{H}^{2} - 1}{{H}^{2}}} \frac{d}{d τ} \sqrt{1 + \frac{1}{{u}^{2}}} = [ \pm ] \sqrt{\frac{{H}^{2} - 1}{{H}^{2}}} \frac{( - \frac{1}{{u}^{4}} ) 2 \sqrt{{u}^{2}} \frac{d \sqrt{{u}^{2}}}{d τ}}{2 \sqrt{1 + \frac{1}{{u}^{2}}}} = \qquad ( 159 )$$

$$= - [ \pm ] \sqrt{\frac{{H}^{2} - 1}{{H}^{2}}} \frac{\frac{1}{{u}^{4}} {u}^{2} \frac{d \sqrt{{u}^{2}}}{d τ}}{\sqrt{{u}^{2} + 1}} = - [ \pm ] \sqrt{\frac{{H}^{2} - 1}{{H}^{2}}} \frac{\frac{d \sqrt{{u}^{2}}}{d τ}}{{u}^{2} \sqrt{{u}^{2} + 1}} \qquad ( 160 )$$

From the 3D-Frenet-Serret formulas we get

$$equ . ( 89 )$$

$$\frac{d \hat{u}}{d τ} \cdot \hat{H} = \sqrt{{u}^{2}} κ \cdot \hat{H}$$

$$⇔ \cdot \hat{H} = \frac{1}{\sqrt{{u}^{2}} κ} \frac{d \hat{u}}{d τ} \cdot \hat{H} = \frac{1}{\sqrt{{u}^{2}} κ} \frac{d ( \hat{u} \cdot \hat{H} )}{d τ} \qquad ( 161 )$$

Since the 3D-Frenet-Serret frame (equ. (89)) is orthonormal, the following identity holds:

$$\hat{H} = ( \hat{u} \cdot \hat{H} ) + ( \cdot \hat{H} ) + [ ( û ⨯ ) \cdot \hat{H} ] ( \hat{u} ⨯ ) \\ ⇒ {( \hat{u} \cdot \hat{H} )}^{2} + {( \cdot \hat{H} )}^{2} + {[ ( û \times ) \cdot \hat{H} ]}^{2} = 1$$

$$⇒ ( \hat{u} ⨯ ) \cdot \hat{H} = \pm \sqrt{1 - {( \hat{u} \cdot \hat{H} )}^{2} - {( \cdot \hat{H} )}^{2}} =$$

$$equ . ( 161 )$$

$$= \pm \sqrt{1 - {( \hat{u} \cdot \hat{H} )}^{2} - {( \frac{1}{\sqrt{{u}^{2}} κ} \frac{d ( \hat{u} \cdot \hat{H} )}{d τ} )}^{2}} \qquad ( 162 )$$

$$1 st case : \frac{d \sqrt{{u}^{2}}}{d τ} = 0$$

$$equ . ( 158 )$$

$$\sqrt{{u}^{2}} = const . ⇒ \hat{u} \cdot \hat{H} = const .$$

$$equ . ( 161 )$$

$$⇒ \cdot \hat{H} = 0$$

$$equ . ( 162 )$$

$$⇒ ( \hat{u} ⨯ ) \cdot \hat{H} = \pm \sqrt{1 - {( \hat{u} \cdot \hat{H} )}^{2}}$$

Inserting the last two relations into the 3D-Frenet-Serret formula

$$equ . ( 89 )$$

$$\cdot \hat{H} = - \sqrt{{u}^{2}} κ ( \hat{u} \cdot \hat{H} ) + \sqrt{{u}^{2}} τ ( \hat{u} ⨯ ) \cdot \hat{H}$$

$$yields$$

$$0 = - \sqrt{{u}^{2}} κ ( \hat{u} \cdot \hat{H} ) \pm \sqrt{{u}^{2}} τ \sqrt{1 - {( \hat{u} \cdot \hat{H} )}^{2}}$$

$$⇔ \frac{τ}{κ} = \pm \frac{( \hat{u} \cdot \hat{H} )}{\sqrt{1 - {( \hat{u} \cdot \hat{H} )}^{2}}} =$$

$$equ . ( 159 )$$

$$= \pm \frac{[ \pm ] \sqrt{\frac{( {u}^{2} + 1 ) ( {H}^{2} - 1 )}{{u}^{2} {H}^{2}}}}{\sqrt{1 - ( [ \pm ] \sqrt{{\frac{( {u}^{2} + 1 ) ( {H}^{2} - 1 )}{{u}^{2} {H}^{2}} )}^{2}}}} =$$

$$= \pm [ \pm ] \frac{1}{\sqrt{\frac{{u}^{2} {H}^{2}}{( {u}^{2} + 1 ) ( {H}^{2} - 1 )} - 1}} = \pm [ \pm ] \frac{1}{\sqrt{\frac{{u}^{2} {H}^{2} - [ {u}^{2} {H}^{2} + {H}^{2} - {u}^{2} - 1 ]}{( {u}^{2} + 1 ) ( {H}^{2} - 1 )}}} =$$

$$\begin{matrix}= \pm [ \pm ] \frac{1}{\sqrt{\frac{{u}^{2} + 1 - {H}^{2}}{( {u}^{2} + 1 ) ( {H}^{2} - 1 )}}} = \pm [ \pm ] \sqrt{\frac{( {u}^{2} + 1 ) ( {H}^{2} - 1 )}{{u}^{2} + 1 - {H}^{2}}} & ( 163 )\end{matrix}$$

This is consistent with the condition ρ₃=0 in case

$$y = 0 ⇔ \frac{d \sqrt{{u}^{2}}}{d τ} = 0$$

in equ. (77), (156):

$$const . = c = \vert \frac{κ}{τ} \vert \sqrt{{u}^{2} + 1} =$$

$$equ . 163$$

$$= \sqrt{\frac{{u}^{2} + 1 - {H}^{2}}{( {u}^{2} + 1 ) ( {H}^{2} - 1 )}} \sqrt{{u}^{2} + 1} = \sqrt{\frac{{u}^{2} + 1 - {H}^{2}}{{H}^{2} - 1}} = = \sqrt{\frac{{u}^{2}}{{H}^{2} - 1} - 1}$$

2nd case

$$\frac{d \sqrt{{u}^{2}}}{d τ} \neq 0$$

From the 3D-Frenet-Serret formulas we get

$$equ . ( 89 )$$

$$\frac{d}{d τ} ( \hat{u} ⨯ ) \hat{\cdot H} = - \sqrt{{u}^{2}} τ \cdot \hat{H}$$

$$equ . ( 161 ) , ( 162 )$$

$$⇒ τ = - \frac{\frac{d}{d τ} ( \hat{u} ⨯ ) \cdot \hat{H}}{\sqrt{{u}^{2}} \cdot \hat{H}} = - \pm \frac{{\frac{d}{d τ} \sqrt{1 - {( \hat{u} \cdot \hat{H} )}^{2} - ( \frac{1}{\sqrt{{u}^{2}} κ}} \frac{d ( \hat{u} \cdot \hat{H} )}{d τ} )}^{2}}{\sqrt{{u}^{2}} \frac{1}{\sqrt{{u}^{2}} κ} \frac{d ( \hat{u} \cdot \hat{H} )}{d τ}} = \\ = ∓ \frac{\frac{d}{d τ} \sqrt{1 - {( \hat{u} \cdot \hat{H} )}^{2} - {( \frac{1}{\sqrt{{u}^{2}} κ} \frac{d ( \hat{u} \cdot \hat{H} )}{d τ} )}^{2}}}{\frac{1}{κ} \frac{d ( \hat{u} \cdot \hat{H} )}{d τ}} =$$

$$equ . ( 159 ) , ( 160 )$$

$$= \frac{\frac{d}{d τ} \sqrt{1 - \frac{( {u}^{2} + 1 ) ( {H}^{2} - 1 )}{{u}^{2} {H}^{2}} - {( \frac{\frac{d \sqrt{{u}^{2}}}{d τ}}{\sqrt{{u}^{2}} κ} )}^{2} \frac{{H}^{2} - 1}{{H}^{2}} \frac{1}{{u}^{4} ( {u}^{2} + 1 )}}}{- [ \pm ] \sqrt{\frac{{H}^{2} - 1}{{H}^{2}}} \frac{\frac{d \sqrt{{u}^{2}}}{d τ}}{{u}^{2} \sqrt{{u}^{2} + 1}} \frac{1}{κ}} = = ∓ \frac{\frac{d}{d τ} \sqrt{\frac{{H}^{2}}{{H}^{2} - 1} - \frac{( {u}^{2} + 1 )}{{u}^{2}} - {( \frac{\frac{d \sqrt{{u}^{2}}}{d τ}}{\sqrt{{u}^{2}} κ} )}^{2} \frac{1}{{u}^{4} ( {u}^{2} + 1 )}}}{- [ \pm ] \frac{\frac{d \sqrt{{u}^{2}}}{d τ}}{{u}^{2} \sqrt{{u}^{2} + 1}} \frac{1}{κ}} = \\ = [ \pm ] \pm \frac{\frac{d}{d τ} \sqrt{\frac{{H}^{2}}{{H}^{2} - 1} - 1 - \frac{1}{{u}^{2}} - {( \frac{\frac{d \sqrt{{u}^{2}}}{d τ}}{{u}^{2} \sqrt{{u}^{2} + 1} κ} )}^{2} \frac{1}{{u}^{2}}}}{\frac{\frac{d \sqrt{{u}^{2}}}{d τ}}{{u}^{2} \sqrt{{u}^{2} + 1}} \frac{1}{κ}} = \\ = [ \pm ] \pm \frac{\frac{d}{d τ} \sqrt{\frac{{H}^{2}}{{H}^{2} - 1} - 1 - \frac{1}{{u}^{2}} [ 1 + {( \frac{\frac{d \sqrt{{u}^{2}}}{d τ}}{{u}^{2} \sqrt{{u}^{2} + 1} κ} )}^{2} ]}}{\frac{\frac{d \sqrt{{u}^{2}}}{d τ}}{{u}^{2} \sqrt{{u}^{2} + 1}} \frac{1}{κ}} = \\ = [ \pm ] \pm \frac{\frac{d}{d τ} \sqrt{\frac{{H}^{2}}{{H}^{2} - 1} - \frac{1}{{u}^{2}} [ 1 + {( \frac{\frac{d \sqrt{{u}^{2}}}{d τ}}{{u}^{2} \sqrt{{u}^{2} + 1} κ} )}^{2} ]}}{\frac{\frac{d \sqrt{{u}^{2}}}{d τ}}{{u}^{2} \sqrt{{u}^{2} + 1}} \frac{1}{κ}}$$

This is consistent with the condition ρ₃=0 in case

$$y \neq 0 ⇔ \frac{d \sqrt{{u}^{2}}}{d τ} \neq 0$$

in equ. (83), (157):

$$y := \frac{1}{κ} \frac{1}{{u}^{2} \sqrt{{u}^{2} + 1}} \frac{d \sqrt{{u}^{2}}}{d τ} \\ τ = \pm \frac{1}{y} \frac{d}{d τ} \sqrt{c - \frac{{y}^{2} + 1}{{u}^{2}}} \\ with \\ c = \frac{1}{{H}^{2} - 1}$$

Annex 32—Calculation of

$${\overline{N}}_{1} = \frac{a}{\sqrt{a \cdot a}}$$

in case of a∥u∧ρ₁≠0

$$a = ( \begin{matrix}{a}^{0} \\ a\end{matrix} ) = ( \begin{matrix}{a}^{0} \\ \sqrt{{a}^{2}} \hat{a}\end{matrix} ) = ( \begin{matrix}{a}^{0} \\ {\underbrace{( \hat{a} \cdot \hat{u} )}}_{\pm 1} \sqrt{{a}^{2}} \hat{u}\end{matrix} ) = ( \begin{matrix}{a}^{0} \\ \pm \sqrt{{a}^{2}} \hat{u}\end{matrix} ) a \cdot u = 0 ⇔ 0 = - {a}^{0} {u}^{0} + a \cdot u = - {a}^{0} {u}^{0} + \sqrt{{a}^{2}} \sqrt{{u}^{2}} ( \hat{a} \cdot \hat{u} ) = - {a}^{0} {u}^{0} \pm \sqrt{{a}^{2}} \sqrt{{u}^{2}} ⇒ 1 ) \frac{{a}^{0}}{\vert {a}^{0} \vert} = \frac{\sqrt{{a}^{2}} \sqrt{{u}^{2}} ( \hat{a} \cdot \hat{u} ) \vert {u}^{0} \vert}{{u}^{0} \vert \sqrt{{a}^{2}} \sqrt{{u}^{2}} ( \hat{a} \cdot \hat{u} ) \vert} = \hat{u} \cdot \hat{a} ⇒ 2 ) a = ( \begin{matrix}\frac{{a}^{0} {u}^{0}}{{u}^{0}} \\ ( \hat{a} \cdot \hat{u} ) \sqrt{{a}^{2}} \hat{u}\end{matrix} ) = ( \begin{matrix}\frac{( \hat{a} \cdot \hat{u} ) \sqrt{{a}^{2}} \sqrt{{u}^{2}}}{{u}^{0}} \\ ( \hat{a} \cdot \hat{u} ) \sqrt{{a}^{2}} \hat{u}\end{matrix} ) = {\underbrace{( \hat{a} \cdot \hat{u} )}}_{\pm 1} \sqrt{{a}^{2}} ( \begin{matrix}\frac{\sqrt{{u}^{2}}}{{u}^{0}} \\ \hat{u}\end{matrix} ) ⇒ 3 ) a \cdot a = \frac{- {a}^{2} {u}^{2}}{{( {u}^{0} )}^{2}} + {a}^{2} = {a}^{2} ( \frac{- {u}^{2}}{{u}^{2} + 1} + 1 ) = \frac{{a}^{2}}{{u}^{2} + 1} = \frac{{a}^{2}}{{( {u}^{0} )}^{2}} \qquad ( 64 )$$

$$equ . 20$$

$$⇒ {\overline{N}}_{1} = \frac{a}{\sqrt{a \cdot a}} = ( \hat{a} \cdot \hat{u} ) \sqrt{{a}^{2}} ( \begin{matrix}\frac{\sqrt{{u}^{2}}}{{u}^{0}} \\ \hat{u}\end{matrix} ) \frac{{u}^{0}}{\sqrt{{a}^{2}}} = ( \hat{a} \cdot \hat{u} ) ( \begin{matrix}\sqrt{{u}^{2}} \\ {u}^{0} \hat{u}\end{matrix} ) =$$

$$equ . 64$$

$$= {\underbrace{( \hat{a} \cdot \hat{u} )}}_{\pm 1} ( \begin{matrix}\sqrt{{u}^{2}} \\ \frac{{u}^{0}}{\sqrt{{u}^{2}}} u\end{matrix} ) = \frac{{a}^{0}}{{\underbrace{\vert {a}^{0} \vert}}_{\pm 1}} ( \begin{matrix}\sqrt{{u}^{2}} \\ \frac{{u}^{0}}{\sqrt{{u}^{2}}} u\end{matrix} ) = \frac{{a}^{0}}{{\underbrace{\vert {a}^{0} \vert}}_{\pm 1}} {\dot{N}}_{1}$$

Annex 33—Industrial Applicability

Fermi-Walker transported frames in Minkowski space play a role in tech-niques involving communication between an observer for example on a space station on the one hand and a satellite or space probe or space ship on the other hand, if the relative velocities are so high and the required accuracy so high that special relativistic effects become important and if general relativistic effects can be neglected, see for example [13, abstract, chapters “I. INTRODUCTION” and “II. FERMI-WALKER TRANSPORT DIFFERENTIAL EQUATIONS] and [11, p. 3, first para., last sentence], which cites [13] as reference [28].

If general relativistic effects cannot be neglected as in the global positioning systems (GPS), then the Minkowski metric has to be replaced with an appropriate metric solving the Einstein equation. The construction of Fermi-Walker transported frames for arbitrary metrics, which thus includes the Minkowski metric as a special case, is treated in [10] and [11] (in the latter restricted to circular orbits and stationary axisymmetric metrics).

The 4D-Frenet-Serret frame is often used to construct the Fermi-Walker frame. For the Minkowski metric this is for example shown in textbook [3, chapters “18.17 Covariant Serret-Frenet Theory”, “18.18 Fermi-Walker Transport” and “18.19 Example of Fermi-Walker Transport” ] and in [12, Appendix A]. For circular orbits and a stationary axisymmetric metric this is shown in [11, chapters “3.1 Frenet-Serret transport” and “3.2 Fermi-Walker transport” and first sentence of chapter “4 Test gyroscopes and circular holonomy”]. For more general metrics this is shown in [10, chapter “The Frenet-Serret equations and the Fermi-Walker transport” ].

The following paragraph lists all cited documents:

### BIBLIOGRAPHY

[1] J. L. Synge and A. Schild, Tensor Calculus, UNIVERSITY OF TORONTO PRESS, TORONTO, COPYRIGHT, CANADA, 1949, Reprinted in 2018, ISBN 978-1-4875-7364-5 (paper), CHAPTER II BASIC OPERATIONS IN RIEMAN-NIAN SPACE, pp. 26-80
[2] Eric Gourgoulhon, Special Relativity in General Frames-From Particles to As-trophysics, 2013, ISBN 978-3-642-37276-6 (eBook), Springer Berlin Heidelberg
[3] Oliver Davis Johns, Analytical Mechanics for Relativity and Quantum Mechan-ics, 2nd edition published 2011, first published in paperback 2016, Oxford University press, ISBN 978-0-19-876680-3 (PBK)
[4] Dennis S. Bernstein, Scalar, Vector, and Matrix Mathematics: Theory, Facts and Formulas, Revised and Expanded Edition, 2018, Princeton University Press, ISBN 9780691151205 (hardcover), ISBN 9780691176536 (paperback)
[5] John David Jackson, Classical Electrodynamics, Third Edition, John Wiley & Sons, 1998, ISBN 978-0-471-30932-1
[6] Michael Tsamparlis, Special Relativity-An Introduction with 200 Problems and Solutions, 2019, ISBN 978-3-030-27346-0, 2nd edition, Springer Nature Switzer-land AG
[7] Christian Möller, The Theory of Relativity, Second Edition, 1972, Clarendon Press/Oxford University Press
[8] J. B. Formiga and C. Romero, On the differential geometry of curves in Minkowski space, arXiv:gr-qc/0601002
   Preprint of: American Journal of Physics, Vol. 74, No. 11, 12. Okt. 2006, p. 1012,00 https://doi.org/10.1119/1.2232644
[9] C. Romero and J. B. Formiga, GEOMETRIC AND KINEMATICAL ASPECTS OF RINDLER OBSERVERS, Proceedings of the Eleventh Marcel Grossmann Meeting on Recent Developments in Theoretical and Experimental General Relativity, Gravitation and Relativistic Field Theories, Part B, Hagen Kleinert, Robert T. Jantzen, Remo Ruffini (editors), pp. 1329-1331 (2008), World Scien-tific, ISBN: 9789812834287, https://doi.org/10.1142/9789812834300_0144
[10] J. W. Maluf and F. F. Faria, On the construction of Fermi-Walker transported frames, arXiv:0804.2502 [gr-qc]
   Preprint of: Annalen der Physik (Berlin), Vol. 17, No. 5, May 2008, p. 326-335, https://doi.org/10.1002/andp.200810289
[11] Donato Bini, Christian Cherubini, Andrea Geralico, Robert T. Jantzen, Physical frames along circular orbits in stationary axisymmetric spacetimes, arXiv:1408.4598 [gr-qc]
   Preprint of: General Relativity and Gravitation, Vol. 40, pp. 985-1012 (2008), https://doi.org/10.1007/s10714-007-0587-z
[12] Donato Bini and Robert T. Jantzen, INERTIAL FORCES: THE SPECIAL RELATIVISTIC ASSESSMENT, http://www34.homepage.villanova.edu/robert.jantzen/research/articles/bkchapter-2003-ifsra.pdf
   Preprint of chapter 11 in: Rizzi G., Ruggiero M. L. (eds) Relativity in Rotating Frames. Fundamental Theories of Physics, vol 135, 2004, Springer, Dordrecht, https://doi.org/10.1007/978-94-017-0528-8_13
[13] Thomas B. Bahder, Fermi Coordinates of an Observer Moving in a Circle in Minkowski Space: Apparent Behavior of Clocks, arXiv:gr-qc/9811009
[14] John W. Betz, ENGINEERING SATELLITE-BASED NAVIGATION AND TIMING, 2016, IEEE press, John Wiley & Sons, Hoboken, N.J., US, ISBN: 978-1-118-61597-3
[15] Alfred Gray, Elsa Abbena, Simon Salamon, Modern Differential Geometry of Curves and Surfaces with Mathematica, 3rd edition, 2006, Chapman & Hall/CRC, Taylor & Francis, Boca Raton, US, ISBN: 978-1-58488-448-4

1. Method of calculating the fourth column vector (N₃) of a local frame (Lη) given in the form of equ. (6) by using one of the expressions of equ. (32), equ. (38) or (41).

2. Method of calculating the 4D-Frenet-Serret frame (**L̅η, ***L̅η) in four-dimensional Minkowski space of a timelike worldline by forming the product of another local frame ( [symbol] η, \dot{L}η) and one or more spatial rotations ( [symbol] η, R̊η, \dot{R}η).

3. Method as defined in claim 2, characterised in that the other local frame ( [symbol] η) is a 4D-Frenet-Serret frame, if the second 4D-curvature (ρ₂), also known as first torsion, is zero and the worldline is not a straight line, and that this other local frame ( [symbol] η) is multiplied with a single spatial rotation ( [symbol] η).

4. Method as defined in claim 3, characterised in that the other local frame ( [symbol] η) is calculated using equ. (44), the rotation matrix ( [symbol] η) is calculated using equ. (48) and the rotation angle (ᾰ) is calculated using equ. (49).

5. Method as defined in claim 2, characterised in that the other local frame (\dot{L}η) is a 4D-Frenet-Serret frame, if the first 4D-curvature (ρ₁) is zero, and that this other local frame (\dot{L}η) is multiplied with three spatial rotations ( [symbol] η, R̊η, \dot{R}η) forming an Euler cradle.

6. Method as defined in claim 5, characterised in that the other local frame (\dot{L}η) is calculated using equ. (64)/(65) and the three rotation matrices ( [symbol] η, R̊η, \dot{R}η) are calculated using equ. (48), equ. (61), and equ. (70) and the rotation angles (ᾰ, α̊, \dot{α}) are calculated using equ. (49), (62)/(63) and (71).

7. Method of calculating one of the three 4D-curvatures (ρ₁, ρ₂, ρ₃) of the 4D-Frenet-Serret frame in Minkowski space of a timelike worldline (r(τ)) in terms of the 3D-curvature ( [symbol] ), the 3D-torsion (τ) and the magnitude (\sqrt{u²}) of the three-dimensional spatial part (u) of the four-velocity
$$( u = ( \begin{matrix}{u}^{0} \\ u\end{matrix} ) ) .$$

8. Method as defined in claim 7, characterised in that one of the formulas (74), (76) or (77) is used.

9. Method for calculating the transport property of a local frame (L′η=LηRη), which is formed by multiplying another local frame (Lη) with a spatial rotation (Rη), using matrix partitioning.

10. Method as defined in claim 9, characterised in that the formula (33) is used.

11. Method of constructing a general solution to the condition that the second 4D-curvature (ρ₂), also known as first torsion, of the 4D-Frenet-Serret frame is zero by using equ. (81).

12. Method of constructing a general solution to the condition that the third 4D-curvature (ρ₃), also known as second torsion, hyper-torsion or bi-torsion, of the 4D-Frenet-Serret frame is zero by using equ. (84).

13. Method of calculating a timelike worldline describing a circular movement with the second 4D-curvature (ρ₂), also known as first torsion, of the 4D-Frenet-Serret frame being zero using one of the two formulas of equ. (82).

14. Computer program executing one of the methods defined in claims 1-13.

15. Storage medium, for example solid state disc, hard disc, USB-stick, CD-Rom etc., storing a program as defined in claim 14.
